(19) United States
(12) Patent Application Publication
(10) Pub. No.: US 2022/0061074 A1
(43) Pub. Date: Feb. 24, 2022

(54) Multiple SPS and Configured Grant Configurations

(71) Applicant: Ofinno, LLC, Reston, VA (US)

(72) Inventors: Alireza Babaei, Fairfax, VA (US); Esmael Hejazi Dinan, McLean, VA (US); Yunjung Yi, Vienna, VA (US); Hyoungsuk Jeon, Centreville, VA (US); Youngwoo Kwak, Vienna, VA (US); Hua Zhou, Vienna, VA (US); Nazanin Rastegardoost, McLean, VA (US); Kai Xu, Herndon, VA (US)

(73) Assignee: Ofinno, LLC, Reston, VA (US)

(21) Appl. No.: 17/515,986

(22) Filed: Nov. 1, 2021

Related U.S. Application Data
(63) Continuation of application No. PCT/US2020/030203, filed on Apr. 28, 2020.
(60) Provisional application No. 62/841,723, filed on May 1, 2019.

(51) Int. Cl. H04W 72/12; H04L 1/18; H04L 5/00

(52) U.S. Cl. CPC H04W 72/1273; H04L 5/0053; H04L 1/1812; H04W 72/1289

(57) ABSTRACT

A wireless device receives transport blocks via semi-persistent scheduling (SPS) resources corresponding to SPS configuration indexes. An acknowledgement codebook is transmitted. The acknowledgement codebook comprises acknowledgement information bits, for the transport blocks, that are ordered based on the SPS configuration indexes.

### CROSS-REFERENCE TO RELATED APPLICATIONS

This application is a continuation of International Application No. PCT/US2020/030203, filed Apr. 28, 2020, which claims the benefit of U.S. Provisional Application No. 62/841,723, filed May 1, 2019, the contents of each of which are hereby incorporated by reference in their entireties.

### BRIEF DESCRIPTION OF THE SEVERAL VIEWS OF THE DRAWINGS

Examples of several of the various embodiments of the present disclosure are described herein with reference to the drawings.

FIG. 1 is a diagram of an example RAN architecture as per an aspect of an embodiment of the present disclosure.

FIG. 2A is a diagram of an example user plane protocol stack as per an aspect of an embodiment of the present disclosure.

FIG. 2B is a diagram of an example control plane protocol stack as per an aspect of an embodiment of the present disclosure.

FIG. 3 is a diagram of an example wireless device and two base stations as per an aspect of an embodiment of the present disclosure.

FIG. 4A, FIG. 4B, FIG. 4C and FIG. 4D are example diagrams for uplink and downlink signal transmission as per an aspect of an embodiment of the present disclosure.

FIG. 5A is a diagram of an example uplink channel mapping and example uplink physical signals as per an aspect of an embodiment of the present disclosure.

FIG. 5B is a diagram of an example downlink channel mapping and example downlink physical signals as per an aspect of an embodiment of the present disclosure.

FIG. 6 is a diagram depicting an example frame structure as per an aspect of an embodiment of the present disclosure.

FIG. 7A and FIG. 7B are diagrams depicting example sets of OFDM subcarriers as per an aspect of an embodiment of the present disclosure.

FIG. 8 is a diagram depicting example OFDM radio resources as per an aspect of an embodiment of the present disclosure.

FIG. 9A is a diagram depicting an example CSI-RS and/or SS block transmission in a multi-beam system.

FIG. 9B is a diagram depicting an example downlink beam management procedure as per an aspect of an embodiment of the present disclosure.

FIG. 10 is an example diagram of configured BWPs as per an aspect of an embodiment of the present disclosure.

FIG. 11A, and FIG. 11B are diagrams of an example multi connectivity as per an aspect of an embodiment of the present disclosure.

FIG. 12 is a diagram of an example random access procedure as per an aspect of an embodiment of the present disclosure.

FIG. 13 is a structure of example MAC entities as per an aspect of an embodiment of the present disclosure.

FIG. 14 is a diagram of an example RAN architecture as per an aspect of an embodiment of the present disclosure.

FIG. 15 is a diagram of example RRC states as per an aspect of an embodiment of the present disclosure.

FIG. 16 is an example procedure as per an aspect of an embodiment of the present disclosure.

FIG. 17 is an example procedure as per an aspect of an embodiment of the present disclosure.

FIG. 18 is an example procedure as per an aspect of an embodiment of the present disclosure.

FIG. 19 is an example procedure as per an aspect of an embodiment of the present disclosure.

FIG. 20 is an example procedure as per an aspect of an embodiment of the present disclosure.

FIG. 21 is an example procedure as per an aspect of an embodiment of the present disclosure.

FIG. 22 is an example procedure as per an aspect of an embodiment of the present disclosure.

FIG. 23 is an example procedure as per an aspect of an embodiment of the present disclosure.

FIG. 24 is an example procedure as per an aspect of an embodiment of the present disclosure.

FIG. 25 is an example procedure as per an aspect of an embodiment of the present disclosure.

FIG. 26 is an example procedure as per an aspect of an embodiment of the present disclosure.

FIG. 27 is an example procedure as per an aspect of an embodiment of the present disclosure.

FIG. 28 is a flow diagram of an aspect of an example embodiment of the present disclosure.

FIG. 29 is a flow diagram of an aspect of an example embodiment of the present disclosure.

### DETAILED DESCRIPTION OF EMBODIMENTS

Example embodiments of the present disclosure enable operation of multiple SPS and configured grant configurations. Embodiments of the technology disclosed herein may be employed in the technical field of multicarrier communication systems. More particularly, the embodiments of the technology disclosed herein may relate to multiple SPS and configured grant configurations in multicarrier communication systems.

The following Acronyms are used throughout the present disclosure:

3GPP 3rd Generation Partnership Project

5GC 5G Core Network

ACK Acknowledgement

AMF Access and Mobility Management Function

ARQ Automatic Repeat Request

AS Access Stratum

ASIC Application-Specific Integrated Circuit

BA Bandwidth Adaptation

BCCH Broadcast Control Channel

BCH Broadcast Channel

BPSK Binary Phase Shift Keying

BWP Bandwidth Part

CA Carrier Aggregation

CC Component Carrier

CCCH Common Control CHannel

CDMA Code Division Multiple Access

CN Core Network

CP Cyclic Prefix

CP-OFDM Cyclic Prefix-Orthogonal Frequency Division Multiplex

C-RNTI Cell-Radio Network Temporary Identifier

CS Configured Scheduling

CSI Channel State Information

CSI-RS Channel State Information-Reference Signal

CQI Channel Quality Indicator

CSS Common Search Space

CU Central Unit

DC Dual Connectivity

DCCH Dedicated Control CHannel

DCI Downlink Control Information

DL Downlink

DL-SCH Downlink Shared CHannel

DM-RS DeModulation Reference Signal

DRB Data Radio Bearer

DRX Discontinuous Reception

DTCH Dedicated Traffic CHannel

DU Distributed Unit

EPC Evolved Packet Core

E-UTRA Evolved UMTS Terrestrial Radio Access

E-UTRAN Evolved-Universal Terrestrial Radio Access Network

FDD Frequency Division Duplex

FPGA Field Programmable Gate Arrays

F1-C F1-Control plane

F1-U F1-User plane

gNB next generation Node B

HARQ Hybrid Automatic Repeat reQuest

HDL Hardware Description Languages

IE Information Element

IP Internet Protocol

LCID Logical Channel IDentifier

LTE Long Term Evolution

MAC Media Access Control

MCG Master Cell Group

MCS Modulation and Coding Scheme

MeNB Master evolved Node B

MIB Master Information Block

MME Mobility Management Entity

MN Master Node

NACK Negative Acknowledgement

NAS Non-Access Stratum

NG CP Next Generation Control Plane

NGC Next Generation Core

NG-C NG-Control plane

ng-eNB next generation evolved Node B

NG-U NG-User plane

NR New Radio

NR MAC New Radio MAC

NR PDCP New Radio PDCP

NR PHY New Radio PHYsical

NR RLC New Radio RLC

NR RRC New Radio RRC

NSSAI Network Slice Selection Assistance Information

O&M Operation and Maintenance

OFDM Orthogonal Frequency Division Multiplexing

PBCH Physical Broadcast CHannel

PCC Primary Component Carrier

PCCH Paging Control CHannel

PCell Primary Cell

PCH Paging CHannel

PDCCH Physical Downlink Control CHannel

PDCP Packet Data Convergence Protocol

PDSCH Physical Downlink Shared CHannel

PDU Protocol Data Unit

PHICH Physical HARQ Indicator CHannel

PHY PHYsical

PLMN Public Land Mobile Network

PMI Precoding Matrix Indicator

PRACH Physical Random Access CHannel

PRB Physical Resource Block

PSCell Primary Secondary Cell

PSS Primary Synchronization Signal

pTAG primary Timing Advance Group

PT-RS Phase Tracking Reference Signal

PUCCH Physical Uplink Control CHannel

PUSCH Physical Uplink Shared CHannel

QAM Quadrature Amplitude Modulation

QFI Quality of Service Indicator

QoS Quality of Service

QPSK Quadrature Phase Shift Keying

RA Random Access

RACH Random Access CHannel

RAN Radio Access Network

RAT Radio Access Technology

RA-RNTI Random Access-Radio Network Temporary Identifier

RB Resource Blocks

RBG Resource Block Groups

RI Rank Indicator

RLC Radio Link Control

RRC Radio Resource Control

RS Reference Signal

RSRP Reference Signal Received Power

SCC Secondary Component Carrier

SCell Secondary Cell

SCG Secondary Cell Group

SC-FDMA Single Carrier-Frequency Division Multiple Access

SDAP Service Data Adaptation Protocol

SDU Service Data Unit

SeNB Secondary evolved Node B

SFN System Frame Number

S-GW Serving GateWay

SI System Information

SIB System Information Block

SMF Session Management Function

SN Secondary Node

SpCell Special Cell

SRB Signaling Radio Bearer

SRS Sounding Reference Signal

SS Synchronization Signal

SSS Secondary Synchronization Signal

sTAG secondary Timing Advance Group

TA Timing Advance

TAG Timing Advance Group

TAI Tracking Area Identifier

TAT Time Alignment Timer

TB Transport Block

TC-RNTI Temporary Cell-Radio Network Temporary Identifier

TDD Time Division Duplex

TDMA Time Division Multiple Access

TTI Transmission Time Interval

UCI Uplink Control Information

UE User Equipment

UL Uplink

UL-SCH Uplink Shared CHannel

UPF User Plane Function

UPGW User Plane Gateway

VHDL VHSIC Hardware Description Language

Xn-C Xn-Control plane

Xn-U Xn-User plane

Example embodiments of the disclosure may be implemented using various physical layer modulation and transmission mechanisms. Example transmission mechanisms may include, but are not limited to: Code Division Multiple Access (CDMA), Orthogonal Frequency Division Multiple Access (OFDMA), Time Division Multiple Access (TDMA), Wavelet technologies, and/or the like. Hybrid transmission mechanisms such as TDMA/CDMA, and OFDM/CDMA may also be employed. Various modulation schemes may be applied for signal transmission in the physical layer. Examples of modulation schemes include, but are not limited to: phase, amplitude, code, a combination of these, and/or the like. An example radio transmission method may implement Quadrature Amplitude Modulation (QAM) using Binary Phase Shift Keying (BPSK), Quadrature Phase Shift Keying (QPSK), 16-QAM, 64-QAM, 256-QAM, and/or the like. Physical radio transmission may be enhanced by dynamically or semi-dynamically changing the modulation and coding scheme depending on transmission requirements and radio conditions.

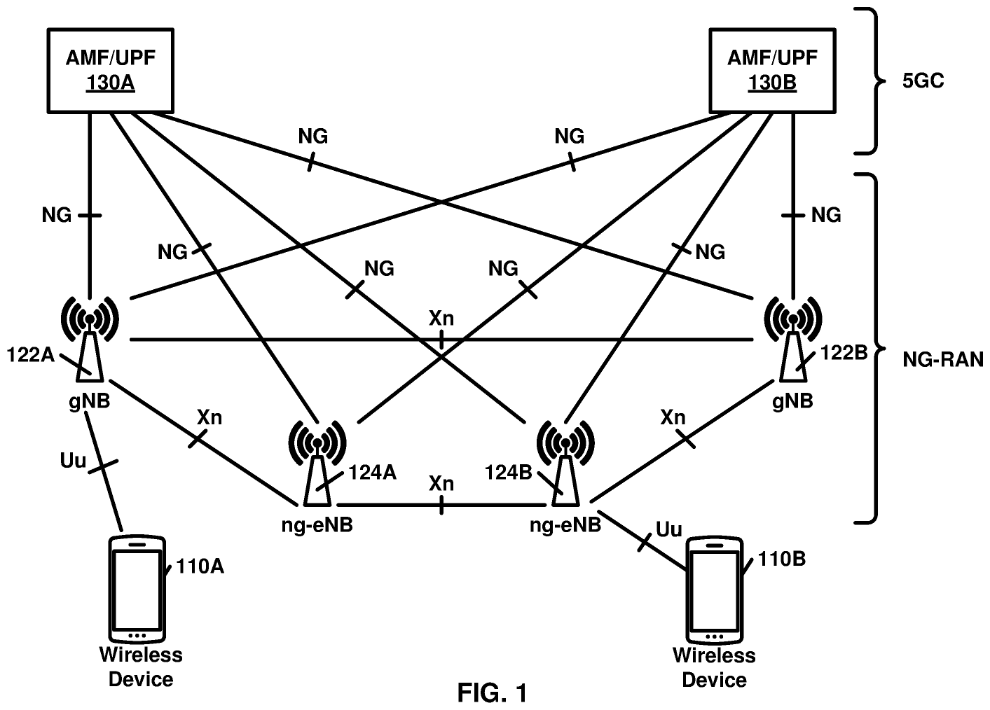

FIG. 1 is an example Radio Access Network (RAN) architecture as per an aspect of an embodiment of the present disclosure. As illustrated in this example, a RAN node may be a next generation Node B (gNB) (e.g. 120A, 120B) providing New Radio (NR) user plane and control plane protocol terminations towards a first wireless device (e.g. 110A). In an example, a RAN node may be a next generation evolved Node B (ng-eNB) (e.g. 124A, 124B), providing Evolved UMTS Terrestrial Radio Access (E-UTRA) user plane and control plane protocol terminations towards a second wireless device (e.g. 110B). The first wireless device may communicate with a gNB over a Uu interface. The second wireless device may communicate with a ng-eNB over a Uu interface. In this disclosure, wireless device 110A and 110B are structurally similar to wireless device 110. Base stations 120A and/or 120B may be structurally similarly to base station 120. Base station 120 may comprise at least one of a gNB (e.g. 122A and/or 122B), ng-eNB (e.g. 124A and/or 124B), and or the like.

A gNB or an ng-eNB may host functions such as: radio resource management and scheduling, IP header compression, encryption and integrity protection of data, selection of Access and Mobility Management Function (AMF) at User Equipment (UE) attachment, routing of user plane and control plane data, connection setup and release, scheduling and transmission of paging messages (originated from the AMF), scheduling and transmission of system broadcast information (originated from the AMF or Operation and Maintenance (O&M)), measurement and measurement reporting configuration, transport level packet marking in the uplink, session management, support of network slicing, Quality of Service (QoS) flow management and mapping to data radio bearers, support of UEs in RRC_INACTIVE state, distribution function for Non-Access Stratum (NAS) messages, RAN sharing, and dual connectivity or tight interworking between NR and E-UTRA.

In an example, one or more gNBs and/or one or more ng-eNBs may be interconnected with each other by means of Xn interface. A gNB or an ng-eNB may be connected by means of NG interfaces to 5G Core Network (5GC). In an example, 5GC may comprise one or more AMF/User Plan Function (UPF) functions (e.g. 130A or 130B). A gNB or an ng-eNB may be connected to a UPF by means of an NG-User plane (NG-U) interface. The NG-U interface may provide delivery (e.g. non-guaranteed delivery) of user plane Protocol Data Units (PDUs) between a RAN node and the UPF. A gNB or an ng-eNB may be connected to an AMF by means of an NG-Control plane (NG-C) interface. The NG-C interface may provide, for example, NG interface management, UE context management, UE mobility management, transport of NAS messages, paging, PDU session management, configuration transfer and/or warning message transmission, combinations thereof, and/or the like.

In an example, a UPF may host functions such as anchor point for intra-/inter-Radio Access Technology (RAT) mobility (when applicable), external PDU session point of interconnect to data network, packet routing and forwarding, packet inspection and user plane part of policy rule enforcement, traffic usage reporting, uplink classifier to support routing traffic flows to a data network, branching point to support multi-homed PDU session, QoS handling for user plane, e.g. packet filtering, gating, Uplink (UL)/Downlink (DL) rate enforcement, uplink traffic verification (e.g. Service Data Flow (SDF) to QoS flow mapping), downlink packet buffering and/or downlink data notification triggering.

In an example, an AMF may host functions such as NAS signaling termination, NAS signaling security, Access Stratum (AS) security control, inter Core Network (CN) node signaling for mobility between 3r^{d} Generation Partnership Project (3GPP) access networks, idle mode UE reachability (e.g., control and execution of paging retransmission), registration area management, support of intra-system and inter-system mobility, access authentication, access authorization including check of roaming rights, mobility management control (subscription and policies), support of network slicing and/or Session Management Function (SMF) selection.

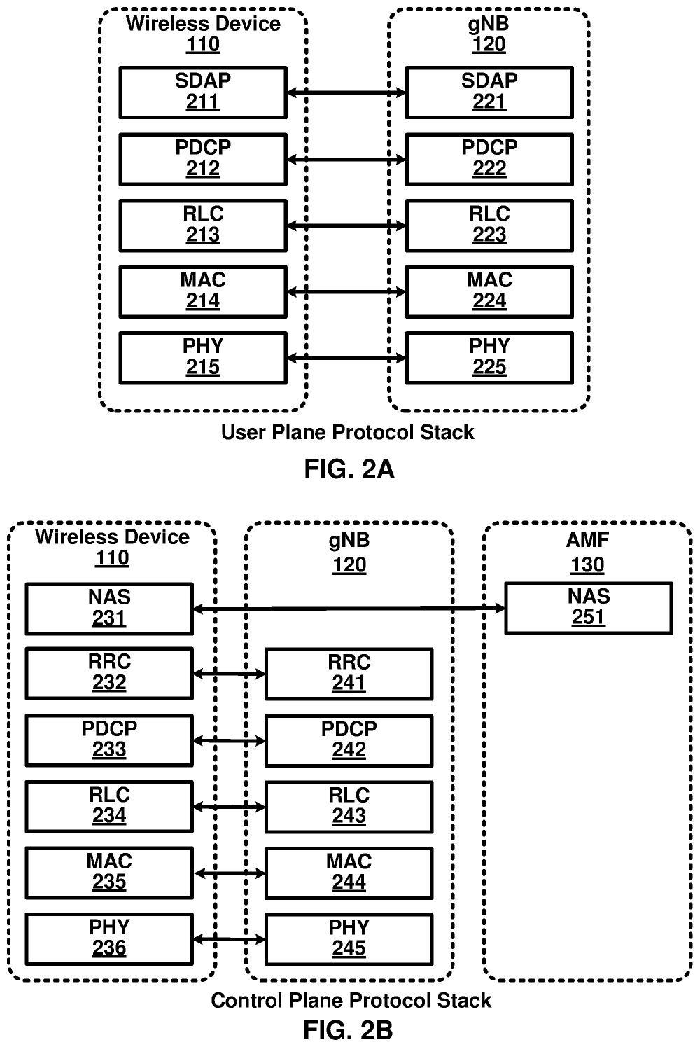

FIG. 2A is an example user plane protocol stack, where Service Data Adaptation Protocol (SDAP) (e.g. 211 and 221), Packet Data Convergence Protocol (PDCP) (e.g. 212 and 222), Radio Link Control (RLC) (e.g. 213 and 223) and Media Access Control (MAC) (e.g. 214 and 224) sublayers and Physical (PHY) (e.g. 215 and 225) layer may be terminated in wireless device (e.g. 110) and gNB (e.g. 120) on the network side. In an example, a PHY layer provides transport services to higher layers (e.g. MAC, RRC, etc.). In an example, services and functions of a MAC sublayer may comprise mapping between logical channels and transport channels, multiplexing/demultiplexing of MAC Service Data Units (SDUs) belonging to one or different logical channels into/from Transport Blocks (TBs) delivered to/from the PHY layer, scheduling information reporting, error correction through Hybrid Automatic Repeat request (HARQ) (e.g. one HARQ entity per carrier in case of Carrier Aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologies and/or Transmission Time Interval (TTI) durations. In an example, Automatic Repeat Request (ARQ) may operate on any of the numerologies and/or TTI durations the logical channel is configured with. In an example, services and functions of the PDCP layer for the user plane may comprise sequence numbering, header compression and decompression, transfer of user data, reordering and duplicate detection, PDCP PDU routing (e.g. in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a QoS flow and a data radio bearer. In an example, services and functions of SDAP may comprise mapping Quality of Service Indicator (QFI) in DL and UL packets. In an example, a protocol entity of SDAP may be configured for an individual PDU session.

FIG. 2B is an example control plane protocol stack where PDCP (e.g. 233 and 242), RLC (e.g. 234 and 243) and MAC (e.g. 235 and 244) sublayers and PHY (e.g. 236 and 245) layer may be terminated in wireless device (e.g. 110) and gNB (e.g. 120) on a network side and perform service and functions described above. In an example, RRC (e.g. 232 and 241) may be terminated in a wireless device and a gNB on a network side. In an example, services and functions of RRC may comprise broadcast of system information related to AS and NAS, paging initiated by 5GC or RAN, establishment, maintenance and release of an RRC connection between the UE and RAN, security functions including key management, establishment, configuration, maintenance and release of Signaling Radio Bearers (SRBs) and Data Radio Bearers (DRBs), mobility functions, QoS management functions, UE measurement reporting and control of the reporting, detection of and recovery from radio link failure, and/or NAS message transfer to/from NAS from/to a UE. In an example, NAS control protocol (e.g. 231 and 251) may be terminated in the wireless device and AMF (e.g. 130) on a network side and may perform functions such as authentication, mobility management between a UE and a AMF for 3GPP access and non-3GPP access, and session management between a UE and a SMF for 3GPP access and non-3GPP access.

In an example, a base station may configure a plurality of logical channels for a wireless device. A logical channel in the plurality of logical channels may correspond to a radio bearer and the radio bearer may be associated with a QoS requirement. In an example, a base station may configure a logical channel to be mapped to one or more TTIs/numerologies in a plurality of TTIs/numerologies. The wireless device may receive a Downlink Control Information (DCI) via Physical Downlink Control CHannel (PDCCH) indicating an uplink grant. In an example, the uplink grant may be for a first TTI/numerology and may indicate uplink resources for transmission of a transport block. The base station may configure each logical channel in the plurality of logical channels with one or more parameters to be used by a logical channel prioritization procedure at the MAC layer of the wireless device. The one or more parameters may comprise priority, prioritized bit rate, etc. A logical channel in the plurality of logical channels may correspond to one or more buffers comprising data associated with the logical channel. The logical channel prioritization procedure may allocate the uplink resources to one or more first logical channels in the plurality of logical channels and/or one or more MAC Control Elements (CEs). The one or more first logical channels may be mapped to the first TTI/numerology. The MAC layer at the wireless device may multiplex one or more MAC CEs and/or one or more MAC SDUs (e.g., logical channel) in a MAC PDU (e.g., transport block). In an example, the MAC PDU may comprise a MAC header comprising a plurality of MAC sub-headers. A MAC sub-header in the plurality of MAC sub-headers may correspond to a MAC CE or a MAC SUD (logical channel) in the one or more MAC CEs and/or one or more MAC SDUs. In an example, a MAC CE or a logical channel may be configured with a Logical Channel IDentifier (LCID). In an example, LCID for a logical channel or a MAC CE may be fixed/pre-configured. In an example, LCID for a logical channel or MAC CE may be configured for the wireless device by the base station. The MAC sub-header corresponding to a MAC CE or a MAC SDU may comprise LCID associated with the MAC CE or the MAC SDU.

In an example, a base station may activate and/or deactivate and/or impact one or more processes (e.g., set values of one or more parameters of the one or more processes or start and/or stop one or more timers of the one or more processes) at the wireless device by employing one or more MAC commands. The one or more MAC commands may comprise one or more MAC control elements. In an example, the one or more processes may comprise activation and/or deactivation of PDCP packet duplication for one or more radio bearers. The base station may transmit a MAC CE comprising one or more fields, the values of the fields indicating activation and/or deactivation of PDCP duplication for the one or more radio bearers. In an example, the one or more processes may comprise Channel State Information (CSI) transmission of on one or more cells. The base station may transmit one or more MAC CEs indicating activation and/or deactivation of the CSI transmission on the one or more cells. In an example, the one or more processes may comprise activation or deactivation of one or more secondary cells. In an example, the base station may transmit a MA CE indicating activation or deactivation of one or more secondary cells. In an example, the base station may transmit one or more MAC CEs indicating starting and/or stopping one or more Discontinuous Reception (DRX) timers at the wireless device. In an example, the base station may transmit one or more MAC CEs indicating one or more timing advance values for one or more Timing Advance Groups (TAGs).

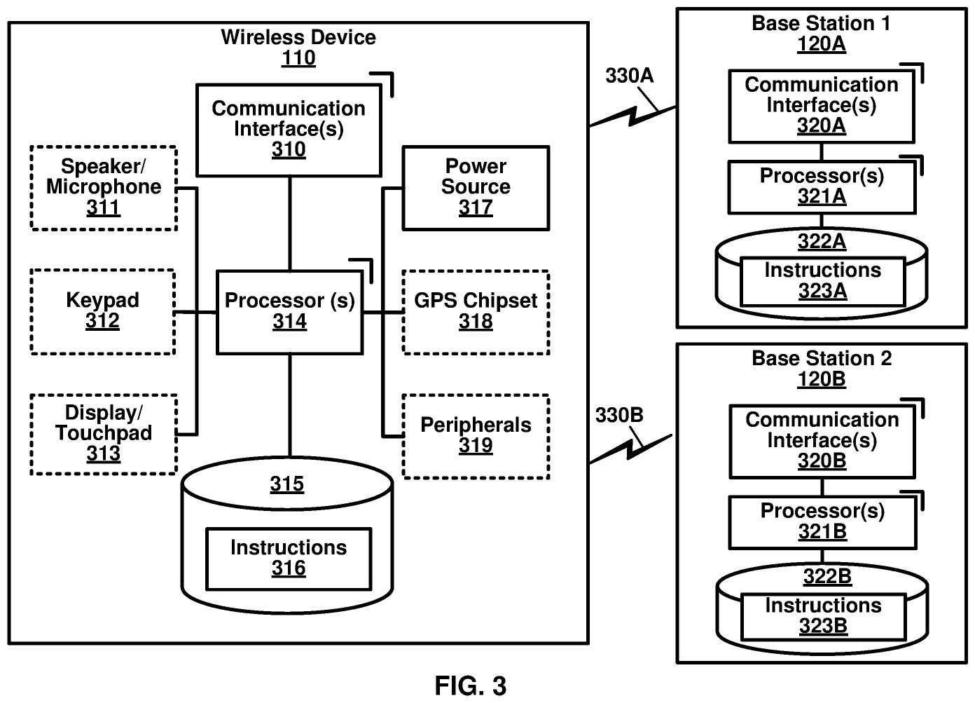

FIG. 3 is a block diagram of base stations (base station 1, 120A, and base station 2, 120B) and a wireless device 110. A wireless device may be called a UE. A base station may be called a NB, eNB, gNB, and/or ng-eNB. In an example, a wireless device and/or a base station may act as a relay node. The base station 1, 120A, may comprise at least one communication interface 320A (e.g. a wireless modem, an antenna, a wired modem, and/or the like), at least one processor 321A, and at least one set of program code instructions 323A stored in non-transitory memory 322A and executable by the at least one processor 321A. The base station 2, 120B, may comprise at least one communication interface 320B, at least one processor 321B, and at least one set of program code instructions 323B stored in non-transitory memory 322B and executable by the at least one processor 321B.

A base station may comprise many sectors for example: 1, 2, 3, 4, or 6 sectors. A base station may comprise many cells, for example, ranging from 1 to 50 cells or more. A cell may be categorized, for example, as a primary cell or secondary cell. At Radio Resource Control (RRC) connection establishment/re-establishment/handover, one serving cell may provide the NAS (non-access stratum) mobility information (e.g. Tracking Area Identifier (TAI)). At RRC connection re-establishment/handover, one serving cell may provide the security input. This cell may be referred to as the Primary Cell (PCell). In the downlink, a carrier corresponding to the PCell may be a DL Primary Component Carrier (PCC), while in the uplink, a carrier may be an UL PCC. Depending on wireless device capabilities, Secondary Cells (SCells) may be configured to form together with a PCell a set of serving cells. In a downlink, a carrier corresponding to an SCell may be a downlink secondary component carrier (DL SCC), while in an uplink, a carrier may be an uplink secondary component carrier (UL SCC). An SCell may or may not have an uplink carrier.

A cell, comprising a downlink carrier and optionally an uplink carrier, may be assigned a physical cell ID and a cell index. A carrier (downlink or uplink) may belong to one cell. The cell ID or cell index may also identify the downlink carrier or uplink carrier of the cell (depending on the context it is used). In the disclosure, a cell ID may be equally referred to a carrier ID, and a cell index may be referred to a carrier index. In an implementation, a physical cell ID or a cell index may be assigned to a cell. A cell ID may be determined using a synchronization signal transmitted on a downlink carrier. A cell index may be determined using RRC messages. For example, when the disclosure refers to a first physical cell ID for a first downlink carrier, the disclosure may mean the first physical cell ID is for a cell comprising the first downlink carrier. The same concept may apply to, for example, carrier activation. When the disclosure indicates that a first carrier is activated, the specification may equally mean that a cell comprising the first carrier is activated.

A base station may transmit to a wireless device one or more messages (e.g. RRC messages) comprising a plurality of configuration parameters for one or more cells. One or more cells may comprise at least one primary cell and at least one secondary cell. In an example, an RRC message may be broadcasted or unicasted to the wireless device. In an example, configuration parameters may comprise common parameters and dedicated parameters.

Services and/or functions of an RRC sublayer may comprise at least one of: broadcast of system information related to AS and NAS; paging initiated by 5GC and/or NG-RAN; establishment, maintenance, and/or release of an RRC connection between a wireless device and NG-RAN, which may comprise at least one of addition, modification and release of carrier aggregation; or addition, modification, and/or release of dual connectivity in NR or between E-UTRA and NR. Services and/or functions of an RRC sublayer may further comprise at least one of security functions comprising key management; establishment, configuration, maintenance, and/or release of Signaling Radio Bearers (SRBs) and/or Data Radio Bearers (DRBs); mobility functions which may comprise at least one of a handover (e.g. intra NR mobility or inter-RAT mobility) and a context transfer; or a wireless device cell selection and reselection and control of cell selection and reselection. Services and/or functions of an RRC sublayer may further comprise at least one of QoS management functions; a wireless device measurement configuration/reporting; detection of and/or recovery from radio link failure; or NAS message transfer to/from a core network entity (e.g. AMF, Mobility Management Entity (MME)) from/to the wireless device.

An RRC sublayer may support an RRC_Idle state, an RRC_Inactive state and/or an RRC_Connected state for a wireless device. In an RRC_Idle state, a wireless device may perform at least one of: Public Land Mobile Network (PLMN) selection; receiving broadcasted system information; cell selection/re-selection; monitoring/receiving a paging for mobile terminated data initiated by 5GC; paging for mobile terminated data area managed by 5GC; or DRX for CN paging configured via NAS. In an RRC_Inactive state, a wireless device may perform at least one of: receiving broadcasted system information; cell selection/re-selection; monitoring/receiving a RAN/CN paging initiated by NG-RAN/5GC; RAN-based notification area (RNA) managed by NG-RAN; or DRX for RAN/CN paging configured by NG-RAN/NAS. In an RRC_Idle state of a wireless device, a base station (e.g. NG-RAN) may keep a 5GC-NG-RAN connection (both C/U-planes) for the wireless device; and/or store a UE AS context for the wireless device. In an RRC Connected state of a wireless device, a base station (e.g. NG-RAN) may perform at least one of: establishment of 5GC-NG-RAN connection (both C/U-planes) for the wireless device; storing a UE AS context for the wireless device; transmit/receive of unicast data to/from the wireless device; or network-controlled mobility based on measurement results received from the wireless device. In an RRC_Connected state of a wireless device, an NG-RAN may know a cell that the wireless device belongs to.

System information (SI) may be divided into minimum SI and other SI. The minimum SI may be periodically broadcast. The minimum SI may comprise basic information required for initial access and information for acquiring any other SI broadcast periodically or provisioned on-demand, i.e. scheduling information. The other SI may either be broadcast, or be provisioned in a dedicated manner, either triggered by a network or upon request from a wireless device. A minimum SI may be transmitted via two different downlink channels using different messages (e.g. MasterInformationBlock and SystemInformationBlockType1). Another SI may be transmitted via SystemInformationBlockType2. For a wireless device in an RRC_Connected state, dedicated RRC signaling may be employed for the request and delivery of the other SI. For the wireless device in the RRC_Idle state and/or the RRC_Inactive state, the request may trigger a random-access procedure.

A wireless device may report its radio access capability information which may be static. A base station may request what capabilities for a wireless device to report based on band information. When allowed by a network, a temporary capability restriction request may be sent by the wireless device to signal the limited availability of some capabilities (e.g. due to hardware sharing, interference or overheating) to the base station. The base station may confirm or reject the request. The temporary capability restriction may be transparent to 5GC (e.g., static capabilities may be stored in 5GC).

When CA is configured, a wireless device may have an RRC connection with a network. At RRC connection establishment/re-establishment/handover procedure, one serving cell may provide NAS mobility information, and at RRC connection re-establishment/handover, one serving cell may provide a security input. This cell may be referred to as the PCell. Depending on the capabilities of the wireless device, SCells may be configured to form together with the PCell a set of serving cells. The configured set of serving cells for the wireless device may comprise one PCell and one or more SCells.

The reconfiguration, addition and removal of SCells may be performed by RRC. At intra-NR handover, RRC may also add, remove, or reconfigure SCells for usage with the target PCell. When adding a new SCell, dedicated RRC signaling may be employed to send all required system information of the SCell i.e. while in connected mode, wireless devices may not need to acquire broadcasted system information directly from the SCells.

The purpose of an RRC connection reconfiguration procedure may be to modify an RRC connection, (e.g. to establish, modify and/or release RBs, to perform handover, to setup, modify, and/or release measurements, to add, modify, and/or release SCells and cell groups). As part of the RRC connection reconfiguration procedure, NAS dedicated information may be transferred from the network to the wireless device. The RRCConnectionReconfiguration message may be a command to modify an RRC connection. It may convey information for measurement configuration, mobility control, radio resource configuration (e.g. RBs, MAC main configuration and physical channel configuration) comprising any associated dedicated NAS information and security configuration. If the received RRC Connection Reconfiguration message includes the sCellToReleaseList, the wireless device may perform an SCell release. If the received RRC Connection Reconfiguration message includes the sCellToAddModList, the wireless device may perform SCell additions or modification.

An RRC connection establishment (or reestablishment, resume) procedure may be to establish (or reestablish, resume) an RRC connection. an RRC connection establishment procedure may comprise SRB1 establishment. The RRC connection establishment procedure may be used to transfer the initial NAS dedicated information/ message from a wireless device to E-UTRAN. The RRCConnectionReestablishment message may be used to re-establish SRB1.

A measurement report procedure may be to transfer measurement results from a wireless device to NG-RAN. The wireless device may initiate a measurement report procedure after successful security activation. A measurement report message may be employed to transmit measurement results.

The wireless device 110 may comprise at least one communication interface 310 (e.g. a wireless modem, an antenna, and/or the like), at least one processor 314, and at least one set of program code instructions 316 stored in non-transitory memory 315 and executable by the at least one processor 314. The wireless device 110 may further comprise at least one of at least one speaker/microphone 311, at least one keypad 312, at least one display/touchpad 313, at least one power source 317, at least one global positioning system (GPS) chipset 318, and other peripherals 319.

The processor 314 of the wireless device 110, the processor 321A of the base station 1 120A, and/or the processor 321B of the base station 2 120B may comprise at least one of a general-purpose processor, a digital signal processor (DSP), a controller, a microcontroller, an application specific integrated circuit (ASIC), a field programmable gate array (FPGA) and/or other programmable logic device, discrete gate and/or transistor logic, discrete hardware components, and the like. The processor 314 of the wireless device 110, the processor 321A in base station 1 120A, and/or the processor 321B in base station 2 120B may perform at least one of signal coding/processing, data processing, power control, input/output processing, and/or any other functionality that may enable the wireless device 110, the base station 1 120A and/or the base station 2 120B to operate in a wireless environment.

The processor 314 of the wireless device 110 may be connected to the speaker/microphone 311, the keypad 312, and/or the display/touchpad 313. The processor 314 may receive user input data from and/or provide user output data to the speaker/microphone 311, the keypad 312, and/or the display/touchpad 313. The processor 314 in the wireless device 110 may receive power from the power source 317 and/or may be configured to distribute the power to the other components in the wireless device 110. The power source 317 may comprise at least one of one or more dry cell batteries, solar cells, fuel cells, and the like. The processor 314 may be connected to the GPS chipset 318. The GPS chipset 318 may be configured to provide geographic location information of the wireless device 110.

The processor 314 of the wireless device 110 may further be connected to other peripherals 319, which may comprise one or more software and/or hardware modules that provide additional features and/or functionalities. For example, the peripherals 319 may comprise at least one of an accelerometer, a satellite transceiver, a digital camera, a universal serial bus (USB) port, a hands-free headset, a frequency modulated (FM) radio unit, a media player, an Internet browser, and the like.

The communication interface 320A of the base station 1, 120A, and/or the communication interface 320B of the base station 2, 120B, may be configured to communicate with the communication interface 310 of the wireless device 110 via a wireless link 330A and/or a wireless link 330B, respectively. In an example, the communication interface 320A of the base station 1, 120A, may communicate with the communication interface 320B of the base station 2 and other RAN and core network nodes.

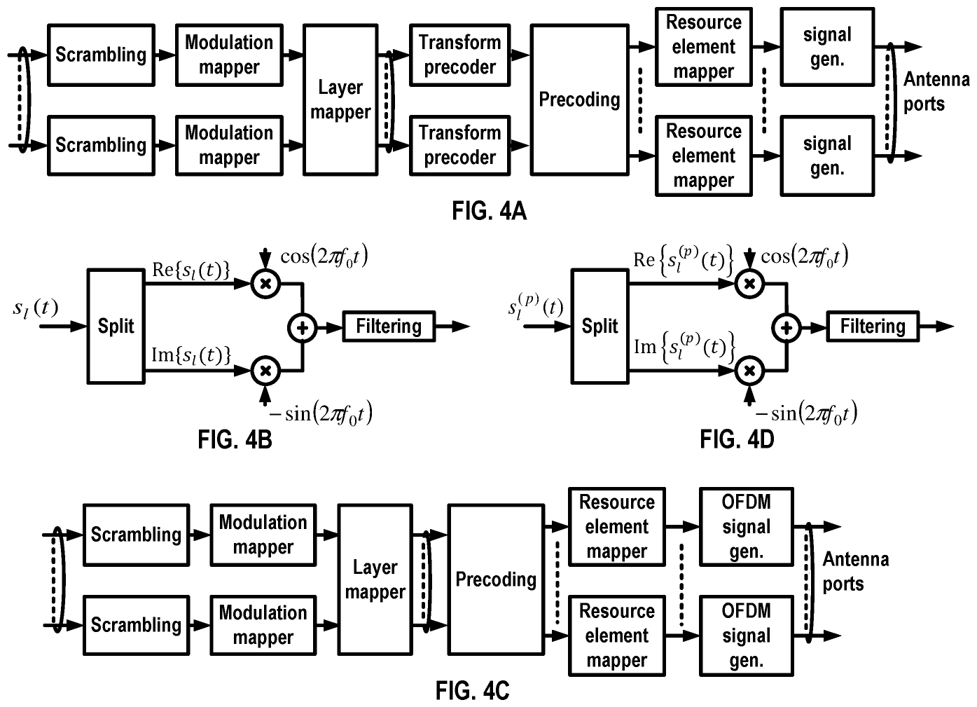

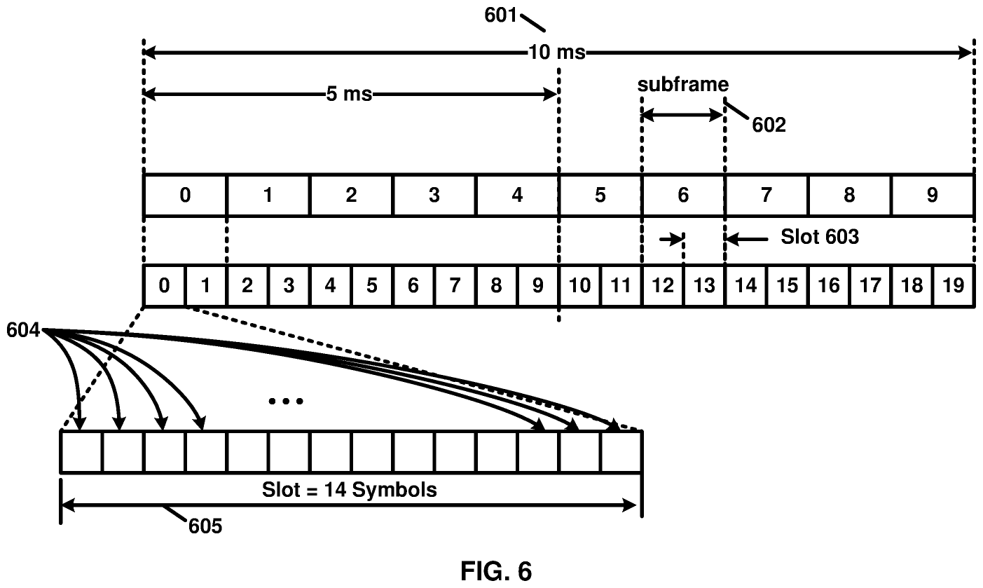

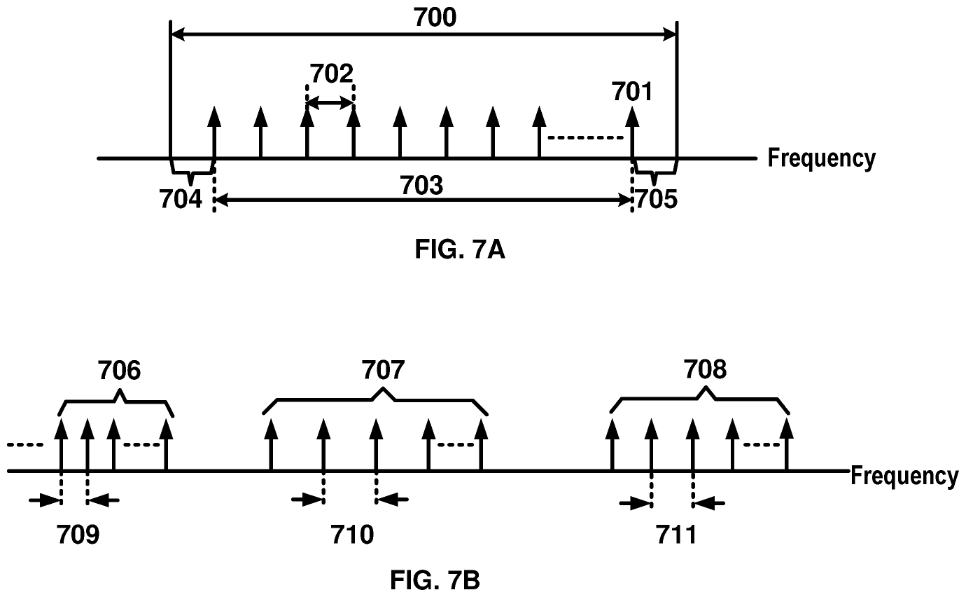

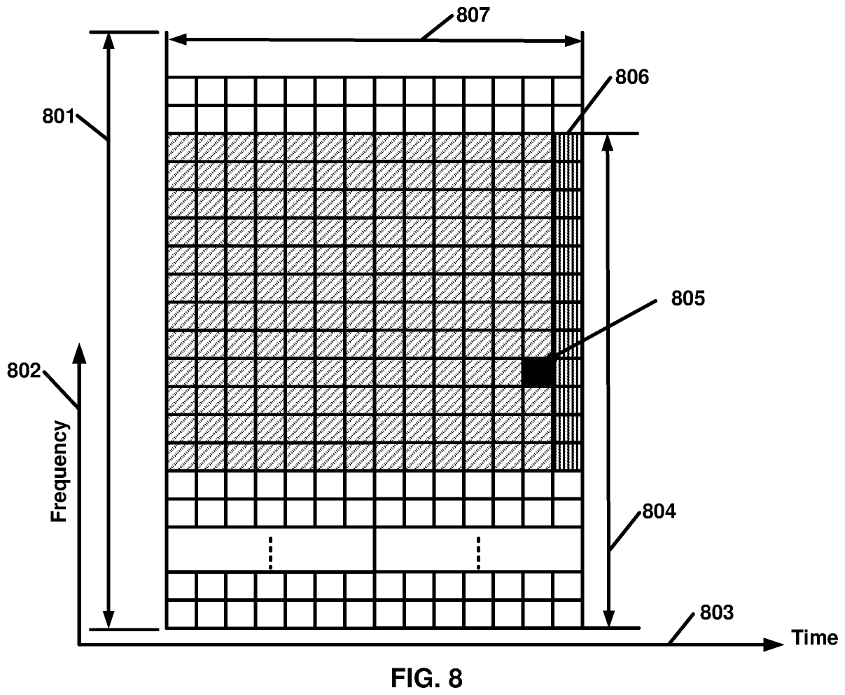

The wireless link 330A and/or the wireless link 330B may comprise at least one of a bi-directional link and/or a directional link. The communication interface 310 of the wireless device 110 may be configured to communicate with the communication interface 320A of the base station 1 120A and/or with the communication interface 320B of the base station 2 120B. The base station 1 120A and the wireless device 110 and/or the base station 2 120B and the wireless device 110 may be configured to send and receive transport blocks via the wireless link 330A and/or via the wireless link 330B, respectively. The wireless link 330A and/or the wireless link 330B may employ at least one frequency carrier. According to some of various aspects of embodiments, transceiver(s) may be employed. A transceiver may be a device that comprises both a transmitter and a receiver. Transceivers may be employed in devices such as wireless devices, base stations, relay nodes, and/or the like. Example embodiments for radio technology implemented in the communication interface 310, 320A, 320B and the wireless link 330A, 330B are illustrated in FIG. 4A, FIG. 4B, FIG. 4C, FIG. 4D, FIG. 6, FIG. 7A, FIG. 7B, FIG. 8, and associated text.

In an example, other nodes in a wireless network (e.g. AMF, UPF, SMF, etc.) may comprise one or more communication interfaces, one or more processors, and memory storing instructions.

A node (e.g. wireless device, base station, AMF, SMF, UPF, servers, switches, antennas, and/or the like) may comprise one or more processors, and memory storing instructions that when executed by the one or more processors causes the node to perform certain processes and/or functions. Example embodiments may enable operation of single-carrier and/or multi-carrier communications. Other example embodiments may comprise a non-transitory tangible computer readable media comprising instructions executable by one or more processors to cause operation of single-carrier and/or multi-carrier communications. Yet other example embodiments may comprise an article of manufacture that comprises a non-transitory tangible computer readable machine-accessible medium having instructions encoded thereon for enabling programmable hardware to cause a node to enable operation of single-carrier and/or multi-carrier communications. The node may include processors, memory, interfaces, and/or the like.

An interface may comprise at least one of a hardware interface, a firmware interface, a software interface, and/or a combination thereof. The hardware interface may comprise connectors, wires, electronic devices such as drivers, amplifiers, and/or the like. The software interface may comprise code stored in a memory device to implement protocol(s), protocol layers, communication drivers, device drivers, combinations thereof, and/or the like. The firmware interface may comprise a combination of embedded hardware and code stored in and/or in communication with a memory device to implement connections, electronic device operations, protocol(s), protocol layers, communication drivers, device drivers, hardware operations, combinations thereof, and/or the like.

FIG. 4A, FIG. 4B, FIG. 4C and FIG. 4D are example diagrams for uplink and downlink signal transmission as per an aspect of an embodiment of the present disclosure. FIG. 4A shows an example uplink transmitter for at least one physical channel. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, an CP-OFDM signal for uplink transmission may be generated by FIG. 4A. These functions are illustrated as examples and it is anticipated that other mechanisms may be implemented in various embodiments.

An example structure for modulation and up-conversion to the carrier frequency of the complex-valued SC-FDMA or CP-OFDM baseband signal for an antenna port and/or the complex-valued Physical Random Access CHannel (PRACH) baseband signal is shown in FIG. 4B. Filtering may be employed prior to transmission.

An example structure for downlink transmissions is shown in FIG. 4C. The baseband signal representing a downlink physical channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

In an example, a gNB may transmit a first symbol and a second symbol on an antenna port, to a wireless device. The wireless device may infer the channel (e.g., fading gain, multipath delay, etc.) for conveying the second symbol on the antenna port, from the channel for conveying the first symbol on the antenna port. In an example, a first antenna port and a second antenna port may be quasi co-located if one or more large-scale properties of the channel over which a first symbol on the first antenna port is conveyed may be inferred from the channel over which a second symbol on a second antenna port is conveyed. The one or more large-scale properties may comprise at least one of: delay spread; doppler spread; doppler shift; average gain; average delay; and/or spatial Receiving (Rx) parameters.

An example modulation and up-conversion to the carrier frequency of the complex-valued OFDM baseband signal for an antenna port is shown in FIG. 4D. Filtering may be employed prior to transmission.

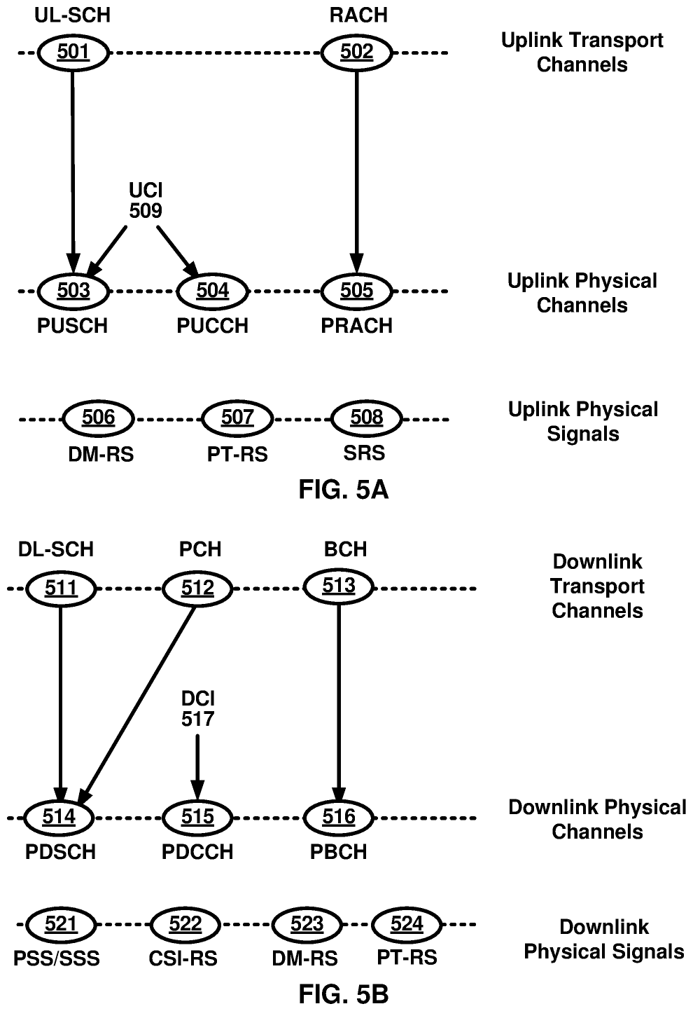

FIG. 5A is a diagram of an example uplink channel mapping and example uplink physical signals. FIG. 5B is a diagram of an example downlink channel mapping and a downlink physical signals. In an example, a physical layer may provide one or more information transfer services to a MAC and/or one or more higher layers. For example, the physical layer may provide the one or more information transfer services to the MAC via one or more transport channels. An information transfer service may indicate how and with what characteristics data are transferred over the radio interface.

In an example embodiment, a radio network may comprise one or more downlink and/or uplink transport channels. For example, a diagram in FIG. 5A shows example uplink transport channels comprising Uplink-Shared CHannel (UL-SCH) 501 and Random Access CHannel (RACH) 502. A diagram in FIG. 5B shows example downlink transport channels comprising Downlink-Shared CHannel (DL-SCH) 511, Paging CHannel (PCH) 512, and Broadcast CHannel (BCH) 513. A transport channel may be mapped to one or more corresponding physical channels. For example, UL-SCH 501 may be mapped to Physical Uplink Shared CHannel (PUSCH) 503. RACH 502 may be mapped to PRACH 505. DL-SCH 511 and PCH 512 may be mapped to Physical Downlink Shared CHannel (PDSCH) 514. BCH 513 may be mapped to Physical Broadcast CHannel (PBCH) 516.

There may be one or more physical channels without a corresponding transport channel. The one or more physical channels may be employed for Uplink Control Information (UCI) 509 and/or Downlink Control Information (DCI) 517. For example, Physical Uplink Control CHannel (PUCCH) 504 may carry UCI 509 from a UE to a base station. For example, Physical Downlink Control CHannel (PDCCH) 515 may carry DCI 517 from a base station to a UE. NR may support UCI 509 multiplexing in PUSCH 503 when UCI 509 and PUSCH 503 transmissions may coincide in a slot at least in part. The UCI 509 may comprise at least one of CSI, Acknowledgement (ACK)/Negative Acknowledgement (NACK), and/or scheduling request. The DCI 517 on PDCCH 515 may indicate at least one of following: one or more downlink assignments and/or one or more uplink scheduling grants

In uplink, a UE may transmit one or more Reference Signals (RSs) to a base station. For example, the one or more RSs may be at least one of Demodulation-RS (DM-RS) 506, Phase Tracking-RS (PT-RS) 507, and/or Sounding RS (SRS) 508. In downlink, a base station may transmit (e.g., unicast, multicast, and/or broadcast) one or more RSs to a UE. For example, the one or more RSs may be at least one of Primary Synchronization Signal (PSS)/Secondary Synchronization Signal (SSS) 521, CSI-RS 522, DM-RS 523, and/or PT-RS 524.

In an example, a UE may transmit one or more uplink DM-RSs 506 to a base station for channel estimation, for example, for coherent demodulation of one or more uplink physical channels (e.g., PUSCH 503 and/or PUCCH 504). For example, a UE may transmit a base station at least one uplink DM-RS 506 with PUSCH 503 and/or PUCCH 504, wherein the at least one uplink DM-RS 506 may be spanning a same frequency range as a corresponding physical channel. In an example, a base station may configure a UE with one or more uplink DM-RS configurations. At least one DM-RS configuration may support a front-loaded DM-RS pattern. A front-loaded DM-RS may be mapped over one or more OFDM symbols (e.g., 1 or 2 adjacent OFDM symbols). One or more additional uplink DM-RS may be configured to transmit at one or more symbols of a PUSCH and/or PUCCH. A base station may semi-statistically configure a UE with a maximum number of front-loaded DM-RS symbols for PUSCH and/or PUCCH. For example, a UE may schedule a single-symbol DM-RS and/or double symbol DM-RS based on a maximum number of front-loaded DM-RS symbols, wherein a base station may configure the UE with one or more additional uplink DM-RS for PUSCH and/or PUCCH. A new radio network may support, e.g., at least for CP-OFDM, a common DM-RS structure for DL and UL, wherein a DM-RS location, DM-RS pattern, and/or scrambling sequence may be same or different.

In an example, whether uplink PT-RS 507 is present or not may depend on an RRC configuration. For example, a presence of uplink PT-RS may be UE-specifically configured. For example, a presence and/or a pattern of uplink PT-RS 507 in a scheduled resource may be UE-specifically configured by a combination of RRC signaling and/or association with one or more parameters employed for other purposes (e.g., Modulation and Coding Scheme (MCS)) which may be indicated by DCI. When configured, a dynamic presence of uplink PT-RS 507 may be associated with one or more DCI parameters comprising at least MCS. A radio network may support plurality of uplink PT-RS densities defined in time/frequency domain. When present, a frequency domain density may be associated with at least one configuration of a scheduled bandwidth. A UE may assume a same precoding for a DMRS port and a PT-RS port. A number of PT-RS ports may be fewer than a number of DM-RS ports in a scheduled resource. For example, uplink PT-RS 507 may be confined in the scheduled time/frequency duration for a UE.

In an example, a UE may transmit SRS 508 to a base station for channel state estimation to support uplink channel dependent scheduling and/or link adaptation. For example, SRS 508 transmitted by a UE may allow for a base station to estimate an uplink channel state at one or more different frequencies. A base station scheduler may employ an uplink channel state to assign one or more resource blocks of good quality for an uplink PUSCH transmission from a UE. A base station may semi-statistically configure a UE with one or more SRS resource sets. For an SRS resource set, a base station may configure a UE with one or more SRS resources. An SRS resource set applicability may be configured by a higher layer (e.g., RRC) parameter. For example, when a higher layer parameter indicates beam management, a SRS resource in each of one or more SRS resource sets may be transmitted at a time instant. A UE may transmit one or more SRS resources in different SRS resource sets simultaneously. A new radio network may support aperiodic, periodic and/or semi-persistent SRS transmissions. A UE may transmit SRS resources based on one or more trigger types, wherein the one or more trigger types may comprise higher layer signaling (e.g., RRC) and/or one or more DCI formats (e.g., at least one DCI format may be employed for a UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH 503 and SRS 508 are transmitted in a same slot, a UE may be configured to transmit SRS 508 after a transmission of PUSCH 503 and corresponding uplink DM-RS 506.

In an example, a base station may semi-statistically configure a UE with one or more SRS configuration parameters indicating at least one of following: a SRS resource configuration identifier, a number of SRS ports, time domain behavior of SRS resource configuration (e.g., an indication of periodic, semi-persistent, or aperiodic SRS), slot (mini-slot, and/or subframe) level periodicity and/or offset for a periodic and/or aperiodic SRS resource, a number of OFDM symbols in a SRS resource, starting OFDM symbol of a SRS resource, a SRS bandwidth, a frequency hopping bandwidth, a cyclic shift, and/or a SRS sequence ID.

In an example, in a time domain, an SS/PBCH block may comprise one or more OFDM symbols (e.g., 4 OFDM symbols numbered in increasing order from 0 to 3) within the SS/PBCH block. An SS/PBCH block may comprise PSS/SSS 521 and PBCH 516. In an example, in the frequency domain, an SS/PBCH block may comprise one or more contiguous subcarriers (e.g., 240 contiguous subcarriers with the subcarriers numbered in increasing order from 0 to 239) within the SS/PBCH block. For example, a PSS/SSS 521 may occupy 1 OFDM symbol and 127 subcarriers. For example, PBCH 516 may span across 3 OFDM symbols and 240 subcarriers. A UE may assume that one or more SS/PBCH blocks transmitted with a same block index may be quasi co-located, e.g., with respect to Doppler spread, Doppler shift, average gain, average delay, and spatial Rx parameters. A UE may not assume quasi co-location for other SS/PBCH block transmissions. A periodicity of an SS/PBCH block may be configured by a radio network (e.g., by an RRC signaling) and one or more time locations where the SS/PBCH block may be sent may be determined by sub-carrier spacing. In an example, a UE may assume a band-specific sub-carrier spacing for an SS/PBCH block unless a radio network has configured a UE to assume a different sub-carrier spacing.

In an example, downlink CSI-RS 522 may be employed for a UE to acquire channel state information. A radio network may support periodic, aperiodic, and/or semi-persistent transmission of downlink CSI-RS 522. For example, a base station may semi-statistically configure and/or reconfigure a UE with periodic transmission of downlink CSI-RS 522. A configured CSI-RS resources may be activated ad/or deactivated. For semi-persistent transmission, an activation and/or deactivation of CSI-RS resource may be triggered dynamically. In an example, CSI-RS configuration may comprise one or more parameters indicating at least a number of antenna ports. For example, a base station may configure a UE with 32 ports. A base station may semi-statistically configure a UE with one or more CSI-RS resource sets. One or more CSI-RS resources may be allocated from one or more CSI-RS resource sets to one or more UEs. For example, a base station may semi-statistically configure one or more parameters indicating CSI RS resource mapping, for example, time-domain location of one or more CSI-RS resources, a bandwidth of a CSI-RS resource, and/or a periodicity. In an example, a UE may be configured to employ a same OFDM symbols for downlink CSI-RS 522 and control resource set (coreset) when the downlink CSI-RS 522 and coreset are spatially quasi co-located and resource elements associated with the downlink CSI-RS 522 are the outside of PRBs configured for coreset. In an example, a UE may be configured to employ a same OFDM symbols for downlink CSI-RS 522 and SSB/PBCH when the downlink CSI-RS 522 and SSB/PBCH are spatially quasi co-located and resource elements associated with the downlink CSI-RS 522 are the outside of PRBs configured for SSB/PBCH.

In an example, a UE may transmit one or more downlink DM-RSs 523 to a base station for channel estimation, for example, for coherent demodulation of one or more downlink physical channels (e.g., PDSCH 514). For example, a radio network may support one or more variable and/or configurable DM-RS patterns for data demodulation. At least one downlink DM-RS configuration may support a front-loaded DM-RS pattern. A front-loaded DM-RS may be mapped over one or more OFDM symbols (e.g., 1 or 2 adjacent OFDM symbols). A base station may semi-statistically configure a UE with a maximum number of front-loaded DM-RS symbols for PDSCH 514. For example, a DM-RS configuration may support one or more DM-RS ports. For example, for single user-MIMO, a DM-RS configuration may support at least 8 orthogonal downlink DM-RS ports. For example, for multiuser-MIMO, a DM-RS configuration may support 12 orthogonal downlink DM-RS ports. A radio network may support, e.g., at least for CP-OFDM, a common DM-RS structure for DL and UL, wherein a DM-RS location, DM-RS pattern, and/or scrambling sequence may be same or different.

In an example, whether downlink PT-RS 524 is present or not may depend on an RRC configuration. For example, a presence of downlink PT-RS 524 may be UE-specifically configured. For example, a presence and/or a pattern of downlink PT-RS 524 in a scheduled resource may be UE-specifically configured by a combination of RRC signaling and/or association with one or more parameters employed for other purposes (e.g., MCS) which may be indicated by DCI. When configured, a dynamic presence of downlink PT-RS 524 may be associated with one or more DCI parameters comprising at least MCS. A radio network may support plurality of PT-RS densities defined in time/frequency domain. When present, a frequency domain density may be associated with at least one configuration of a scheduled bandwidth. A UE may assume a same precoding for a DMRS port and a PT-RS port. A number of PT-RS ports may be fewer than a number of DM-RS ports in a scheduled resource. For example, downlink PT-RS 524 may be confined in the scheduled time/frequency duration for a UE.

FIG. 6 is a diagram depicting an example frame structure for a carrier as per an aspect of an embodiment of the present disclosure. A multicarrier OFDM communication system may include one or more carriers, for example, ranging from 1 to 32 carriers, in case of carrier aggregation, or ranging from 1 to 64 carriers, in case of dual connectivity. Different radio frame structures may be supported (e.g., for FDD and for TDD duplex mechanisms). FIG. 6 shows an example frame structure. Downlink and uplink transmissions may be organized into radio frames 601. In this example, radio frame duration is 10 ms. In this example, a 10 ms radio frame 601 may be divided into ten equally sized subframes 602 with 1 ms duration. Subframe(s) may comprise one or more slots (e.g. slots 603 and 605) depending on subcarrier spacing and/or CP length. For example, a subframe with 15 kHz, 30 kHz, 60 kHz, 120 kHz, 240 kHz and 480 kHz subcarrier spacing may comprise one, two, four, eight, sixteen and thirty-two slots, respectively. In FIG. 6, a subframe may be divided into two equally sized slots 603 with 0.5 ms duration. For example, 10 subframes may be available for downlink transmission and 10 subframes may be available for uplink transmissions in a 10 ms interval. Uplink and downlink transmissions may be separated in the frequency domain. Slot(s) may include a plurality of OFDM symbols 604. The number of OFDM symbols 604 in a slot 605 may depend on the cyclic prefix length. For example, a slot may be 14 OFDM symbols for the same subcarrier spacing of up to 480 kHz with normal CP. A slot may be 12 OFDM symbols for the same subcarrier spacing of 60 kHz with extended CP. A slot may contain downlink, uplink, or a downlink part and an uplink part and/or alike.

FIG. 7A is a diagram depicting example sets of OFDM subcarriers as per an aspect of an embodiment of the present disclosure. In the example, a gNB may communicate with a wireless device with a carrier with an example channel bandwidth 700. Arrow(s) in the diagram may depict a subcarrier in a multicarrier OFDM system. The OFDM system may use technology such as OFDM technology, SC-FDMA technology, and/or the like. In an example, an arrow 701 shows a subcarrier transmitting information symbols. In an example, a subcarrier spacing 702, between two contiguous subcarriers in a carrier, may be any one of 15 KHz, 30 KHz, 60 KHz, 120 KHz, 240 KHz etc. In an example, different subcarrier spacing may correspond to different transmission numerologies. In an example, a transmission numerology may comprise at least: a numerology index; a value of subcarrier spacing; a type of cyclic prefix (CP). In an example, a gNB may transmit to/receive from a UE on a number of subcarriers 703 in a carrier. In an example, a bandwidth occupied by a number of subcarriers 703 (transmission bandwidth) may be smaller than the channel bandwidth 700 of a carrier, due to guard band 704 and 705. In an example, a guard band 704 and 705 may be used to reduce interference to and from one or more neighbor carriers. A number of subcarriers (transmission bandwidth) in a carrier may depend on the channel bandwidth of the carrier and the subcarrier spacing. For example, a transmission bandwidth, for a carrier with 20 MHz channel bandwidth and 15 KHz subcarrier spacing, may be in number of 1024 subcarriers.

In an example, a gNB and a wireless device may communicate with multiple CCs when configured with CA. In an example, different component carriers may have different bandwidth and/or subcarrier spacing, if CA is supported. In an example, a gNB may transmit a first type of service to a UE on a first component carrier. The gNB may transmit a second type of service to the UE on a second component carrier. Different type of services may have different service requirement (e.g., data rate, latency, reliability), which may be suitable for transmission via different component carrier having different subcarrier spacing and/or bandwidth. FIG. 7B shows an example embodiment. A first component carrier may comprise a first number of subcarriers 706 with a first subcarrier spacing 709. A second component carrier may comprise a second number of subcarriers 707 with a second subcarrier spacing 710. A third component carrier may comprise a third number of subcarriers 708 with a third subcarrier spacing 711. Carriers in a multicarrier OFDM communication system may be contiguous carriers, non-contiguous carriers, or a combination of both contiguous and non-contiguous carriers.

FIG. 8 is a diagram depicting OFDM radio resources as per an aspect of an embodiment of the present disclosure. In an example, a carrier may have a transmission bandwidth 801. In an example, a resource grid may be in a structure of frequency domain 802 and time domain 803. In an example, a resource grid may comprise a first number of OFDM symbols in a subframe and a second number of resource blocks, starting from a common resource block indicated by higher-layer signaling (e.g. RRC signaling), for a transmission numerology and a carrier. In an example, in a resource grid, a resource unit identified by a subcarrier index and a symbol index may be a resource element 805. In an example, a subframe may comprise a first number of OFDM symbols 807 depending on a numerology associated with a carrier. For example, when a subcarrier spacing of a numerology of a carrier is 15 KHz, a subframe may have 14 OFDM symbols for a carrier. When a subcarrier spacing of a numerology is 30 KHz, a subframe may have 28 OFDM symbols. When a subcarrier spacing of a numerology is 60 Khz, a subframe may have 56 OFDM symbols, etc. In an example, a second number of resource blocks comprised in a resource grid of a carrier may depend on a bandwidth and a numerology of the carrier.

As shown in FIG. 8, a resource block 806 may comprise 12 subcarriers. In an example, multiple resource blocks may be grouped into a Resource Block Group (RBG) 804. In an example, a size of an RBG may depend on at least one of: an RRC message indicating a RBG size configuration; a size of a carrier bandwidth; or a size of a bandwidth part of a carrier. In an example, a carrier may comprise multiple bandwidth parts. A first bandwidth part of a carrier may have different frequency location and/or bandwidth from a second bandwidth part of the carrier.

In an example, a gNB may transmit a downlink control information comprising a downlink or uplink resource block assignment to a wireless device. A base station may transmit to or receive from, a wireless device, data packets (e.g. transport blocks) scheduled and transmitted via one or more resource blocks and one or more slots according to parameters in a downlink control information and/or RRC message(s). In an example, a starting symbol relative to a first slot of the one or more slots may be indicated to the wireless device. In an example, a gNB may transmit to or receive from, a wireless device, data packets scheduled on one or more RBGs and one or more slots.

In an example, a gNB may transmit a downlink control information comprising a downlink assignment to a wireless device via one or more PDCCHs. The downlink assignment may comprise parameters indicating at least modulation and coding format; resource allocation; and/or HARQ information related to DL-SCH. In an example, a resource allocation may comprise parameters of resource block allocation; and/or slot allocation. In an example, a gNB may dynamically allocate resources to a wireless device via a Cell-Radio Network Temporary Identifier (C-RNTI) on one or more PDCCHs. The wireless device may monitor the one or more PDCCHs in order to find possible allocation when its downlink reception is enabled. The wireless device may receive one or more downlink data package on one or more PDSCH scheduled by the one or more PDCCHs, when successfully detecting the one or more PDCCHs.

In an example, a gNB may allocate Configured Scheduling (CS) resources for down link transmission to a wireless device. The gNB may transmit one or more RRC messages indicating a periodicity of the CS grant. The gNB may transmit a DCI via a PDCCH addressed to a Configured Scheduling-RNTI (CS-RNTI) activating the CS resources. The DCI may comprise parameters indicating that the downlink grant is a CS grant. The CS grant may be implicitly reused according to the periodicity defined by the one or more RRC messages, until deactivated.

In an example, a gNB may transmit a downlink control information comprising an uplink grant to a wireless device via one or more PDCCHs. The uplink grant may comprise parameters indicating at least modulation and coding format; resource allocation; and/or HARQ information related to UL-SCH. In an example, a resource allocation may comprise parameters of resource block allocation; and/or slot allocation. In an example, a gNB may dynamically allocate resources to a wireless device via a C-RNTI on one or more PDCCHs. The wireless device may monitor the one or more PDCCHs in order to find possible resource allocation. The wireless device may transmit one or more uplink data package via one or more PUSCH scheduled by the one or more PDCCHs, when successfully detecting the one or more PDCCHs.

In an example, a gNB may allocate CS resources for uplink data transmission to a wireless device. The gNB may transmit one or more RRC messages indicating a periodicity of the CS grant. The gNB may transmit a DCI via a PDCCH addressed to a CS-RNTI activating the CS resources. The DCI may comprise parameters indicating that the uplink grant is a CS grant. The CS grant may be implicitly reused according to the periodicity defined by the one or more RRC message, until deactivated.

In an example, a base station may transmit DCl/control signaling via PDCCH. The DCI may take a format in a plurality of formats. A DCI may comprise downlink and/or uplink scheduling information (e.g., resource allocation information, HARQ related parameters, MCS), request for CSI (e.g., aperiodic CQI reports), request for SRS, uplink power control commands for one or more cells, one or more timing information (e.g., TB transmission/reception timing, HARQ feedback timing, etc.), etc. In an example, a DCI may indicate an uplink grant comprising transmission parameters for one or more transport blocks. In an example, a DCI may indicate downlink assignment indicating parameters for receiving one or more transport blocks. In an example, a DCI may be used by base station to initiate a contention-free random access at the wireless device. In an example, the base station may transmit a DCI comprising slot format indicator (SFI) notifying a slot format. In an example, the base station may transmit a DCI comprising pre-emption indication notifying the PRB(s) and/or OFDM symbol(s) where a UE may assume no transmission is intended for the UE. In an example, the base station may transmit a DCI for group power control of PUCCH or PUSCH or SRS. In an example, a DCI may correspond to an RNTI. In an example, the wireless device may obtain an RNTI in response to completing the initial access (e.g., C-RNTI). In an example, the base station may configure an RNTI for the wireless (e.g., CS-RNTI, TPC-CS-RNTI, TPC-PUCCH-RNTI, TPC-PUSCH-RNTI, TPC-SRS-RNTI). In an example, the wireless device may compute an RNTI (e.g., the wireless device may compute RA-RNTI based on resources used for transmission of a preamble). In an example, an RNTI may have a pre-configured value (e.g., P-RNTI or SI-RNTI). In an example, a wireless device may monitor a group common search space which may be used by base station for transmitting DCIs that are intended for a group of UEs. In an example, a group common DCI may correspond to an RNTI which is commonly configured for a group of UEs. In an example, a wireless device may monitor a UE-specific search space. In an example, a UE specific DCI may correspond to an RNTI configured for the wireless device.

A NR system may support a single beam operation and/or a multi-beam operation. In a multi-beam operation, a base station may perform a downlink beam sweeping to provide coverage for common control channels and/or downlink SS blocks, which may comprise at least a PSS, a SSS, and/or PBCH. A wireless device may measure quality of a beam pair link using one or more RSs. One or more SS blocks, or one or more CSI-RS resources, associated with a CSI-RS resource index (CRI), or one or more DM-RSs of PBCH, may be used as RS for measuring quality of a beam pair link. Quality of a beam pair link may be defined as a reference signal received power (RSRP) value, or a reference signal received quality (RSRQ) value, and/or a CSI value measured on RS resources. The base station may indicate whether an RS resource, used for measuring a beam pair link quality, is quasi-co-located (QCLed) with DM-RSs of a control channel. A RS resource and DM-RSs of a control channel may be called QCLed when a channel characteristics from a transmission on an RS to a wireless device, and that from a transmission on a control channel to a wireless device, are similar or same under a configured criterion. In a multi-beam operation, a wireless device may perform an uplink beam sweeping to access a cell.

In an example, a wireless device may be configured to monitor PDCCH on one or more beam pair links simultaneously depending on a capability of a wireless device. This may increase robustness against beam pair link blocking. A base station may transmit one or more messages to configure a wireless device to monitor PDCCH on one or more beam pair links in different PDCCH OFDM symbols. For example, a base station may transmit higher layer signaling (e.g. RRC signaling) or MAC CE comprising parameters related to the Rx beam setting of a wireless device for monitoring PDCCH on one or more beam pair links. A base station may transmit indication of spatial QCL assumption between an DL RS antenna port(s) (for example, cell-specific CSI-RS, or wireless device-specific CSI-RS, or SS block, or PBCH with or without DM-RSs of PBCH), and DL RS antenna port(s) for demodulation of DL control channel. Signaling for beam indication for a PDCCH may be MAC CE signaling, or RRC signaling, or DCI signaling, or specification-transparent and/or implicit method, and combination of these signaling methods.

For reception of unicast DL data channel, a base station may indicate spatial QCL parameters between DL RS antenna port(s) and DM-RS antenna port(s) of DL data channel. The base station may transmit DCI (e.g. downlink grants) comprising information indicating the RS antenna port(s). The information may indicate RS antenna port(s) which may be QCL-ed with the DM-RS antenna port(s). Different set of DM-RS antenna port(s) for a DL data channel may be indicated as QCL with different set of the RS antenna port(s).

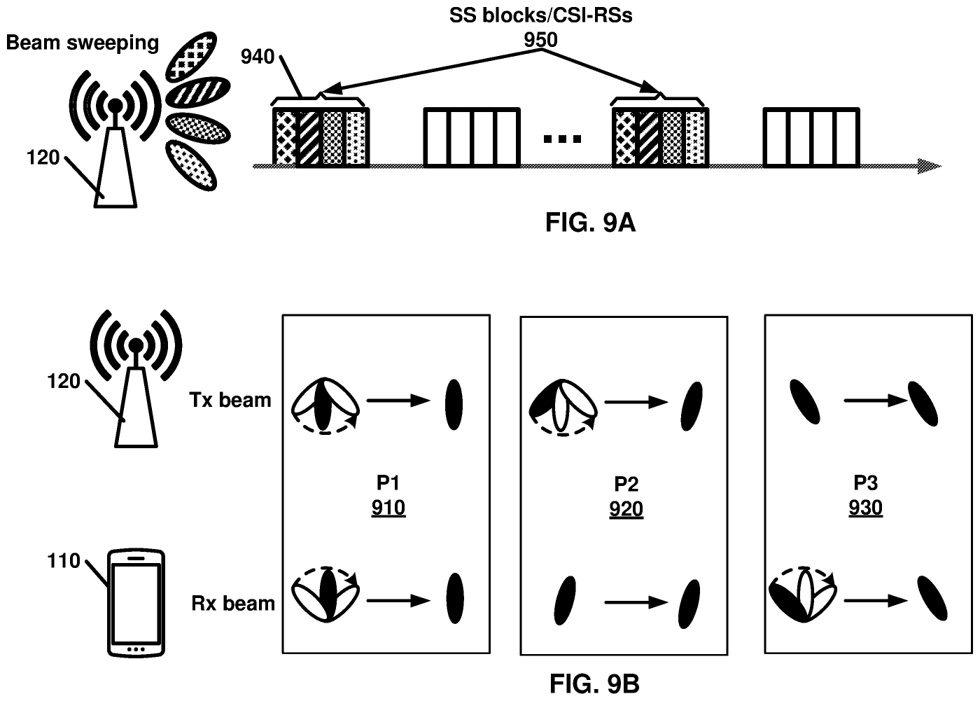

FIG. 9A is an example of beam sweeping in a DL channel. In an RRC_INACTIVE state or RRC_IDLE state, a wireless device may assume that SS blocks form an SS burst 940, and an SS burst set 950. The SS burst set 950 may have a given periodicity. For example, in a multi-beam operation, a base station 120 may transmit SS blocks in multiple beams, together forming a SS burst 940. One or more SS blocks may be transmitted on one beam. If multiple SS bursts 940 are transmitted with multiple beams, SS bursts together may form SS burst set 950.

A wireless device may further use CSI-RS in the multi-beam operation for estimating a beam quality of a links between a wireless device and a base station. A beam may be associated with a CSI-RS. For example, a wireless device may, based on a RSRP measurement on CSI-RS, report a beam index, as indicated in a CRI for downlink beam selection, and associated with a RSRP value of a beam. A CSI-RS may be transmitted on a CSI-RS resource including at least one of one or more antenna ports, one or more time or frequency radio resources. A CSI-RS resource may be configured in a cell-specific way by common RRC signaling, or in a wireless device-specific way by dedicated RRC signaling, and/or L1/L2 signaling. Multiple wireless devices covered by a cell may measure a cell-specific CSI-RS resource. A dedicated subset of wireless devices covered by a cell may measure a wireless device-specific CSI-RS resource.

A CSI-RS resource may be transmitted periodically, or using aperiodic transmission, or using a multi-shot or semi-persistent transmission. For example, in a periodic transmission in FIG. 9A, a base station 120 may transmit configured CSI-RS resources 940 periodically using a configured periodicity in a time domain. In an aperiodic transmission, a configured CSI-RS resource may be transmitted in a dedicated time slot. In a multi-shot or semi-persistent transmission, a configured CSI-RS resource may be transmitted within a configured period. Beams used for CSI-RS transmission may have different beam width than beams used for SS-blocks transmission.

FIG. 9B is an example of a beam management procedure in an example new radio network. A base station 120 and/or a wireless device 110 may perform a downlink L1/L2 beam management procedure. One or more of the following downlink L1/L2 beam management procedures may be performed within one or more wireless devices 110 and one or more base stations 120. In an example, a P-1 procedure 910 may be used to enable the wireless device 110 to measure one or more Transmission (Tx) beams associated with the base station 120 to support a selection of a first set of Tx beams associated with the base station 120 and a first set of Rx beam(s) associated with a wireless device 110. For beamforming at a base station 120, a base station 120 may sweep a set of different TX beams. For beamforming at a wireless device 110, a wireless device 110 may sweep a set of different Rx beams. In an example, a P-2 procedure 920 may be used to enable a wireless device 110 to measure one or more Tx beams associated with a base station 120 to possibly change a first set of Tx beams associated with a base station 120. A P-2 procedure 920 may be performed on a possibly smaller set of beams for beam refinement than in the P-1 procedure 910. A P-2 procedure 920 may be a special case of a P-1 procedure 910. In an example, a P-3 procedure 930 may be used to enable a wireless device 110 to measure at least one Tx beam associated with a base station 120 to change a first set of Rx beams associated with a wireless device 110.

A wireless device 110 may transmit one or more beam management reports to a base station 120. In one or more beam management reports, a wireless device 110 may indicate some beam pair quality parameters, comprising at least, one or more beam identifications; RSRP; Precoding Matrix Indicator (PMI)/Channel Quality Indicator (CQI)/Rank Indicator (RI) of a subset of configured beams. Based on one or more beam management reports, a base station 120 may transmit to a wireless device 110 a signal indicating that one or more beam pair links are one or more serving beams. A base station 120 may transmit PDCCH and PDSCH for a wireless device 110 using one or more serving beams.

In an example embodiment, new radio network may support a Bandwidth Adaptation (BA). In an example, receive and/or transmit bandwidths configured by a UE employing a BA may not be large. For example, a receive and/or transmit bandwidths may not be as large as a bandwidth of a cell. Receive and/or transmit bandwidths may be adjustable. For example, a UE may change receive and/or transmit bandwidths, e.g., to shrink during period of low activity to save power. For example, a UE may change a location of receive and/or transmit bandwidths in a frequency domain, e.g. to increase scheduling flexibility. For example, a UE may change a subcarrier spacing, e.g. to allow different services.

In an example embodiment, a subset of a total cell bandwidth of a cell may be referred to as a Bandwidth Part (BWP). A base station may configure a UE with one or more BWPs to achieve a BA. For example, a base station may indicate, to a UE, which of the one or more (configured) BWPs is an active BWP.

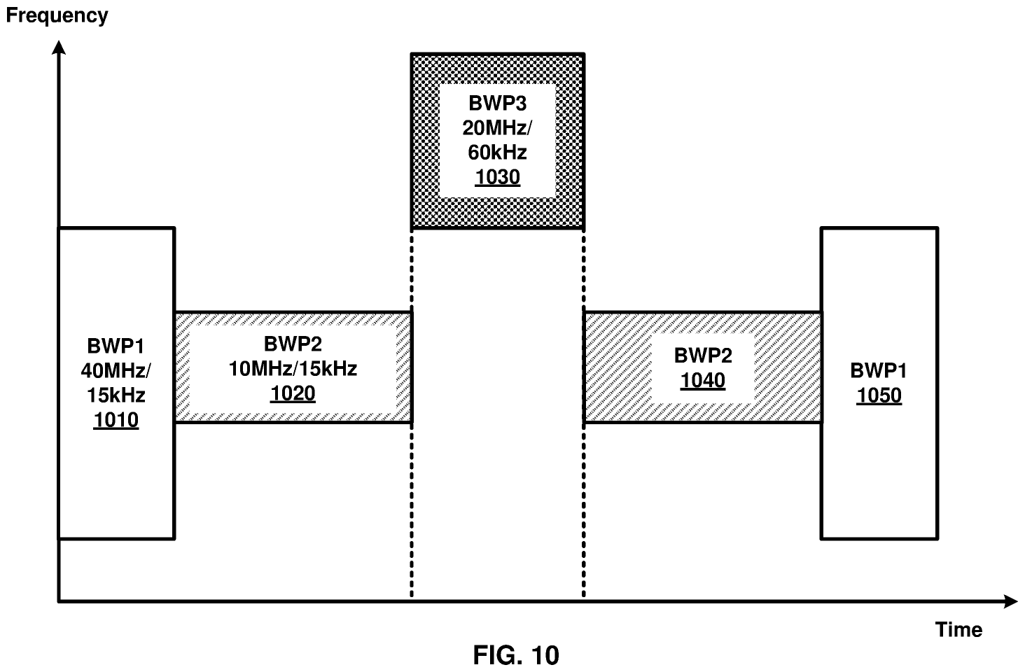

FIG. 10 is an example diagram of 3 BWPs configured: BWP1 (1010 and 1050) with a width of 40 MHz and subcarrier spacing of 15 kHz; BWP2 (1020 and 1040) with a width of 10 MHz and subcarrier spacing of 15 kHz; BWP3 1030 with a width of 20 MHz and subcarrier spacing of 60 kHz.

In an example, a UE, configured for operation in one or more BWPs of a cell, may be configured by one or more higher layers (e.g. RRC layer) for a cell a set of one or more BWPs (e.g., at most four BWPs) for receptions by the UE (DL BWP set) in a DL bandwidth by at least one parameter DL-BWP and a set of one or more BWPs (e.g., at most four BWPs) for transmissions by a UE (UL BWP set) in an UL bandwidth by at least one parameter UL-BWP for a cell.

To enable BA on the PCell, a base station may configure a UE with one or more UL and DL BWP pairs. To enable BA on SCells (e.g., in case of CA), a base station may configure a UE at least with one or more DL BWPs (e.g., there may be none in an UL).

In an example, an initial active DL BWP may be defined by at least one of a location and number of contiguous PRBs, a subcarrier spacing, or a cyclic prefix, for a control resource set for at least one common search space. For operation on the PCell, one or more higher layer parameters may indicate at least one initial UL BWP for a random access procedure. If a UE is configured with a secondary carrier on a primary cell, the UE may be configured with an initial BWP for random access procedure on a secondary carrier.

In an example, for unpaired spectrum operation, a UE may expect that a center frequency for a DL BWP may be same as a center frequency for a UL BWP.

For example, for a DL BWP or an UL BWP in a set of one or more DL BWPs or one or more UL BWPs, respectively, a base statin may semi-statistically configure a UE for a cell with one or more parameters indicating at least one of following: a subcarrier spacing; a cyclic prefix; a number of contiguous PRBs; an index in the set of one or more DL BWPs and/or one or more UL BWPs; a link between a DL BWP and an UL BWP from a set of configured DL BWPs and UL BWPs; a DCI detection to a PDSCH reception timing; a PDSCH reception to a HARQ-ACK transmission timing value; a DCI detection to a PUSCH transmission timing value; an offset of a first PRB of a DL bandwidth or an UL bandwidth, respectively, relative to a first PRB of a bandwidth.

In an example, for a DL BWP in a set of one or more DL BWPs on a PCell, a base station may configure a UE with one or more control resource sets for at least one type of common search space and/or one UE-specific search space. For example, a base station may not configure a UE without a common search space on a PCell, or on a PSCell, in an active DL BWP.

For an UL BWP in a set of one or more UL BWPs, a base station may configure a UE with one or more resource sets for one or more PUCCH transmissions.

In an example, if a DCI comprises a BWP indicator field, a BWP indicator field value may indicate an active DL BWP, from a configured DL BWP set, for one or more DL receptions. If a DCI comprises a BWP indicator field, a BWP indicator field value may indicate an active UL BWP, from a configured UL BWP set, for one or more UL transmissions.

In an example, for a PCell, a base station may semi-statistically configure a UE with a default DL BWP among configured DL BWPs. If a UE is not provided a default DL BWP, a default BWP may be an initial active DL BWP.

In an example, a base station may configure a UE with a timer value for a PCell. For example, a UE may start a timer, referred to as BWP inactivity timer, when a UE detects a DCI indicating an active DL BWP, other than a default DL BWP, for a paired spectrum operation or when a UE detects a DCI indicating an active DL BWP or UL BWP, other than a default DL BWP or UL BWP, for an unpaired spectrum operation. The UE may increment the timer by an interval of a first value (e.g., the first value may be 1 millisecond or 0.5 milliseconds) if the UE does not detect a DCI during the interval for a paired spectrum operation or for an unpaired spectrum operation. In an example, the timer may expire when the timer is equal to the timer value. A UE may switch to the default DL BWP from an active DL BWP when the timer expires.

In an example, a base station may semi-statistically configure a UE with one or more BWPs. A UE may switch an active BWP from a first BWP to a second BWP in response to receiving a DCI indicating the second BWP as an active BWP and/or in response to an expiry of BWP inactivity timer (for example, the second BWP may be a default BWP). For example, FIG. 10 is an example diagram of 3 BWPs configured, BWP1 (1010 and 1050), BWP2 (1020 and 1040), and BWP3 (1030). BWP2 (1020 and 1040) may be a default BWP. BWP1 (1010) may be an initial active BWP. In an example, a UE may switch an active BWP from BWP1 1010 to BWP2 1020 in response to an expiry of BWP inactivity timer. For example, a UE may switch an active BWP from BWP2 1020 to BWP3 1030 in response to receiving a DCI indicating BWP3 1030 as an active BWP. Switching an active BWP from BWP3 1030 to BWP2 1040 and/or from BWP2 1040 to BWP1 1050 may be in response to receiving a DCI indicating an active BWP and/or in response to an expiry of BWP inactivity timer.

In an example, if a UE is configured for a secondary cell with a default DL BWP among configured DL BWPs and a timer value, UE procedures on a secondary cell may be same as on a primary cell using the timer value for the secondary cell and the default DL BWP for the secondary cell.

In an example, if a base station configures a UE with a first active DL BWP and a first active UL BWP on a secondary cell or carrier, a UE may employ an indicated DL BWP and an indicated UL BWP on a secondary cell as a respective first active DL BWP and first active UL BWP on a secondary cell or carrier.

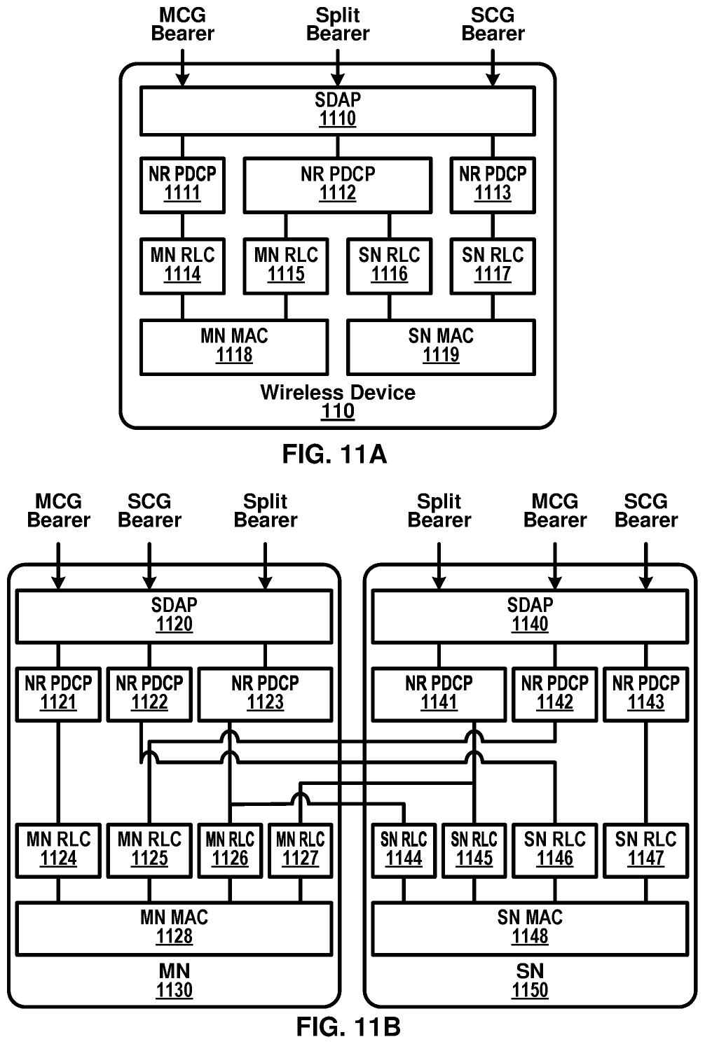

FIG. 11A and FIG. 11B show packet flows employing a multi connectivity (e.g. dual connectivity, multi connectivity, tight interworking, and/or the like). FIG. 11A is an example diagram of a protocol structure of a wireless device 110 (e.g. UE) with CA and/or multi connectivity as per an aspect of an embodiment. FIG. 11B is an example diagram of a protocol structure of multiple base stations with CA and/or multi connectivity as per an aspect of an embodiment. The multiple base stations may comprise a master node, MN 1130 (e.g. a master node, a master base station, a master gNB, a master eNB, and/or the like) and a secondary node, SN 1150 (e.g. a secondary node, a secondary base station, a secondary gNB, a secondary eNB, and/or the like). A master node 1130 and a secondary node 1150 may co-work to communicate with a wireless device 110.

When multi connectivity is configured for a wireless device 110, the wireless device 110, which may support multiple reception/transmission functions in an RRC connected state, may be configured to utilize radio resources provided by multiple schedulers of a multiple base stations. Multiple base stations may be inter-connected via a non-ideal or ideal backhaul (e.g. Xn interface, X2 interface, and/or the like). A base station involved in multi connectivity for a certain wireless device may perform at least one of two different roles: a base station may either act as a master base station or as a secondary base station. In multi connectivity, a wireless device may be connected to one master base station and one or more secondary base stations. In an example, a master base station (e.g. the MN 1130) may provide a master cell group (MCG) comprising a primary cell and/or one or more secondary cells for a wireless device (e.g. the wireless device 110). A secondary base station (e.g. the SN 1150) may provide a secondary cell group (SCG) comprising a primary secondary cell (PSCell) and/or one or more secondary cells for a wireless device (e.g. the wireless device 110).

In multi connectivity, a radio protocol architecture that a bearer employs may depend on how a bearer is setup. In an example, three different type of bearer setup options may be supported: an MCG bearer, an SCG bearer, and/or a split bearer. A wireless device may receive/transmit packets of an MCG bearer via one or more cells of the MCG, and/or may receive/transmits packets of an SCG bearer via one or more cells of an SCG. Multi-connectivity may also be described as having at least one bearer configured to use radio resources provided by the secondary base station. Multi-connectivity may or may not be configured/implemented in some of the example embodiments.

In an example, a wireless device (e.g. Wireless Device 110) may transmit and/or receive: packets of an MCG bearer via an SDAP layer (e.g. SDAP 1110), a PDCP layer (e.g. NR PDCP 1111), an RLC layer (e.g. MN RLC 1114), and a MAC layer (e.g. MN MAC 1118); packets of a split bearer via an SDAP layer (e.g. SDAP 1110), a PDCP layer (e.g. NR PDCP 1112), one of a master or secondary RLC layer (e.g. MN RLC 1115, SN RLC 1116), and one of a master or secondary MAC layer (e.g. MN MAC 1118, SN MAC 1119); and/or packets of an SCG bearer via an SDAP layer (e.g. SDAP 1110), a PDCP layer (e.g. NR PDCP 1113), an RLC layer (e.g. SN RLC 1117), and a MAC layer (e.g. MN MAC 1119).

In an example, a master base station (e.g. MN 1130) and/or a secondary base station (e.g. SN 1150) may transmit/receive: packets of an MCG bearer via a master or secondary node SDAP layer (e.g. SDAP 1120, SDAP 1140), a master or secondary node PDCP layer (e.g. NR PDCP 1121, NR PDCP 1142), a master node RLC layer (e.g. MN RLC 1124, MN RLC 1125), and a master node MAC layer (e.g. MN MAC 1128); packets of an SCG bearer via a master or secondary node SDAP layer (e.g. SDAP 1120, SDAP 1140), a master or secondary node PDCP layer (e.g. NR PDCP 1122, NR PDCP 1143), a secondary node RLC layer (e.g. SN RLC 1146, SN RLC 1147), and a secondary node MAC layer (e.g. SN MAC 1148); packets of a split bearer via a master or secondary node SDAP layer (e.g. SDAP 1120, SDAP 1140), a master or secondary node PDCP layer (e.g. NR PDCP 1123, NR PDCP 1141), a master or secondary node RLC layer (e.g. MN RLC 1126, SN RLC 1144, SN RLC 1145, MN RLC 1127), and a master or secondary node MAC layer (e.g. MN MAC 1128, SN MAC 1148).

In multi connectivity, a wireless device may configure multiple MAC entities: one MAC entity (e.g. MN MAC 1118) for a master base station, and other MAC entities (e.g. SN MAC 1119) for a secondary base station. In multi-connectivity, a configured set of serving cells for a wireless device may comprise two subsets: an MCG comprising serving cells of a master base station, and SCGs comprising serving cells of a secondary base station. For an SCG, one or more of following configurations may be applied: at least one cell of an SCG has a configured UL CC and at least one cell of a SCG, named as primary secondary cell (PSCell, PCell of SCG, or sometimes called PCell), is configured with PUCCH resources; when an SCG is configured, there may be at least one SCG bearer or one Split bearer; upon detection of a physical layer problem or a random access problem on a PSCell, or a number of NR RLC retransmissions has been reached associated with the SCG, or upon detection of an access problem on a PSCell during a SCG addition or a SCG change: an RRC connection re-establishment procedure may not be triggered, UL transmissions towards cells of an SCG may be stopped, a master base station may be informed by a wireless device of a SCG failure type, for split bearer, a DL data transfer over a master base station may be maintained; an NR RLC acknowledged mode (AM) bearer may be configured for a split bearer; PCell and/or PSCell may not be de-activated; PSCell may be changed with a SCG change procedure (e.g. with security key change and a RACH procedure); and/or a bearer type change between a split bearer and a SCG bearer or simultaneous configuration of a SCG and a split bearer may or may not supported.

With respect to interaction between a master base station and a secondary base stations for multi-connectivity, one or more of the following may be applied: a master base station and/or a secondary base station may maintain RRM measurement configurations of a wireless device; a master base station may (e.g. based on received measurement reports, traffic conditions, and/or bearer types) may decide to request a secondary base station to provide additional resources (e.g. serving cells) for a wireless device; upon receiving a request from a master base station, a secondary base station may create/modify a container that may result in configuration of additional serving cells for a wireless device (or decide that the secondary base station has no resource available to do so); for a UE capability coordination, a master base station may provide (a part of) an AS configuration and UE capabilities to a secondary base station; a master base station and a secondary base station may exchange information about a UE configuration by employing of RRC containers (inter-node messages) carried via Xn messages; a secondary base station may initiate a reconfiguration of the secondary base station existing serving cells (e.g. PUCCH towards the secondary base station); a secondary base station may decide which cell is a PSCell within a SCG; a master base station may or may not change content of RRC configurations provided by a secondary base station; in case of a SCG addition and/or a SCG SCell addition, a master base station may provide recent (or the latest) measurement results for SCG cell(s); a master base station and secondary base stations may receive information of SFN and/or subframe offset of each other from OAM and/or via an Xn interface, (e.g. for a purpose of DRX alignment and/or identification of a measurement gap). In an example, when adding a new SCG SCell, dedicated RRC signaling may be used for sending required system information of a cell as for CA, except for an SFN acquired from a MIB of a PSCell of a SCG.

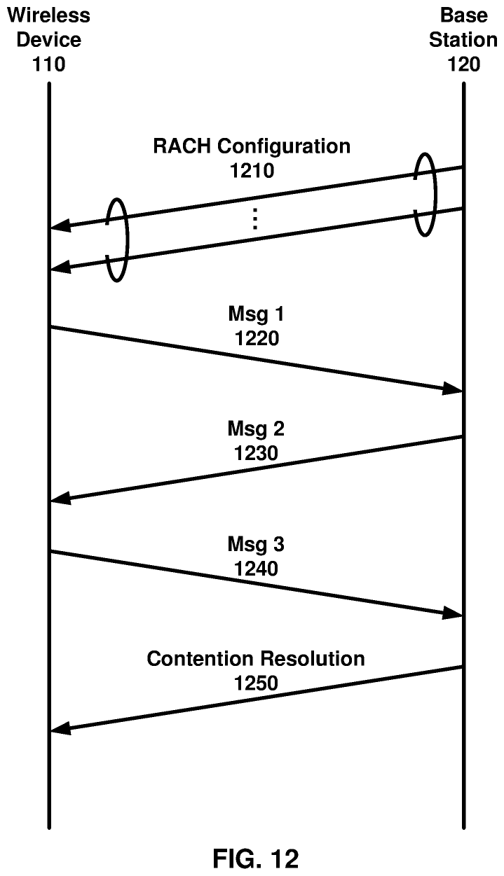

FIG. 12 is an example diagram of a random access procedure. One or more events may trigger a random access procedure. For example, one or more events may be at least one of following: initial access from RRC_IDLE, RRC connection re-establishment procedure, handover, DL or UL data arrival during RRC_CONNECTED when UL synchronization status is non-synchronized, transition from RRC_Inactive, and/or request for other system information. For example, a PDCCH order, a MAC entity, and/or a beam failure indication may initiate a random access procedure.

In an example embodiment, a random access procedure may be at least one of a contention based random access procedure and a contention free random access procedure. For example, a contention based random access procedure may comprise, one or more Msg 1 1220 transmissions, one or more Msg2 1230 transmissions, one or more Msg3 1240 transmissions, and contention resolution 1250. For example, a contention free random access procedure may comprise one or more Msg 1 1220 transmissions and one or more Msg2 1230 transmissions.

In an example, a base station may transmit (e.g., unicast, multicast, or broadcast), to a UE, a RACH configuration 1210 via one or more beams. The RACH configuration 1210 may comprise one or more parameters indicating at least one of following: available set of PRACH resources for a transmission of a random access preamble, initial preamble power (e.g., random access preamble initial received target power), an RSRP threshold for a selection of a SS block and corresponding PRACH resource, a power-ramping factor (e.g., random access preamble power ramping step), random access preamble index, a maximum number of preamble transmission, preamble group A and group B, a threshold (e.g., message size) to determine the groups of random access preambles, a set of one or more random access preambles for system information request and corresponding PRACH resource(s), if any, a set of one or more random access preambles for beam failure recovery request and corresponding PRACH resource(s), if any, a time window to monitor RA response(s), a time window to monitor response(s) on beam failure recovery request, and/or a contention resolution timer.

In an example, the Msg1 1220 may be one or more transmissions of a random access preamble. For a contention based random access procedure, a UE may select a SS block with a RSRP above the RSRP threshold. If random access preambles group B exists, a UE may select one or more random access preambles from a group A or a group B depending on a potential Msg3 1240 size. If a random access preambles group B does not exist, a UE may select the one or more random access preambles from a group A. A UE may select a random access preamble index randomly (e.g. with equal probability or a normal distribution) from one or more random access preambles associated with a selected group. If a base station semi-statistically configures a UE with an association between random access preambles and SS blocks, the UE may select a random access preamble index randomly with equal probability from one or more random access preambles associated with a selected SS block and a selected group.

For example, a UE may initiate a contention free random access procedure based on a beam failure indication from a lower layer. For example, a base station may semi-statistically configure a UE with one or more contention free PRACH resources for beam failure recovery request associated with at least one of SS blocks and/or CSI-RSs. If at least one of SS blocks with a RSRP above a first RSRP threshold amongst associated SS blocks or at least one of CSI-RSs with a RSRP above a second RSRP threshold amongst associated CSI-RSs is available, a UE may select a random access preamble index corresponding to a selected SS block or CSI-RS from a set of one or more random access preambles for beam failure recovery request.

For example, a UE may receive, from a base station, a random access preamble index via PDCCH or RRC for a contention free random access procedure. If a base station does not configure a UE with at least one contention free PRACH resource associated with SS blocks or CSI-RS, the UE may select a random access preamble index. If a base station configures a UE with one or more contention free PRACH resources associated with SS blocks and at least one SS block with a RSRP above a first RSRP threshold amongst associated SS blocks is available, the UE may select the at least one SS block and select a random access preamble corresponding to the at least one SS block. If a base station configures a UE with one or more contention free PRACH resources associated with CSI-RSs and at least one CSI-RS with a RSRP above a second RSPR threshold amongst the associated CSI-RSs is available, the UE may select the at least one CSI-RS and select a random access preamble corresponding to the at least one CSI-RS.

A UE may perform one or more Msgl 1220 transmissions by transmitting the selected random access preamble. For example, if a UE selects an SS block and is configured with an association between one or more PRACH occasions and one or more SS blocks, the UE may determine an PRACH occasion from one or more PRACH occasions corresponding to a selected SS block. For example, if a UE selects a CSI-RS and is configured with an association between one or more PRACH occasions and one or more CSI-RSs, the UE may determine a PRACH occasion from one or more PRACH occasions corresponding to a selected CSI-RS. A UE may transmit, to a base station, a selected random access preamble via a selected PRACH occasions. A UE may determine a transmit power for a transmission of a selected random access preamble at least based on an initial preamble power and a power-ramping factor. A UE may determine a RA-RNTI associated with a selected PRACH occasions in which a selected random access preamble is transmitted. For example, a UE may not determine a RA-RNTI for a beam failure recovery request. A UE may determine an RA-RNTI at least based on an index of a first OFDM symbol and an index of a first slot of a selected PRACH occasions, and/or an uplink carrier index for a transmission of Msg1 1220.

In an example, a UE may receive, from a base station, a random access response, Msg 2 1230. A UE may start a time window (e.g., ra-Response Window) to monitor a random access response. For beam failure recovery request, a base station may configure a UE with a different time window (e.g., bfr-Response Window) to monitor response on beam failure recovery request. For example, a UE may start a time window (e.g., ra-Response Window or bfr-Response Window) at a start of a first PDCCH occasion after a fixed duration of one or more symbols from an end of a preamble transmission. If a UE transmits multiple preambles, the UE may start a time window at a start of a first PDCCH occasion after a fixed duration of one or more symbols from an end of a first preamble transmission. A UE may monitor a PDCCH of a cell for at least one random access response identified by a RA-RNTI or for at least one response to beam failure recovery request identified by a C-RNTI while a timer for a time window is running.

In an example, a UE may consider a reception of random access response successful if at least one random access response comprises a random access preamble identifier corresponding to a random access preamble transmitted by the UE. A UE may consider the contention free random access procedure successfully completed if a reception of random access response is successful. If a contention free random access procedure is triggered for a beam failure recovery request, a UE may consider a contention free random access procedure successfully complete if a PDCCH transmission is addressed to a C-RNTI. In an example, if at least one random access response comprises a random access preamble identifier, a UE may consider the random access procedure successfully completed and may indicate a reception of an acknowledgement for a system information request to upper layers. If a UE has signaled multiple preamble transmissions, the UE may stop transmitting remaining preambles (if any) in response to a successful reception of a corresponding random access response.

In an example, a UE may perform one or more Msg 3 1240 transmissions in response to a successful reception of random access response (e.g., for a contention based random access procedure). A UE may adjust an uplink transmission timing based on a timing advanced command indicated by a random access response and may transmit one or more transport blocks based on an uplink grant indicated by a random access response. Subcarrier spacing for PUSCH transmission for Msg3 1240 may be provided by at least one higher layer (e.g. RRC) parameter. A UE may transmit a random access preamble via PRACH and Msg3 1240 via PUSCH on a same cell. A base station may indicate an UL BWP for a PUSCH transmission of Msg3 1240 via system information block. A UE may employ HARQ for a retransmission of Msg 3 1240.

In an example, multiple UEs may perform Msg 1 1220 by transmitting a same preamble to a base station and receive, from the base station, a same random access response comprising an identity (e.g., TC-RNTI). Contention resolution 1250 may ensure that a UE does not incorrectly use an identity of another UE. For example, contention resolution 1250 may be based on C-RNTI on PDCCH or a UE contention resolution identity on DL-SCH. For example, if a base station assigns a C-RNTI to a UE, the UE may perform contention resolution 1250 based on a reception of a PDCCH transmission that is addressed to the C-RNTI. In response to detection of a C-RNTI on a PDCCH, a UE may consider contention resolution 1250 successful and may consider a random access procedure successfully completed. If a UE has no valid C-RNTI, a contention resolution may be addressed by employing a TC-RNTI. For example, if a MAC PDU is successfully decoded and a MAC PDU comprises a UE contention resolution identity MAC CE that matches the CCCH SDU transmitted in Msg3 1250, a UE may consider the contention resolution 1250 successful and may consider the random access procedure successfully completed.

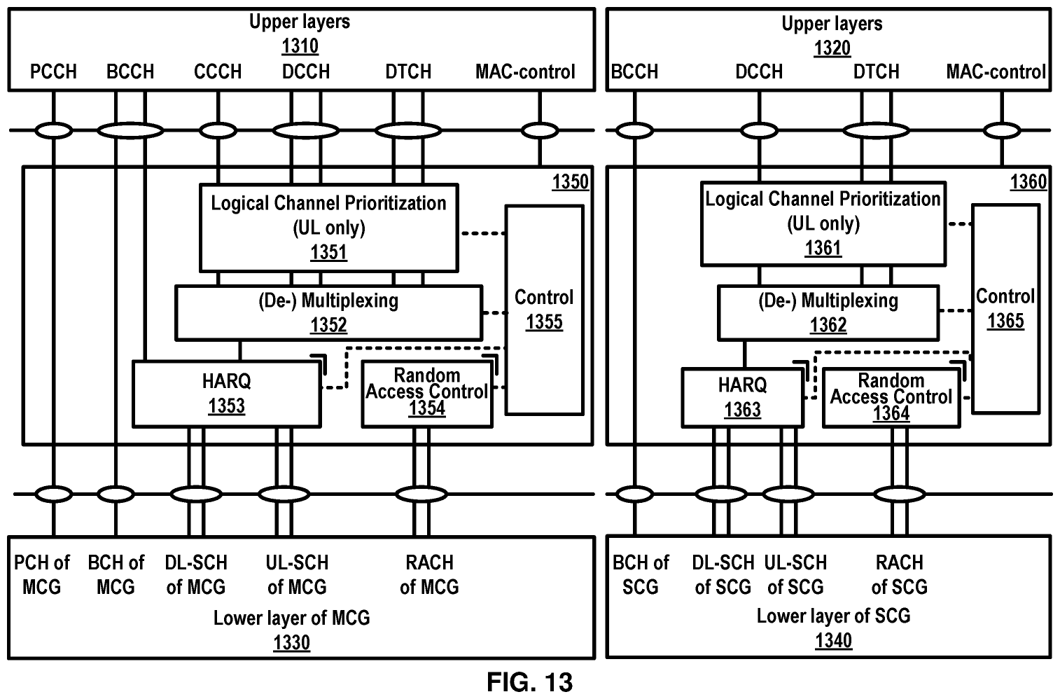

FIG. 13 is an example structure for MAC entities as per an aspect of an embodiment. In an example, a wireless device may be configured to operate in a multi-connectivity mode. A wireless device in RRC_CONNECTED with multiple RX/TX may be configured to utilize radio resources provided by multiple schedulers located in a plurality of base stations. The plurality of base stations may be connected via a non-ideal or ideal backhaul over the Xn interface. In an example, a base station in a plurality of base stations may act as a master base station or as a secondary base station. A wireless device may be connected to one master base station and one or more secondary base stations. A wireless device may be configured with multiple MAC entities, e.g. one MAC entity for master base station, and one or more other MAC entities for secondary base station(s). In an example, a configured set of serving cells for a wireless device may comprise two subsets: an MCG comprising serving cells of a master base station, and one or more SCGs comprising serving cells of a secondary base station(s). FIG. 13 illustrates an example structure for MAC entities when MCG and SCG are configured for a wireless device.

In an example, at least one cell in a SCG may have a configured UL CC, wherein a cell of at least one cell may be called PSCell or PCell of SCG, or sometimes may be simply called PCell. A PSCell may be configured with PUCCH resources. In an example, when a SCG is configured, there may be at least one SCG bearer or one split bearer. In an example, upon detection of a physical layer problem or a random access problem on a PSCell, or upon reaching a number of RLC retransmissions associated with the SCG, or upon detection of an access problem on a PSCell during a SCG addition or a SCG change: an RRC connection re-establishment procedure may not be triggered, UL transmissions towards cells of an SCG may be stopped, a master base station may be informed by a UE of a SCG failure type and DL data transfer over a master base station may be maintained.

In an example, a MAC sublayer may provide services such as data transfer and radio resource allocation to upper layers (e.g. 1310 or 1320). A MAC sublayer may comprise a plurality of MAC entities (e.g. 1350 and 1360). A MAC sublayer may provide data transfer services on logical channels. To accommodate different kinds of data transfer services, multiple types of logical channels may be defined. A logical channel may support transfer of a particular type of information. A logical channel type may be defined by what type of information (e.g., control or data) is transferred. For example, BCCH, PCCH, CCCH and DCCH may be control channels and DTCH may be a traffic channel. In an example, a first MAC entity (e.g. 1310) may provide services on PCCH, BCCH, CCCH, DCCH, DTCH and MAC control elements. In an example, a second MAC entity (e.g. 1320) may provide services on BCCH, DCCH, DTCH and MAC control elements.

A MAC sublayer may expect from a physical layer (e.g. 1330 or 1340) services such as data transfer services, signaling of HARQ feedback, signaling of scheduling request or measurements (e.g. CQI). In an example, in dual connectivity, two MAC entities may be configured for a wireless device: one for MCG and one for SCG. A MAC entity of wireless device may handle a plurality of transport channels. In an example, a first MAC entity may handle first transport channels comprising a PCCH of MCG, a first BCH of MCG, one or more first DL-SCHs of MCG, one or more first UL-SCHs of MCG and one or more first RACHs of MCG. In an example, a second MAC entity may handle second transport channels comprising a second BCH of SCG, one or more second DL-SCHs of SCG, one or more second UL-SCHs of SCG and one or more second RACHs of SCG.

In an example, if a MAC entity is configured with one or more SCells, there may be multiple DL-SCHs and there may be multiple UL-SCHs as well as multiple RACHs per MAC entity. In an example, there may be one DL-SCH and UL-SCH on a SpCell. In an example, there may be one DL-SCH, zero or one UL-SCH and zero or one RACH for an SCell. A DL-SCH may support receptions using different numerologies and/or TTI duration within a MAC entity. A UL-SCH may also support transmissions using different numerologies and/or TTI duration within the MAC entity.

In an example, a MAC sublayer may support different functions and may control these functions with a control (e.g. 1355 or 1365) element. Functions performed by a MAC entity may comprise mapping between logical channels and transport channels (e.g., in uplink or downlink), multiplexing (e.g. 1352 or 1362) of MAC SDUs from one or different logical channels onto transport blocks (TB) to be delivered to the physical layer on transport channels (e.g., in uplink), demultiplexing (e.g. 1352 or 1362) of MAC SDUs to one or different logical channels from transport blocks (TB) delivered from the physical layer on transport channels (e.g., in downlink), scheduling information reporting (e.g., in uplink), error correction through HARQ in uplink or downlink (e.g. 1363), and logical channel prioritization in uplink (e.g. 1351 or 1361). A MAC entity may handle a random access process (e.g. 1354 or 1364).

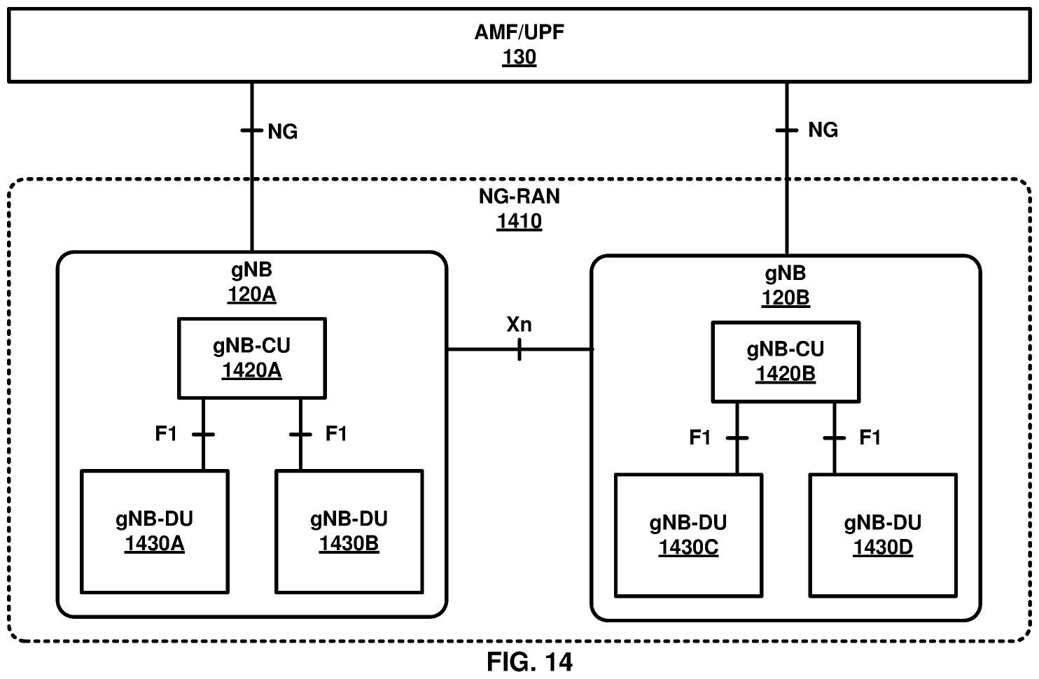

FIG. 14 is an example diagram of a RAN architecture comprising one or more base stations. In an example, a protocol stack (e.g. RRC, SDAP, PDCP, RLC, MAC, and PHY) may be supported at a node. A base station (e.g. 120A or 120B) may comprise a base station central unit (CU) (e.g. gNB-CU 1420A or 1420B) and at least one base station distributed unit (DU) (e.g. gNB-DU 1430A, 1430B, 1430C, or 1430D) if a functional split is configured. Upper protocol layers of a base station may be located in a base station CU, and lower layers of the base station may be located in the base station DUs. An Fl interface (e.g. CU-DU interface) connecting a base station CU and base station DUs may be an ideal or non-ideal backhaul. F1-C may provide a control plane connection over an Fl interface, and F1-U may provide a user plane connection over the Fl interface. In an example, an Xn interface may be configured between base station CUs.

In an example, a base station CU may comprise an RRC function, an SDAP layer, and a PDCP layer, and base station DUs may comprise an RLC layer, a MAC layer, and a PHY layer. In an example, various functional split options between a base station CU and base station DUs may be possible by locating different combinations of upper protocol layers (RAN functions) in a base station CU and different combinations of lower protocol layers (RAN functions) in base station DUs. A functional split may support flexibility to move protocol layers between a base station CU and base station DUs depending on service requirements and/or network environments.

In an example, functional split options may be configured per base station, per base station CU, per base station DU, per UE, per bearer, per slice, or with other granularities. In per base station CU split, a base station CU may have a fixed split option, and base station DUs may be configured to match a split option of a base station CU. In per base station DU split, a base station DU may be configured with a different split option, and a base station CU may provide different split options for different base station DUs. In per UE split, a base station (base station CU and at least one base station DUs) may provide different split options for different wireless devices. In per bearer split, different split options may be utilized for different bearers. In per slice splice, different split options may be applied for different slices.

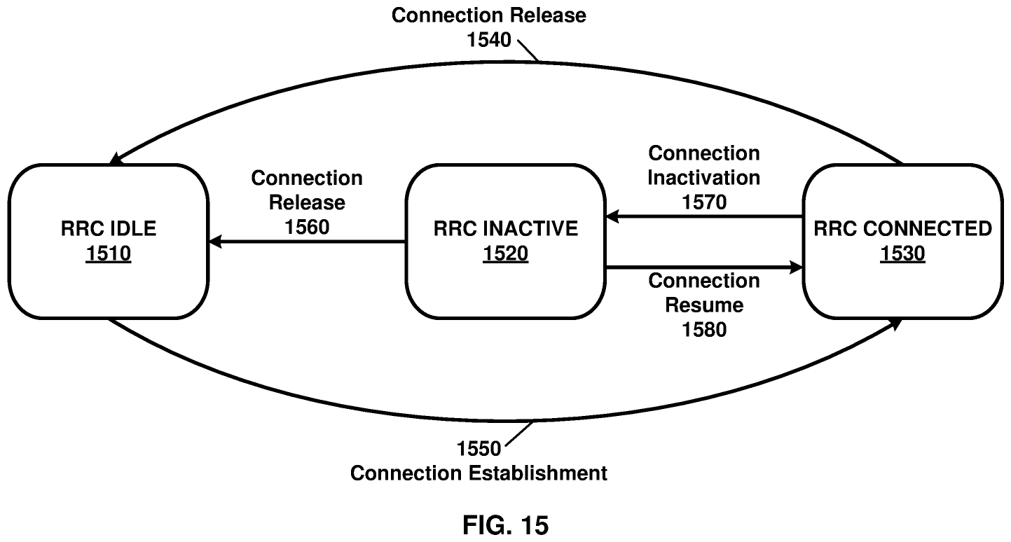

FIG. 15 is an example diagram showing RRC state transitions of a wireless device. In an example, a wireless device may be in at least one RRC state among an RRC connected state (e.g. RRC Connected 1530, RRC_Connected), an RRC idle state (e.g. RRC Idle 1510, RRC_Idle), and/or an RRC inactive state (e.g. RRC Inactive 1520, RRC_Inactive). In an example, in an RRC connected state, a wireless device may have at least one RRC connection with at least one base station (e.g. gNB and/or eNB), which may have a UE context of the wireless device. A UE context (e.g. a wireless device context) may comprise at least one of an access stratum context, one or more radio link configuration parameters, bearer (e.g. data radio bearer (DRB), signaling radio bearer (SRB), logical channel, QoS flow, PDU session, and/or the like) configuration information, security information, PHY/MAC/RLC/PDCP/SDAP layer configuration information, and/or the like configuration information for a wireless device. In an example, in an RRC idle state, a wireless device may not have an RRC connection with a base station, and a UE context of a wireless device may not be stored in a base station. In an example, in an RRC inactive state, a wireless device may not have an RRC connection with a base station. A UE context of a wireless device may be stored in a base station, which may be called as an anchor base station (e.g. last serving base station).

In an example, a wireless device may transition a UE RRC state between an RRC idle state and an RRC connected state in both ways (e.g. connection release 1540 or connection establishment 1550; or connection reestablishment) and/or between an RRC inactive state and an RRC connected state in both ways (e.g. connection inactivation 1570 or connection resume 1580). In an example, a wireless device may transition its RRC state from an RRC inactive state to an RRC idle state (e.g. connection release 1560).

In an example, an anchor base station may be a base station that may keep a UE context (a wireless device context) of a wireless device at least during a time period that a wireless device stays in a RAN notification area (RNA) of an anchor base station, and/or that a wireless device stays in an RRC inactive state. In an example, an anchor base station may be a base station that a wireless device in an RRC inactive state was lastly connected to in a latest RRC connected state or that a wireless device lastly performed an RNA update procedure in. In an example, an RNA may comprise one or more cells operated by one or more base stations. In an example, a base station may belong to one or more RNAs. In an example, a cell may belong to one or more RNAs.

In an example, a wireless device may transition a UE RRC state from an RRC connected state to an RRC inactive state in a base station. A wireless device may receive RNA information from the base station. RNA information may comprise at least one of an RNA identifier, one or more cell identifiers of one or more cells of an RNA, a base station identifier, an IP address of the base station, an AS context identifier of the wireless device, a resume identifier, and/or the like.

In an example, an anchor base station may broadcast a message (e.g. RAN paging message) to base stations of an RNA to reach to a wireless device in an RRC inactive state, and/or the base stations receiving the message from the anchor base station may broadcast and/or multicast another message (e.g. paging message) to wireless devices in their coverage area, cell coverage area, and/or beam coverage area associated with the RNA through an air interface.

In an example, when a wireless device in an RRC inactive state moves into a new RNA, the wireless device may perform an RNA update (RNAU) procedure, which may comprise a random access procedure by the wireless device and/or a UE context retrieve procedure. A UE context retrieve may comprise: receiving, by a base station from a wireless device, a random access preamble; and fetching, by a base station, a UE context of the wireless device from an old anchor base station. Fetching may comprise: sending a retrieve UE context request message comprising a resume identifier to the old anchor base station and receiving a retrieve UE context response message comprising the UE context of the wireless device from the old anchor base station.

In an example embodiment, a wireless device in an RRC inactive state may select a cell to camp on based on at least a on measurement results for one or more cells, a cell where a wireless device may monitor an RNA paging message and/or a core network paging message from a base station. In an example, a wireless device in an RRC inactive state may select a cell to perform a random access procedure to resume an RRC connection and/or to transmit one or more packets to a base station (e.g. to a network). In an example, if a cell selected belongs to a different RNA from an RNA for a wireless device in an RRC inactive state, the wireless device may initiate a random access procedure to perform an RNA update procedure. In an example, if a wireless device in an RRC inactive state has one or more packets, in a buffer, to transmit to a network, the wireless device may initiate a random access procedure to transmit one or more packets to a base station of a cell that the wireless device selects. A random access procedure may be performed with two messages (e.g. 2 stage random access) and/or four messages (e.g. 4 stage random access) between the wireless device and the base station.

In an example embodiment, a base station receiving one or more uplink packets from a wireless device in an RRC inactive state may fetch a UE context of a wireless device by transmitting a retrieve UE context request message for the wireless device to an anchor base station of the wireless device based on at least one of an AS context identifier, an RNA identifier, a base station identifier, a resume identifier, and/or a cell identifier received from the wireless device. In response to fetching a UE context, a base station may transmit a path switch request for a wireless device to a core network entity (e.g. AMF, MME, and/or the like). A core network entity may update a downlink tunnel endpoint identifier for one or more bearers established for the wireless device between a user plane core network entity (e.g. UPF, S-GW, and/or the like) and a RAN node (e.g. the base station), e.g. changing a downlink tunnel endpoint identifier from an address of the anchor base station to an address of the base station.

A gNB may communicate with a wireless device via a wireless network employing one or more new radio technologies. The one or more radio technologies may comprise at least one of: multiple technologies related to physical layer; multiple technologies related to medium access control layer; and/or multiple technologies related to radio resource control layer. Example embodiments of enhancing the one or more radio technologies may improve performance of a wireless network. Example embodiments may increase the system throughput, or data rate of transmission. Example embodiments may reduce battery consumption of a wireless device. Example embodiments may improve latency of data transmission between a gNB and a wireless device. Example embodiments may improve network coverage of a wireless network. Example embodiments may improve transmission efficiency of a wireless network.

In an example, a wireless device may receive configuration parameters of a plurality of configured grant configurations on cell. In an example, the plurality of configured grant configurations may be for a BWP of a cell. The wireless device may receive one or more messages comprising configuration parameters of the plurality of configured grant configurations. In an example, a configured grant configuration in the plurality of configured grant configurations may be configured with a configured grant configuration identifier. In an example, a configured grant configuration in the plurality of configured grant configurations may be a Type 1 configured grant configuration. In an example, a configured grant configuration in the plurality of configured grant configurations maybe a Type 2 configured grant configuration.

In an example, a wireless device may support separate activation of different configured grant Type 2 configurations for a BWP of a serving cell. In an example, for separate activation of the different configured grant Type 2 configurations, the wireless device may receive separate activation DCIs (e.g., one DCI for each configured grant configuration to be activated).

In an example, the wireless device may support joint activation of a plurality of configured grant configurations. With joint activation of multiple configured grant configuration, the wireless device may receive one DCI for activation of two or more configured grant Type 2 configurations.

In an example, a wireless device may support separate release of different configured grant Type 2 configurations for a BWP of a serving cell. In an example, for separate release of the different configured grant Type 2 configurations, the wireless device may receive separate DCIs indicating release (e.g., one DCI for each configured grant configuration to be release).

In an example, the wireless device may support joint release of a plurality of configured grant configurations. With joint release of multiple configured grant configuration, the wireless device may receive one DCI for release of two or more configured grant Type 2 configurations.

In an example, a wireless device may be configured with one or more first configured grant configuration of a first Type and one or more second configured grant configurations of a second type. The first type configured grant configuration may be a Type 1 configured grant configuration. A wireless device may activate a plurality of resources in response to receiving configuration parameters of a Type 1 configured grant. The second type configured grant configuration may be a Type 2 configured grant. A wireless device may activate a plurality of resources in response to receiving configuration parameters of a Type 2 configured grant and receiving an activation DCI indicating activating the Type 2 configured grant.

In an example, a wireless device support multiple active configured grant configurations with different Types for a given BWP of a serving cell. In an example, the wireless device may indicate (e.g., in a capability message), that the wireless device may support multiple active configured grant configurations of different types. The wireless device may receive (e.g., in response to indicating the support of active configured grant configurations with different Types for a given BWP of a serving cell), configuration parameters and/or activation DCIs indicating multiple active configured grant with different Types (e.g., one or more active configured grant Type 1 and one or more active configured grant Type 2) on a BWP of a cell of the wireless device.

In an example, a wireless device may receive configuration parameters of a plurality of downlink SPS configurations. In an example, the plurality of downlink SPS configurations may be for a downlink BWP of a cell. The wireless device may receive one or more messages comprising configuration parameters of the plurality of downlink SPS configurations. In an example, a downlink SPS configuration in the plurality of downlink SPS configurations may be configured with a downlink SPS configuration identifier.

In an example, a downlink SPS configuration identifier may be a downlink SPS configuration index.

In an example, a wireless device may support separate activation for different DL SPS configurations for a given BWP of a serving cell. In an example, for separate activation of different DL SPS configurations for a given BWP of a serving cell, the wireless device may receive separate activation DCIs (e.g., one DCI for each downlink SPS configuration to be activated).

In an example, the wireless device may support joint activation of a plurality of downlink SPS configurations. With joint activation of multiple downlink SPS configuration, the wireless device may receive one DCI for activation of two or more downlink SPS configurations.

In an example, a wireless device may support separate release of different DL SPS configurations for a given BWP of a serving cell. In an example, for separate release of different DL SPS configurations for a given BWP of a serving cell, the wireless device may receive separate release DCIs (e.g., one DCI for each downlink SPS configuration to be released).

In an example, a wireless device may support joint release of a plurality of downlink SPS configurations. With joint release of multiple downlink SPS configurations, the wireless device may receive one DCI for release of two or more downlink SPS configurations.

In an example downlink SPS may be configured for a wireless device to support periodic traffic for various URLLC use cases such as power distribution, factory automation, and transport industry (including remote driving. Support of multiple simultaneous active DL SPS configurations for a given BWP may reduce the latency and provide the possibility to support different service types for a wireless device.

In an example, a downlink SPS configuration may indicate a periodicity of downlink SPS assignments. In an example, a periodicity of shorter than 1 slot may be supported by a wireless device. In an example, support for multiple active downlink SPS configurations on a cell (e.g., a DL BWP of a cell) and/or shorter periodicities of DL SPS may require enhancements to HARQ-ACK codebook determination processes. In an example, a larger PUCCH payload may be needed to carry the HARQ ACK bits corresponding to several SPS PDSCH in a slot. In an example, in case of DL SPS with dynamic scheduling, the size of semi-static HARQ codebook may need to be increased to support DL SPS with smaller periodicities. In an example, a number of HARQ-ACK bits, bit position, and PUCCH resource determination need to be considered. In an example, HARQ-ACK for multiple SPS PDSCHs may need to be aggregated.

In an example, dynamic HARQ codebook may be constructed with one bit corresponding to each semi-persistently scheduled PDSCH. In case multiple DL SPS occur per a cell within a PUCCH slot duration, multiple bits per cell need to be added to the dynamic HARQ codebook. The number of DL SPS PDSCH per PUCCH slot duration per cell may depends on activation and/or configuration status of DL SPS configuration(s).

In an example, the HARQ-ACK for more than one SPS PDSCH receptions/release in a same PUCCH will occur in case of multiple SPS configurations and/or shorter SPS periodicities. For multiple SPS configurations and/or shorter SPS periodicities, HARQ-ACK for more than one SPS PDSCH receptions/release in a same PUCCH may be reported.

In an example, Semi-Persistent Scheduling (SPS) may be configured by RRC per Serving Cell and per BWP. In an example, activation and deactivation of the DL SPS may be independent among the Serving Cells. For the DL SPS, a DL assignment may be provided by PDCCH, and stored or cleared based on L1 signaling indicating SPS activation or deactivation.

In an example, RRC may configure the following parameters when SPS is configured: cs-RNTI: CS-RNTI for activation, deactivation, and retransmission; nrofHARQ-Processes: the number of configured HARQ processes for SPS; periodicity: periodicity of configured downlink assignment for SPS.

In an example, when SPS is released by upper layers, the corresponding configurations may be released.

In an example, in response to a downlink assignment being configured for SPS, the MAC entity may consider sequentially that the Nth downlink assignment occurs in the slot for which:

(numberOfSlotsPerFrame×SFN+slot number in the frame)=[(numberOfSlotsPerFrame×SFNstart time+slotstart time)+N×periodicity×numberOfSlotsPerFrame/10] modulo (1024×numberOfSlotsPerFrame),

where SFNstart time and slotstart time are the SFN and slot, respectively, of the first transmission of PDSCH where the configured downlink assignment was (re-)initialized.

In an example, two types of transmission without dynamic grant may be configured: configured grant Type 1 where an uplink grant is provided by RRC, and stored as configured uplink grant; and configured grant Type 2 where an uplink grant is provided by PDCCH, and stored or cleared as configured uplink grant based on L1 signaling indicating configured uplink grant activation or deactivation.

In an example, Type 1 and Type 2 configured grants may be configured by RRC per Serving Cell and per BWP. In an example, multiple configurations may be active simultaneously on different Serving Cells. For Type 2 configured grant, activation and deactivation may be independent among the Serving Cells.

In an example, RRC may configure the following parameters when the configured grant Type 1 is configured: cs-RNTI: CS-RNTI for retransmission; periodicity: periodicity of the configured grant Type 1; timeDomainOffset: Offset of a resource with respect to SFN=0 in time domain; timeDomainAllocation: Allocation of configured uplink grant in time domain which contains startSymbolAndLength; nrofHARQ-Processes: the number of HARQ processes for configured grant.

In an example, RRC may configure the following parameters when the configured grant Type 2 is configured: cs-RNTI: CS-RNTI for activation, deactivation, and retransmission; periodicity: periodicity of the configured grant Type 2; nrofHARQ-Processes: the number of HARQ processes for configured grant.

In an example, upon configuration of a configured grant Type 1 for a Serving Cell by upper layers, the MAC entity may: store the uplink grant provided by upper layers as a configured uplink grant for the indicated Serving Cell; and initialize or re-initialize the configured uplink grant to start in the symbol according to timeDomainOffset and S (derived from SLIV), and to reoccur with periodicity.

In an example, after an uplink grant is configured for a configured grant Type 1, the MAC entity may consider that the uplink grant recurs associated with each symbol for which: [(SFN×numberOfSlotsPerFrame x numberOfSymbolsPerSlot)+(slot number in the frame×numberOfSymbolsPerSlot)+symbol number in the slot]=(timeDomainOffset×numberOfSymbolsPerSlot+S+N×periodicity) modulo (1024×numberOfSlotsPerFrame×numberOfSymbolsPerSlot), for all N>=0.

In an example, after an uplink grant is configured for a configured grant Type 2, the MAC entity may consider that the uplink grant recurs associated with each symbol for which:

[(SFN×numberOfSlotsPerFrame×numberOfSymbolsPerSlot)+(slot number in the frame×numberOfSymbolsPerSlot)+symbol number in the slot]=[(SFNstart time×numberOfSlotsPerFrame×numberOfSymbolsPerSlot+slotstart time×numberOfSymbolsPerSlot+symbolstart time)+N×periodicity] modulo (1024×numberOfSlotsPerFrame×numberOfSymbolsPerSlot), for all N>=0,
where SFNstart time, slotstart time, and symbolstart time are the SFN, slot, and symbol, respectively, of the first transmission opportunity of PUSCH where the configured uplink grant was (re-)initialized.

In an example, when a configured uplink grant is released by upper layers, all the corresponding configurations may be released and all corresponding uplink grants shall be cleared.

In an example, if the configured uplink grant confirmation has been triggered and not cancelled; and if the MAC entity has UL resources allocated for new transmission, a MAC entity may instruct the Multiplexing and Assembly procedure to generate an Configured Grant Confirmation MAC CE and cancel the triggered configured uplink grant confirmation.

In an example, for a configured grant Type 2, the MAC entity may clear the configured uplink grant in response to a first transmission of Configured Grant Confirmation MAC CE triggered by the configured uplink grant deactivation. In an example, retransmissions except for repetition of configured uplink grants may use uplink grants addressed to CS-RNTI.

In an example, an uplink grant for a PDCCH occasion may be received for a Serving Cell on the PDCCH for the MAC entity's CS-RNTI and the NDI in the received HARQ information may be 1. The MAC entity may consider the NDI for the corresponding HARQ process not to have been toggled. The MAC entity may start or restart the configuredGrantTimer for the corresponding HARQ process, if configured. The MAC entity may deliver the uplink grant and the associated HARQ information to the HARQ entity.

In an example, an uplink grant for a PDCCH occasion may be received for a Serving Cell on the PDCCH for the MAC entity's CS-RNTI and the NDI in the received HARQ information may be 0. If PDCCH contents indicate configured grant Type 2 deactivation, the MAC entity may trigger configured uplink grant confirmation. If PDCCH contents indicate configured grant Type 2 activation, the MAC entity may trigger configured uplink grant confirmation; the MAC entity may store the uplink grant for this Serving Cell and the associated HARQ information as configured uplink grant; the MAC entity may initialize or re-initialize the configured uplink grant for this Serving Cell to start in the associated PUSCH duration and to recur according to rules; and the MAC entity may stop the configuredGrantTimer for the corresponding HARQ process, if running.

In an example, a Configured Grant Confirmation MAC CE may be identified by a MAC subheader with a corresponding LCID. The LCID for a Configured Grant Conformation MAC CE may be pre-configured.

In an example, a PDCCH for configured UL grant Type 2 activation, configured UL grant Type 2 release, DL SPS activation and DL SPS release may be validated before activation/release of resources. In an example, in response to a CRC of a corresponding DCI format is scrambled with a CS-RNTI provided by the RRC parameter cs-RNTI, and a new data indicator field for the enabled transport block is set to ‘0’, a wireless device may validate the PDCCH for scheduling activation or scheduling release of a DL SPS assignment or configured UL grant Type 2.

In an example, validation of a DCI format may be achieved if fields of a DCI format are set according to pre-defined values. In an example, if validation is achieved, a UE may consider information in the DCI format as a valid activation or valid release of DL SPS or configured UL grant Type 2. If validation is not achieved, the UE may discard the information in the DCI format.

In an example, a wireless device may provide HARQ-ACK information in response to a SPS PDSCH release after N symbols from the last symbol of a PDCCH providing the SPS PDSCH release. In an example, N may be based on wireless device capability. For a first wireless device processing capability and for the SCS of the PDCCH reception, N=10 for 15 kHz, N=12 for 30 kHz, N=22 for 60 kHz, and N=25 for 120 kHz. For a wireless device with capability 2 in FR1 and for the SCS of the PDCCH reception, N=5 for 15 kHz, N=5.5 for 30 kHz, and N=11 for 60 kHz.

In an example, a wireless device may receive a PDSCH without receiving a corresponding PDCCH, or the wireless device may receive a PDCCH indicating a SPS PDSCH release. The wireless device may generate one corresponding HARQ-ACK information bit.

In an example, a wireless device may not be provided with an RRC parameter PDSCH-CodeBlockGroupTransmission. The wireless device may generate one HARQ-ACK information bit per transport block.

In an example, a wireless device may determine monitoring occasions for PDCCH with DCI format 1_0 or DCI format 1_1 for scheduling PDSCH receptions or SPS PDSCH release on an active DL BWP of a serving cell c and for which the UE transmits HARQ-ACK information in a same PUCCH in slot n based on: PDSCH-to-HARQ_feedback timing values for PUCCH transmission with HARQ-ACK information in slot n in response to PDSCH receptions or SPS PDSCH release slot offsets K₀ provided by time domain resource assignment field in DCI format 1_0 or DCI format 1_1 for scheduling PDSCH receptions or SPS PDSCH release and by pdsch-AggregationFactor, when provided.

In an example, a set of PDCCH monitoring occasions for DCI format 1_0 or DCI format 1_1 for scheduling PDSCH receptions or SPS PDSCH release is defined as a union of PDCCH monitoring occasions across active DL BWPs of configured serving cells, ordered in ascending order of start time of the search space set associated with a PDCCH monitoring occasion. The cardinality of the set of PDCCH monitoring occasions defines a total number M of PDCCH monitoring occasions.

In an example, a value of a counter downlink assignment indicator (DAI) field in DCI format 1_0 or DCI format 1_1 may denote the accumulative number of {serving cell, PDCCH monitoring occasion}-pair(s) in which PDSCH reception(s) or SPS PDSCH release associated with DCI format 1_0 or DCI format 1_1 is present, up to the current serving cell and current PDCCH monitoring occasion, first in ascending order of serving cell index and then in ascending order of PDCCH monitoring occasion index m, where 0≤m<M.

In an example, ae value of the total DAI, when present, in DCI format 1_1 may denote the total number of {serving cell, PDCCH monitoring occasion}-pair(s) in which PDSCH reception(s) or SPS PDSCH release associated with DCI format 1_0 or DCI format 1_1 is present, up to the current PDCCH monitoring occasion m and is updated from PDCCH monitoring occasion to PDCCH monitoring occasion.

In an example, a wireless device may first determine HARQ-ACK feedback corresponding to PDSCH receptions and SPS PDSCH release DCIs. In an example, a wireless device may transmit HARQ-ACK information in a PUCCH in slot n and for any PUCCH format, the wireless device may determine the õ₀^{ACK}, õ₁^{ACK}, . . . , õₒ_{^{ACK}}₋₁^{ACK}, for a total number of o_{ACK} HARQ-ACK information bits.

In an example, if SPS PDSCH reception is activated for the wireless device and the wireless device is configured to receive SPS PDSCH in a slot n−K_{1,c} for serving cell c, where K_{1,c} is the PDSCH-to-HARQ-feedback timing value for SPS PDSCH on serving cell c, O^{ACK}=O^{ACK}+1, and oₒ_{^{ACK}}₋₁^{ACK}=HARQ-ACK information bit associated with the SPS PDSCH reception.

In an example, a wireless device may transmit one or more PUCCH with HARQ-ACK information in a slot. For DCI format 1_0, the PDSCH-to-HARQ-timing-indicator field values may map to {1, 2, 3, 4, 5, 6, 7, 8}. For DCI format 1_1, if present, the PDSCH-to-HARQ-timing-indicator field values may map to values for a set of number of slots provided by RRC parameter dl-DataToUL-ACK.

In an example, for a SPS PDSCH reception ending in slot n, a wireless device may transmit the PUCCH in slot n+kwhere k is provided by the PDSCH-to-HARQ-timing-indicator field in DCI format 1_0 or, if present, in DCI format 1_1 activating the SPS PDSCH reception.

In an example, if a wireless device detects a DCI format 1_1 that does not include a PDSCH-to-HARQ-timing-indicator field and schedules a PDSCH reception or activates a SPS PDSCH reception ending in slot n, the wireless device may provide corresponding HARQ-ACK information in a PUCCH transmission within slot n+k where k is provided by dl-DataToUL-ACK.

In an example, if a wireless device detects a DCI format 1_0 or a DCI format 1_1 scheduling a PDSCH reception ending in slot n or if the wireless device detects a DCI format 1_0 indicating a SPS PDSCH release through a PDCCH reception ending in slot n, the wireless device may provide corresponding HARQ-ACK information in a PUCCH transmission within slot n+k, where k is a number of slots and is indicated by the PDSCH-to-HARQ-timing-indicator field in the DCI format, if present, or provided by dl-DataToUL-ACK. In an example, k=0 may correspond to a last slot of the PUCCH transmission that overlaps with the PDSCH reception or with the PDCCH reception in case of SPS PDSCH release.

In an example, for a PUCCH transmission with HARQ-ACK information, a UE determines a PUCCH resource after determining a set of PUCCH resources for O_{UCI} HARQ-ACK information bits. The PUCCH resource determination may be based on a PUCCH resource indicator field in a last DCI format 1_0 or DCI format 1_1, among the DCI formats 1_0 or DCI formats 1_1 that have a value of a PDSCH-to-HARQ_feedback timing indicator field indicating a same slot for the PUCCH transmission, that the UE detects and for which the UE transmits corresponding HARQ-ACK information in the PUCCH where, for PUCCH resource determination, detected DCI formats may be first indexed in an ascending order across serving cells indexes for a same PDCCH monitoring occasion and may then be indexed in an ascending order across PDCCH monitoring occasion indexes.

In an example, PUCCH resource indicator field values map to values of a set of PUCCH resource indexes provided by RRC parameter ResourceList for PUCCH resources from a set of PUCCH resources provided by PUCCH-ResourceSet with a maximum of eight PUCCH resources.

In an example, if a UE detects a first DCI format 1_0 or DCI format 1_1 indicating a first resource for a PUCCH transmission with corresponding HARQ-ACK information in a slot and also detects at a later time a second DCI format 1_0 or DCI format 1_1 indicating a second resource for a PUCCH transmission with corresponding HARQ-ACK information in the slot, the UE may not expect to multiplex HARQ-ACK information corresponding to the second DCI format in a PUCCH resource in the slot if the PDCCH reception that includes the second DCI format is not earlier than N₃ symbols from a first symbol of the first resource for PUCCH transmission in the slot where, for wireless device processing capability 1 and SCS configuration μ, N₃=8 for μ=0, N₃=10 for μ=1, N₃=17 for μ=2, N₃=20 for μ=3, and for UE processing capability 2 and SCS configuration μ, N₃=3 for μ=0, N₃=4.5 for μ=1, N₃=9 for μ=2.

In an example, if a wireless device transmits HARQ-ACK information corresponding only to a PDSCH reception without a corresponding PDCCH, a PUCCH resource for corresponding PUCCH transmission with HARQ-ACK information is provided by RRC parameter n1PUCCH-AN.

In an example, an IE ConfiguredGrantConfig may be used to configure uplink transmission without dynamic grant according to two possible schemes. The actual uplink grant may either be configured via RRC (type1) or provided via the PDCCH (addressed to CS-RNTI) (type2).

In an example, a parameter antennaPort may Indicates the antenna port(s) to be used for this configuration. In an example, a parameter cg-DMRS-Configuration may indicate DMRS configuration. In an example, a parameter configuredGrantTimer may indicate the initial value of a configured grant timer in multiples of periodicity. In an example, a parameter frequencyDomainAllocation may indicate the frequency domain resource allocation. In an example, a parameter dmrs-SeqInitialization may be configured field if transformPrecoder is disabled. Otherwise the field may be absent. In an example, an intraSlot value of a parameter frequencyHopping may indicate enabling of ‘Intra-slot frequency hopping’ and a value interSlot may indicate enabling ‘Inter-slot frequency hopping’. If the field is absent, frequency hopping may not be configured. In an example, a parameter frequencyHoppingOffset may indicate enabling intra-slot frequency hopping with the given frequency hopping offset. Frequency hopping offset may be used when frequency hopping is enabled. In an example, a parameter mcs-Table may indicate the MCS table the UE may use for PUSCH without transform precoding. If the field is absent the UE may apply the value qam64. In an example, a parameter mcs-TableTransformPrecoder may indicate the MCS table the UE may use for PUSCH with transform precoding. If the field is absent the UE may apply the value qam64. In an example, a parameter mcsAndTBS may indicate a modulation order, target code rate and TB size. In an example, a parameter nrofHARQ-Processes may indicate the number of HARQ processes configured. It may apply for both Type 1 and Type 2. In an example, a parameter p0-PUSCH-Alpha may indicate an index of the P0-PUSCH-AlphaSet to be used for this configuration. In an example, a parameter periodicity may indicate a Periodicity for UL transmission without UL grant for type 1 and type 2. In an example, powerControlLoopToUse may indicate closed control loop to apply. In an example, a parameter repK-RV may indicate the redundancy version (RV) sequence to use. The network may configure this field if repetitions are used, e.g., if repK is set to n2, n4 or n8. Otherwise, the field may be absent. In an example, a parameter repK may indicate a number of repetitions of K. In an example, a parameter resourceAllocationmay indicaye Configuration of resource allocation type 0 and resource allocation type 1. For Type 1 UL data transmission without grant, “resourceAllocation” may be resourceAllocationType0 or resourceAllocationTypel. In an example, a parameter rrc-ConfiguredUplinkGrant may indicate configuration for “configured grant” transmission with fully RRC-configured UL grant (Type1). If this field is absent the UE uses UL grant configured by DCI addressed to CS-RNTI (Type2). In an example, Type 1 configured grant may be configured for UL or SUL, but not for both simultaneously. In an example, a parameter timeDomainAllocation may indicate a combination of start symbol and length and PUSCH mapping type. In an example, a parameter transformPrecoder may enable or disable transform precoding for type1 and type2. If the field is absent, the UE may enable or disable transform precoding in accordance with the field msg3-transformPrecoder in RACH-ConfigCommon.

In an example, an IE SPS-Config may be used to configure downlink semi-persistent transmission. Downlink SPS may be configured on the SpCell and/or on SCells. In an example, a parameter mcs-Table may indicate the MCS table the wireless device may use for DL SPS. If present, the wireless device may use the MCS table of low-SE 64 QAM. In an example, if this field is absent and field mcs-table in PDSCH-Config is set to ‘qam256’ and the activating DCI is of format 1_1, the UE may apply the 256 QAM table. Otherwise, the UE may apply a non-low-SE 64 QAM table. In an example, a parameter n1PUCCH-AN may indicate HARQ resource for PUCCH for DL SPS. The network may configure the resource either as format0 or format1. The actual PUCCH-Resource may be configured in PUCCH-Config and referred to by its ID.

In an example, a parameter nrofHARQ-Processes may indicate number of configured HARQ processes for SPS DL. In an example, a parameter periodicity may indicate Periodicity for DL SPS.

In an example, an IE PUCCH-Config may be used to configure UE specific PUCCH parameters (per BWP). In an example, a parameter dl-DataToUL-ACK may indicate a list of timing for given PDSCH to the DL ACK.

In an example, an IE PDCCH-Config may be used to configure UE specific PDCCH parameters such as control resource sets (CORESET), search spaces and additional parameters for acquiring the PDCCH. If this IE is used for the scheduled cell in case of cross carrier scheduling, the fields other than searchSpacesToAddModList and searchSpaceToReleaseList may be absent. In an example, a parameter tpc-PUCCH may indicate enabling and configuring reception of group TPC commands for PUCCH. In an example, a parameter tpc-PUSCH may indicate enabling and configuring reception of group TPC commands for PUSCH.

In an example, an IE PUCCH-TPC-CommandConfig may be used to configure the UE for extracting TPC commands for PUCCH from a group-TPC messages on DCI. In an example, a parameter tpc-IndexPCellmay indicate an index determining the position of the first bit of TPC command (applicable to the SpCell) inside the DCI format 2-2 payload. In an example, a parameter tpc-IndexPUCCH-SCell may indicate an index determining the position of the first bit of TPC command (applicable to the PUCCH SCell) inside the DCI format 2-2 payload.

In an example, an IE PUSCH-TPC-CommandConfig may be used to configure the UE for extracting TPC commands for PUSCH from a group-TPC messages on DCI. In an example, a parameter targetCell may indicate the serving cell to which the acquired power control commands are applicable. If the value is absent, the UE may apply the TPC commands to the serving cell on which the command has been received. In an example, a parameter tpc-Index may indicate an index determining the position of the first bit of TPC command inside the DCI format 2-2 payload. In an example, a parameter tpc-IndexSUL may indicate an index determining the position of the first bit of TPC command inside the DCI format 2-2 payload.

In an example, DCI format 1_0 may be used for the scheduling of PDSCH in a DL cell. In an example, the DCI format 1_0 may comprise a PDSCH-to-HARQ_feedback timing indicator indicating a timing between a PDSCH and its corresponding HARQ feedback.

In an example, a DCI format 1_1 may be used for the scheduling of PDSCH in a cell. In an example, the DCI format 1_1 may comprise a PDSCH-to-HARQ_feedback timing indicator indicating a timing between a PDSCH and its corresponding HARQ feedback.

In an example, a DCI format 2_2 may be used for the transmission of TPC commands for PUCCH and PUSCH. The following information may be transmitted by means of the DCI format 2_2 with CRC scrambled by TPC-PUSCH-RNTI or TPC-PUCCH-RNTI: block number 1, block number 2, . . . , block number N.

In an example, the parameter tpc-PUSCH or tpc-PUCCH provided by higher layers may determine the index to the block number for an UL of a cell, with the following fields defined for each block: (1) Closed loop indicator—0 or 1 bit. For DCI format 2_2 with TPC-PUSCH-RNTI, 0 bit if the UE is not configured with high layer parameter twoPUSCH-PC-AdjustmentStates, in which case UE may assume a block in the DCI format 2_2 is of 2 bits; 1 bit otherwise, in which case UE may assume a block in the DCI format 2_2 is of 3 bits; For DCI format 2_2 with TPC-PUCCH-RNTI, 0 bit if the UE is not configured with high layer parameter twoPUCCH-PC-AdjustmentStates, in which case UE may assume a block in the DCI format 2_2 is of 2 bits; 1 bit otherwise, in which case UE may assume a block in the DCI format 2_2 is of 3 bits; (2) TPC command—2 bits.

In an example, the number of information bits in format 2_2 may be equal to or less than the payload size of format 1_0 monitored in common search space in the same serving cell. If the number of information bits in format 2_2 is less than the payload size of format 1_0 monitored in common search space in the same serving cell, zeros may be appended to format 2_2 until the payload size equals that of format 1_0 monitored in common search space in the same serving cell.

A wireless device indicates HARQ feedback (e.g., a positive or negative acknowledgement (ACK or NACK respectively)) for a downlink reception (e.g., dynamically scheduled PDSCH or semi-persistently scheduled PDSCH or a DCI indicating release of downlink SPS). The wireless device creates a HARQ-ACK codebook comprising a plurality of acknowledgements corresponding to the plurality of downlink receptions. In legacy processes, a wireless device includes at most one acknowledgement corresponding to a SPS PDSCH reception of a cell in the HARQ-ACK codebook. With multiple downlink SPS configurations simultaneously being active or with short SPS periodicities, a wireless device may include a plurality of acknowledgement bits corresponding to a plurality of downlink SPS receptions of a cell in the HARQ-ACK codebook. The legacy processes lead to inaccurate determination of location of HARQ feedback corresponding to different SPS PDSCHs in the HARQ-ACK codebook. There is a need to enhance the legacy processes for HARQ-ACK codebook creation. Example embodiments enhance the legacy HARQ-ACK codebook creation.

In an example, a wireless device may receive, e.g., from a base station, configuration parameters indicating a plurality of semi-persistent scheduling (SPS) configurations.

In an example, the wireless device may receive a downlink control information (DCI) activating a SPS configuration among the plurality of SPS configurations. The wireless device may receive a transport block (e.g., PDSCH) for the SPS configuration. The wireless device may receive the transport block for the SPS configuration after (or based on) the receiving the DCI activating the SPS configuration. The wireless device may receive one or more dynamic grants (e.g. a first dynamic grant and a second dynamic grant) indicating downlink transmissions (e.g., PDSCH) to the wireless device. In an example, the wireless device may transmit, e.g., to the base station, an HARQ-ACK codebook comprising an HARQ-ACK feedback (e.g., ACK or NACK) of the transport block to indicate a successful or an unsuccessful reception of the transport block. The HARQ-ACK codebook may comprise HARQ-ACK feedback of the downlink transmissions indicated by the one or more dynamic grants. In existing technologies, the wireless device may include/add the HARQ-ACK feedback of the transport block in a last location/position in the HARQ-ACK codebook. For example, when HARQ-ACK codebook comprises HARQ-ACK for two dynamic grants (e.g. a first dynamic grant and a second dynamic grant) and the SPS configuration, the wireless device transmits the HARQ-ACK codebook=[ACK (first dynamic grant), NACK (second dynamic grant), ACK (SPS configuration)].

In an example, the wireless device may receive one or more DCIs activating multiple SPS configurations. The multiple SPS configurations may comprise a first SPS configuration and a second SPS configuration. The plurality of SPS configurations may comprise the multiple SPS configurations. The wireless device may receive multiple transport blocks for the multiple SPS configurations. The multiple transport blocks may comprise a first transport block (e.g., PDSCH) for the first SPS configuration and a second transport block (e.g., PDSCH) for the second SPS configuration. In an implementation of the existing technologies, the wireless device may transmit multiple HARQ-ACK codebooks when the wireless device receives the multiple transport blocks corresponding to the multiple SPS configurations. For example, a first HARQ-ACK codebook comprises a first HARQ-ACK feedback for the first SPS configuration, and the second HARQ-ACK codebook comprises a second HARQ-ACK feedback for the second SPS configuration. Implementation of existing technologies increases HARQ-ACK feedback signaling overhead, when the multiple SPS configurations are activated. Example embodiments implements a HARQ-ACK codebook comprising multiple HARQ-ACK feedback of the multiple SPS configurations. In an example embodiment, the wireless device may transmit, e.g., to the base station, a HARQ-ACK codebook comprising the multiple HARQ-ACK feedback. The multiple HARQ-ACK feedback may comprise a first HARQ-ACK feedback (e.g., ACK or NACK) of the first transport block and a second HARQ-ACK feedback (e.g., ACK or NACK) of the second transport block.

Existing technologies include/add a HARQ-ACK feedback of a transport block for one SPS configuration in a last location/position in a HARQ-ACK codebook. Implementation of the multiple HARQ-ACK feedback for the multiple SPS configurations may result in a HARQ-ACK misalignment between the base station and the wireless device when the wireless device transmits, in a HARQ-ACK codebook, the multiple HARQ-ACK feedbacks of the multiple transport blocks for the multiple SPS configurations. Example embodiments implements mechanisms for a HARQ-ACK codebook design to reduce uplink signaling overhead and resolve HARQ-ACK misalignment between the base station and the wireless device.

The wireless device may receive one or more dynamic grants (e.g. a first dynamic grant and a second dynamic grant) indicating downlink transmissions to the wireless device. For example, when HARQ-ACK codebook comprises HARQ-ACK for two dynamic grants (e.g. a first dynamic grant and a second dynamic grant) and the multiple SPS configurations, the wireless device transmits the HARQ-ACK codebook=[NACK (first dynamic grant), NACK (second dynamic grant), ACK, NACK]. When the wireless device transmits the HARQ-ACK codebook, the base station may not have information about whether the “ACK” is the first HARQ-ACK feedback of the first transport block or the second HARQ-ACK feedback of the second transport block. The base station may not have information about whether the “NACK” is the first HARQ-ACK feedback of the first transport block or the second HARQ-ACK feedback of the second transport block. The base station may not have information about whether the first transport block or the second block has been successfully received indicated by “ACK” in the HARQ-ACK codebook. The base station may not have information about whether the first transport block or the second block has been unsuccessfully received indicated by “NACK” in the HARQ-ACK codebook. The base station may not reschedule a transport block, among the first transport block and the second transport block, that is unsuccessfully received based on not having information. The base station may reschedule a transport block, among the first transport block and the second transport block, that is (already) successfully received based on not having information. This may result in reduced data rates, increased latency/delay of a communication, and increased signaling (due to wrong rescheduling decisions), etc.

Example embodiments enhance/improve HARQ-ACK codebook design when the wireless device transmits, in a HARQ-ACK codebook, multiple HARQ-ACK feedbacks of multiple transport blocks for multiple SPS configurations. In an example embodiment, the wireless device may order the multiple HARQ-ACK feedbacks of the multiple transport blocks for the multiple SPS configurations in an order (e.g., ascending/descending order) of multiple SPS configuration indexes of the multiple SPS configurations. In an example embodiment, the wireless device may order the multiple HARQ-ACK feedbacks of the multiple transport blocks for the multiple SPS configurations in an order (e.g., ascending/descending order) of time slots that the wireless device receives the multiple transport blocks. In an example embodiment, the wireless device may order the multiple HARQ-ACK feedbacks of the multiple transport blocks for the multiple SPS configurations in an order (e.g., ascending/descending order) of time slots that the wireless device receives a plurality of DCIs activating the multiple SPS configurations. The example embodiments may reduce uplink signaling overhead, may increase data rates, reduce latency/delay of a communication, and reducing downlink signaling overhead (due to wrong rescheduling decisions).

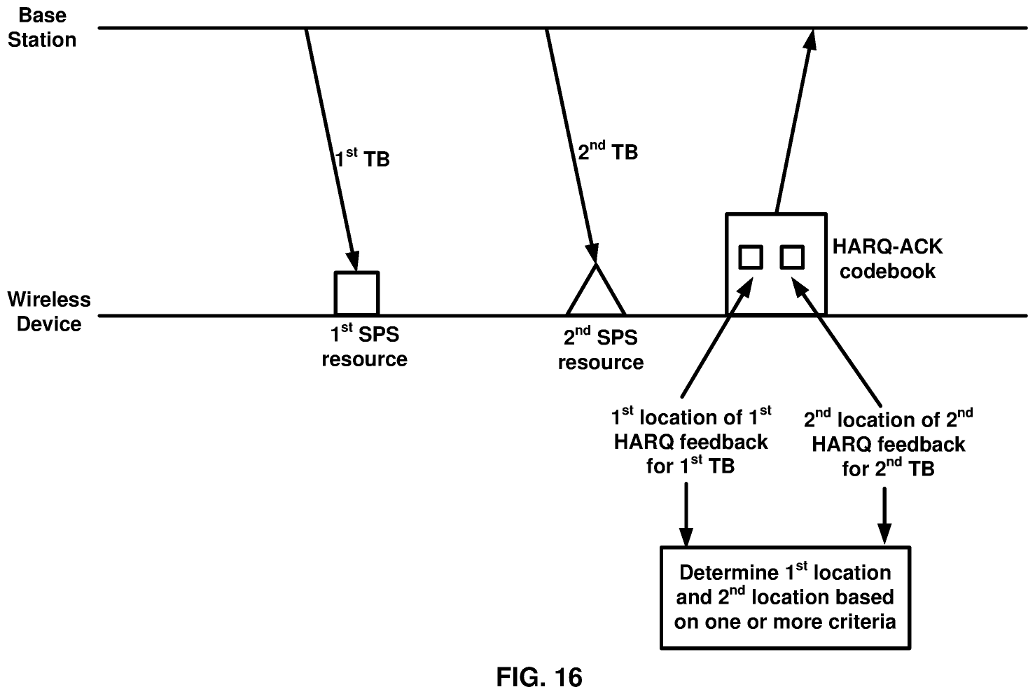

In an example embodiment as shown in FIG. 16, a wireless device may be configured with one or more downlink SPS configurations on a cell. In an example, the one or more downlink SPS configurations may be for a same bandwidth part of the cell. In an example, one or more first downlink SPS configurations of the one or more downlink SPS configurations may be for a first bandwidth part of the cell and one or more second downlink SPS configurations may be for a second bandwidth part of the cell. In an example, configuration parameters of a downlink SPS configuration may comprise a plurality of parameters comprising a SPS periodicity, one or more transmission parameters, etc. The wireless device may receive a DCI indicating activation of a plurality of resources associated with the SPS configuration. The wireless device may determine the plurality of resources based on the DCI and the configuration parameters of the SPS configuration.

In an example, the wireless device may receive a plurality of downlink receptions. The plurality of downlink receptions may comprise zero or more dynamically scheduled PDSCHs, zero or more downlink control information indicating SPS release and a first downlink transport block and a second downlink transport block. The wireless device may receive the first downlink transport block via a first SPS resource of the cell. The wireless device may receive the second downlink transport block via a second SPS resource of the cell. In an example, the first resource and the second resource may be for a first downlink bandwidth part of the cell. In an example, the first resource may be for a first downlink bandwidth part of the cell and the second resource may be for a second downlink bandwidth part of the cell. In an example, the first downlink bandwidth part and the second downlink bandwidth part may be simultaneously active. The wireless device may create a HARQ-ACK codebook comprising plurality of HARQ feedback for the plurality of downlink receptions. The plurality of HARQ feedback may comprise at least one HARQ feedback for each of the plurality of downlink receptions.

The wireless device may determine a first location of the first HARQ feedback for the first downlink TB (e.g., TB received via the first SPS resource) and a second location of a second HARQ feedback for the second downlink TB (e.g., TB received via the second SPS resource) based on one or more criteria. In an example, the first location may indicate a first position and the second location may indicate a second position. In an example, the first location and the second location may indicate a relative order of including/recording the first HARQ feedback and the second HARQ feedback in the HARQ-ACK codebook.

The wireless device may transmit the HARQ-ACK codebook via an uplink channel. In an example, the uplink channel may be an uplink control channel (e.g., PUCCH). In an example, the PUCCH may be a long PUCCH. In an example, the PUCCH may be a short PUCCH. In an example, the PUCCH may have a first format in a plurality of formats. In an example, the HARQ-ACK codebook may be transmitted in a slot of a second cell. In an example, the second cell may be configured with a plurality of PUCCHs, comprising the PUCCH, in the slot. In an example, the second cell may be the cell. The second cell may be a primary cell (e.g., PCell or SPCell) or secondary cell with uplink control channel. In an example, the plurality of downlink receptions may indicate the slot to be a timing for transmission of corresponding HARQ feedbacks. In an example, one or more DCIs indicating activation of the first SPS resource and the second SPS resource may indicate timing of transmissions of the first HARQ feedback and the second HARQ feedback to be the slot. In an example, an indication of a timing for transmission of HARQ feedback may be based on one or more fields in activation DCI and one or more RRC configured parameters.

In an example, the wireless device may transmit the HARQ-ACK codebook via a physical uplink shared channel. In an example, the HARQ-ACK codebook may be multiplexed with an uplink transport block and transmitted via PUSCH. The wireless device may multiplex the HARQ-ACK codebook in the PUSCH via a multiplexing mechanism in a plurality of multiplexing mechanisms. The plurality of multiplexing mechanisms may comprise a rate matching mechanism or a puncturing mechanism.

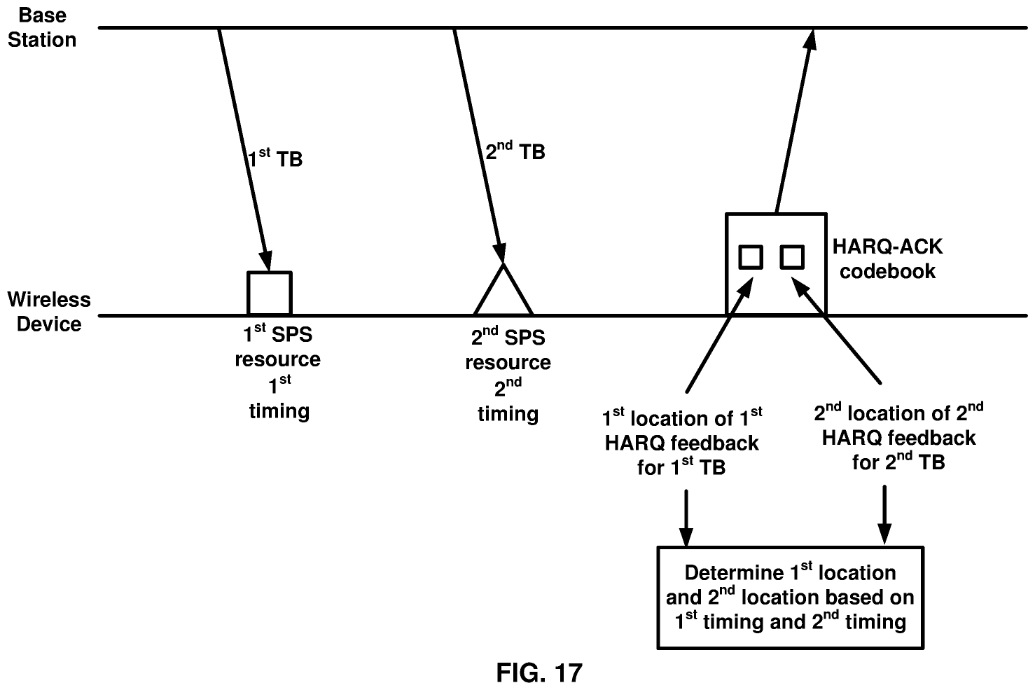

In an example embodiment as shown in FIG. 17, the first TB may be received in a first timing. In an example, the first TB may be received in a first slot. In an example, the first TB may be received in a first subframe. In an example, the first TB may be received at a first transmission time interval. In an example, the first TB may be received starting at a first symbol. In an example, the second TB may be received in a second timing. In an example, the second TB may be received in a second slot. In an example, the second TB may be received in a second subframe. In an example, the second TB may be received at a second transmission time interval. In an example, the second TB may be received starting at a second symbol. In an example, the determining the first location of the first HARQ feedback and the second location of the second HARQ feedback may be based on the first timing/transmission time interval/slot/subframe/symbol and the second timing/transmission time interval/slot/subframe/symbol. In an example, the first HARQ feedback may be included/recorder in the HARQ-ACK codebook before/prior to the second HARQ feedback (e.g., first location may be prior to the second location) in response to the first timing/transmission time interval/slot/subframe/symbol being earlier/before the second timing/transmission time interval/slot/subframe/symbol. In an example, the first HARQ feedback may be included/recorder in the HARQ-ACK codebook before/prior to the second HARQ feedback (e.g., first location may be prior to the second location) in response to the second timing/transmission time interval/slot/subframe/symbol being earlier/before the first timing/transmission time interval/slot/subframe/symbol.

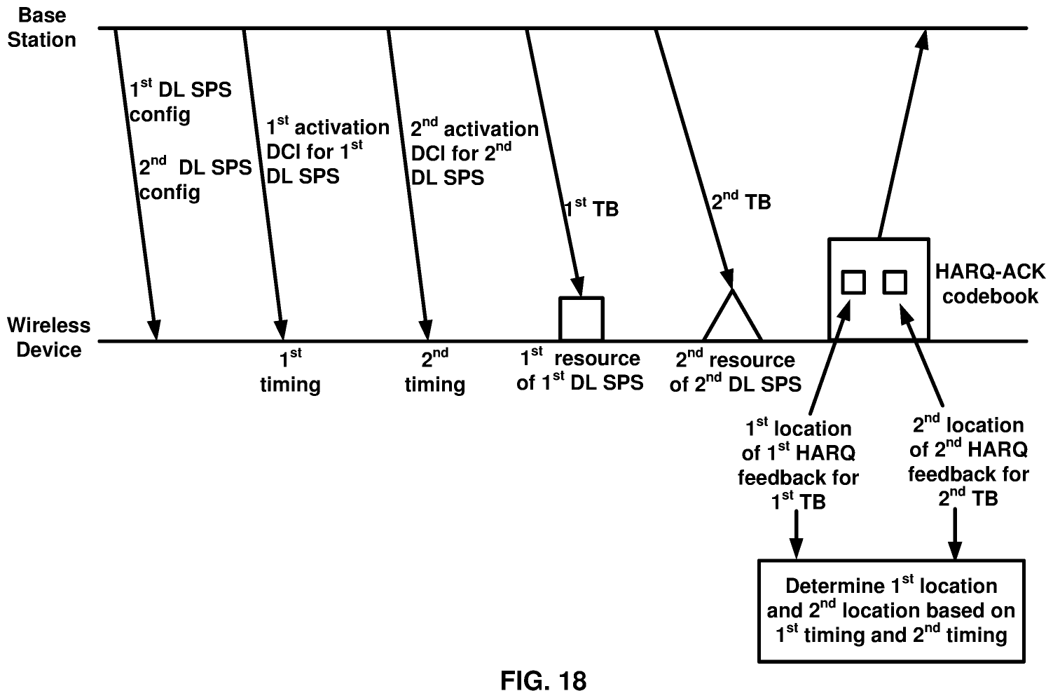

In an example embodiment as shown in FIG. 18, the wireless device may receive a first DCI indicating activation of first SPS resources based on a first SPS configuration. The first SPS resources may comprise the first SPS resource. The wireless device may receive a second DCI indicating activation of second SPS resources based on a second SPS configuration. The wireless device may receive the first DCI in a first timing. In an example, the first DCI may be received in a first slot. In an example, the first DCI may be received in a first subframe. In an example, the first DCI may be received at a first transmission time interval. In an example, the first DCI may be received starting at a first symbol. In an example, the second DCI may be received in a second timing. In an example, the second DCI may be received in a second slot. In an example, the second DCI may be received in a second subframe. In an example, the second DCI may be received at a second transmission time interval. In an example, the second DCI may be received starting at a second symbol. In an example, the first HARQ feedback may be included/recorder in the HARQ-ACK codebook before/prior to the second HARQ feedback (e.g., first location may be prior to the second location) in response to the first timing/transmission time interval/slot/subframe/symbol being earlier/before the second timing/transmission time interval/slot/subframe/symbol. In an example, the first HARQ feedback may be included/recorder in the HARQ-ACK codebook before/prior to the second HARQ feedback (e.g., first location may be prior to the second location) in response to the second timing/transmission time interval/slot/subframe/symbol being earlier/before the first timing/transmission time interval/slot/subframe/symbol.

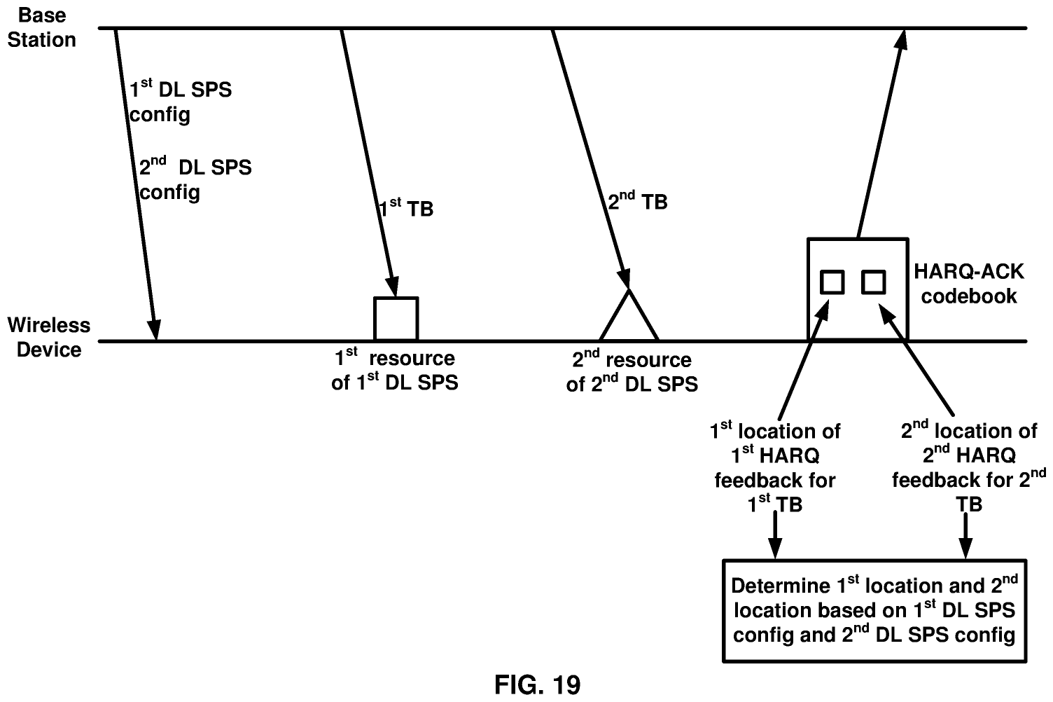

In an example embodiment as show in FIG. 19, the determining the first location of the first HARQ feedback and the second location of the second HARQ feedback may be based on first configuration parameters of a first SPS configuration (corresponding to the first SPS resource) and second configuration parameters of a second SPS configuration (corresponding to the second SPS resource). In an example, the first configuration parameters of the first SPS configuration may comprise a first parameter and the second configuration parameters of the second SPS configuration may comprise a second parameter. The determining the first location of the first HARQ feedback and the second location of the second HARQ feedback may be based on the first parameter and the second parameter.

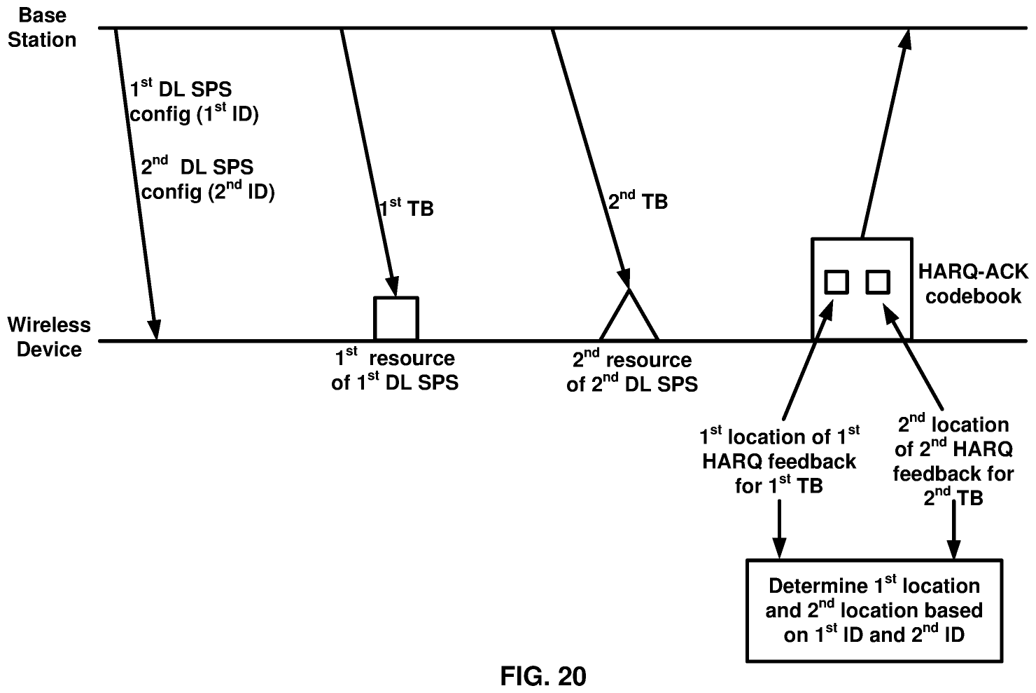

In an example embodiment as shown in FIG. 20, the first configuration parameters of the first SPS configuration (e.g., corresponding to the first SPS resource) may comprise a first SPS configuration identifier. The second configuration parameters of the second SPS configuration (e.g., corresponding to the second SPS resource) may comprise a second SPS configuration identifier. The determining the first location of the first HARQ feedback and the second location of the second HARQ feedback may be based on the first SPS configuration identifier and the second SPS configuration identifier. In an example, the first HARQ feedback may be included/recorder in the HARQ-ACK codebook before/prior to the second HARQ feedback (e.g., first location may be prior to the second location) in response to the first SPS configuration identifier being smaller than the second SPS configuration identifier. In an example, the first HARQ feedback may be included/recorder in the HARQ-ACK codebook before/prior to the second HARQ feedback (e.g., first location may be prior to the second location) in response to the second SPS configuration identifier being smaller the first SPS configuration identifier.

In an example, the first SPS configuration identifier may be a first SPS configuration index. The second SPS configuration identifier may be a second SPS configuration index.

In an example, the first parameter in the first SPS configuration parameters may be a first priority parameter. The second parameter in the second SPS configuration parameter may be a second priority parameter. In an example, the first priority parameter or the second priority parameter may indicate a first location/priority/position/order and a second location/priority/position/order, respectively. The determining the first location of the first HARQ feedback and the second location of the second HARQ feedback may be based on the first priority parameter and the second priority parameter. In an example, the first HARQ feedback may be included/recorder in the HARQ-ACK codebook before/prior to the second HARQ feedback (e.g., first location may be prior to the second location) in response to the first priority parameter being smaller than the second priority parameter. In an example, the first HARQ feedback may be included/recorder in the HARQ-ACK codebook before/prior to the second HARQ feedback (e.g., first location may be prior to the second location) in response to the second priority parameter being smaller the first priority parameter.

In an example, the first configuration parameters of the first SPS configuration may indicate a first service type and the second configuration parameters of the second SPS configuration may indicate a second service type. The determining of the first location of the first HARQ feedback and the second location of the second HARQ feedback may be based on the first service type and the second service type. The first service type may be one of a plurality of service types comprising URLLC and eMBB. The second service type may be one of the plurality of service types comprising URLLC and eMBB. For example, the first location of the first HARQ feedback may be earlier than the second location of the second HARQ feedback in response to the first service type being URLLC and the second service type being eMBB. For example, the first location of the first HARQ feedback may be earlier than the second location of the second HARQ feedback in response to the second service type being URLLC and the first service type being eMBB.

In an example, the wireless device may receive first configuration parameters of one or more first logical channels and second configuration parameters of one or more second logical channels. The wireless device may determine the first location of the first HARQ feedback and the second location of the second HARQ feedback based on the first configuration parameters and the second configuration parameters. In an example, the first configuration parameters may comprise one or more first parameters of the one or more first logical channel and one or more second parameters of the one or more second logical channels. The wireless device may determine the first location of the first HARQ feedback and the second location of the second HARQ feedback based on the one or more first parameters and the one or more second parameters. In an example, the one or more first parameters may indicate one or more first priorities of the one or more first logical channels and the one or more second parameters may indicate one or more second priorities of the one or more second logical channels.

Base station may indicate a plurality of transmit power control commands to a plurality of wireless devices by employing a group power control DCI. The legacy processes for group power control may lead to inefficient network performance when a plurality of uplink configured grants are simultaneously active for a bandwidth part of cell or when a cell is configured with multiple active bandwidth parts and each active bandwidth part is configured and activated with an uplink configured grant configuration. There is a need to enhance the legacy group power control processes. Example embodiments enhance the legacy group power control processes.

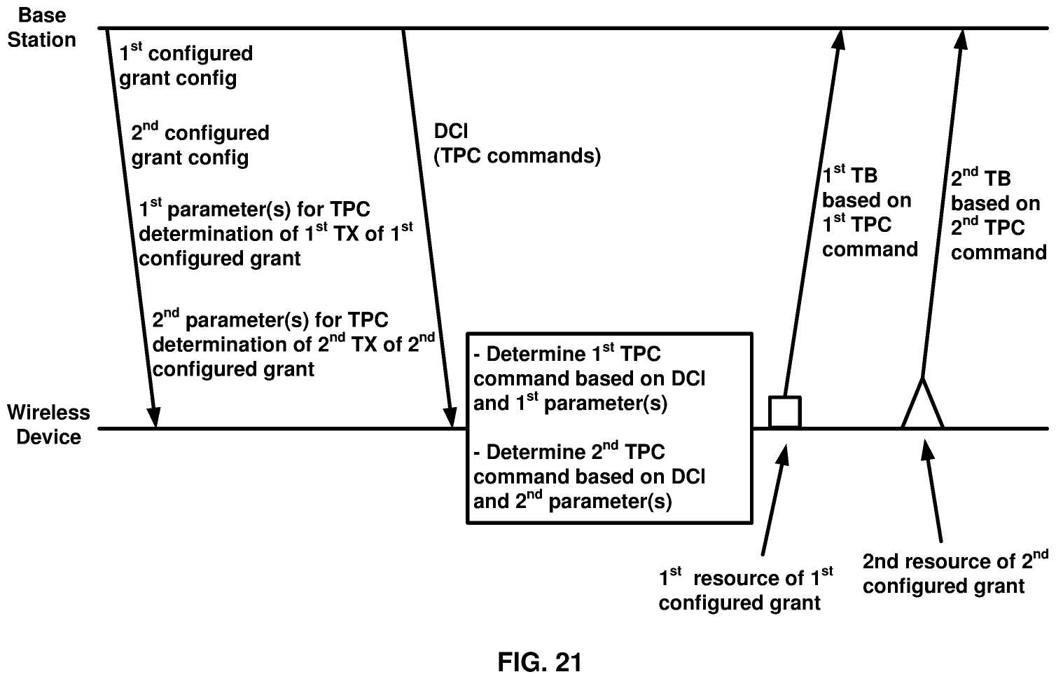

In an example embodiment as shown in FIG. 21, a wireless device may receive one or more messages comprising configuration parameters. The one or more messages may comprise one or more RRC messages. The one or more messages may comprise first configuration parameters of a first configured grant configuration on a cell. The first configuration parameters may comprise a first plurality of parameters (e.g., first periodicity, first number of HARQ processes, first HARQ process offset, etc.). The one or more messages may comprise second configuration parameters of a second configured grant configuration on the cell. The second configuration parameters may comprise a second plurality of parameters (e.g., second periodicity, second number of HARQ processes, second HARQ process offset, etc.). The one or more messages may further comprise third configuration parameters. The third configuration parameters may indicate one or more first parameters for transmit power control (TPC) determination of a transmission associated with the first configured grant configuration. The transmission associated with the first configured grant configuration may be based on resource indicated at least by the first configured grant configuration. The third configuration parameters may further indicate one or more second parameters for transmit power control (TPC) determination of a transmission associated with the second configured grant configuration. The transmission associated with the second configured grant configuration may be based on resource indicated at least by the second configured grant configuration.

In an example, the wireless device may receive a first DCI indicating activation of a plurality of resources comprising a first resource of the cell. The wireless device may receive a second DCI indicating activation of a second plurality of resources comprising a second resource of the cell. In an example, the receiving the first configuration parameters may indicate activation of the first plurality of resources comprising the first resource of the cell. In an example, the receiving the second configuration parameters may indicate activation of the second plurality of resources comprising the second resource of the cell.

In an example, the first configured grant configuration may correspond to a first service type in a plurality of service types (e.g., eMBB, URLLC, etc.). In an example, the first transport block may comprise one or more first logical channels corresponding to the first service type. In an example, the second configured grant configuration may correspond to a second service type in a plurality of service types (e.g., eMBB, URLLC, etc.). In an example, the second transport block may comprise one or more second logical channels corresponding to the second service type.

The wireless device may receive a DCI comprising a plurality of TPC commands. In an example, the DCI format may be format 2_2. In an example, the DCI may be transmitted via a common control channel and received in a common search space. The DCI may comprise a plurality of TPC commands for a plurality of wireless devices. The DCI may comprise one or more TPC commands for a wireless device in the plurality of wireless devices. In an example, the one or more messages may further comprise an RNTI (e.g., tpc-RNTI) for scrambling CRC of a DCI associated with the group power control.

The wireless device may determine a first TPC command, in the plurality of TPC commands, based on the DCI and the one or more first parameters. The wireless device may determine a second TPC command, in the plurality of TPC commands, based on the DCI and the one or more second parameters. The wireless device may transmit a first transport block, via a first resource of the cell, based on the first configuration parameters of the first configured grant configuration and the first TPC command. The wireless device may determine a first power of the first transport block based on the first TPC command. The wireless device may transmit a second transport block, via a second resource of the cell, based on the second configuration parameters of the second configured grant configuration and the second TPC command. The wireless device may determine a second power of the second transport block based on the second TPC command.

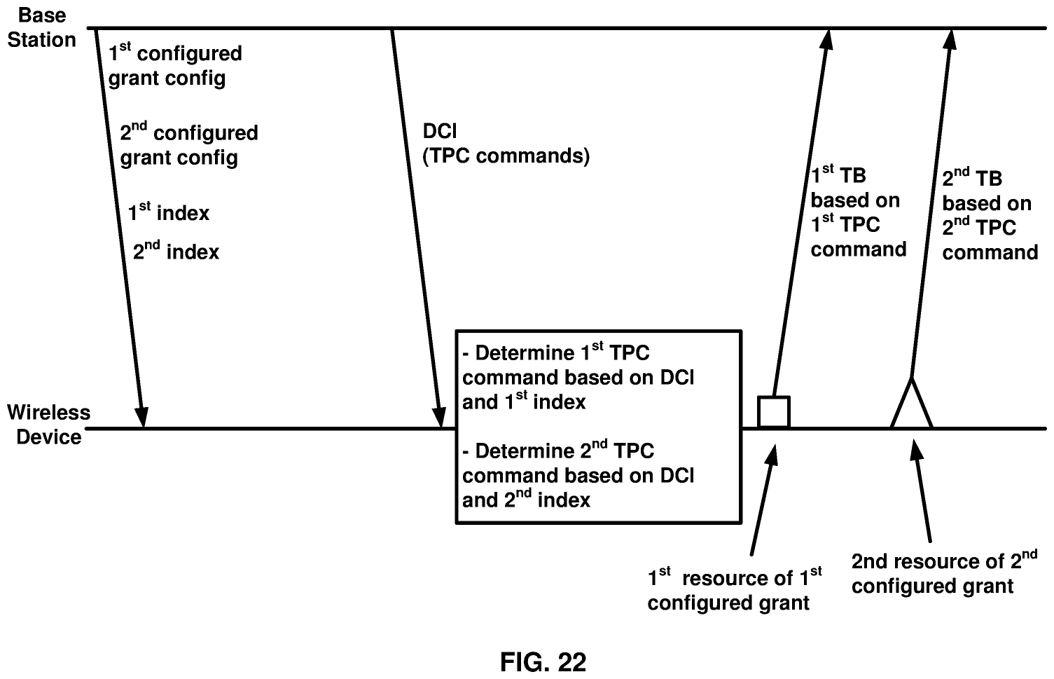

In an example embodiment as shown in FIG. 22, the one or more first parameters for TPC determination of a transmission associated with the first configured grant configuration may comprise a first index indicating a first location of the first TPC command in the DCI. The wireless device may determine the first TPC command, based on the DCI and the first index. For example, the first index may indicate which one or more first bits, in a plurality of bits indicated by the DCI, correspond to the first TPC command. The mapping between the one or more first bits and the first TPC command may be pre-configured. The wireless device may determine the first TPC command based on the one or more first bits and the pre-configured mapping. A TPC command may be in form of plus or minus k dB and is used in power calculation of a transport block. The one or more second parameters for TPC determination of a transmission associated with the second configured grant configuration may comprise a second index indicating a second location of the second TPC command in the DCI. The wireless device may determine the second TPC command, based on the DCI and the second index. For example, the second index may indicate which one or more first bits, in a plurality of bits indicated by the DCI, correspond to the second TPC command. The mapping between the one or more second bits and the second TPC command may be pre-configured. The wireless device may determine the second TPC command based on the one or more second bits and the pre-configured mapping.

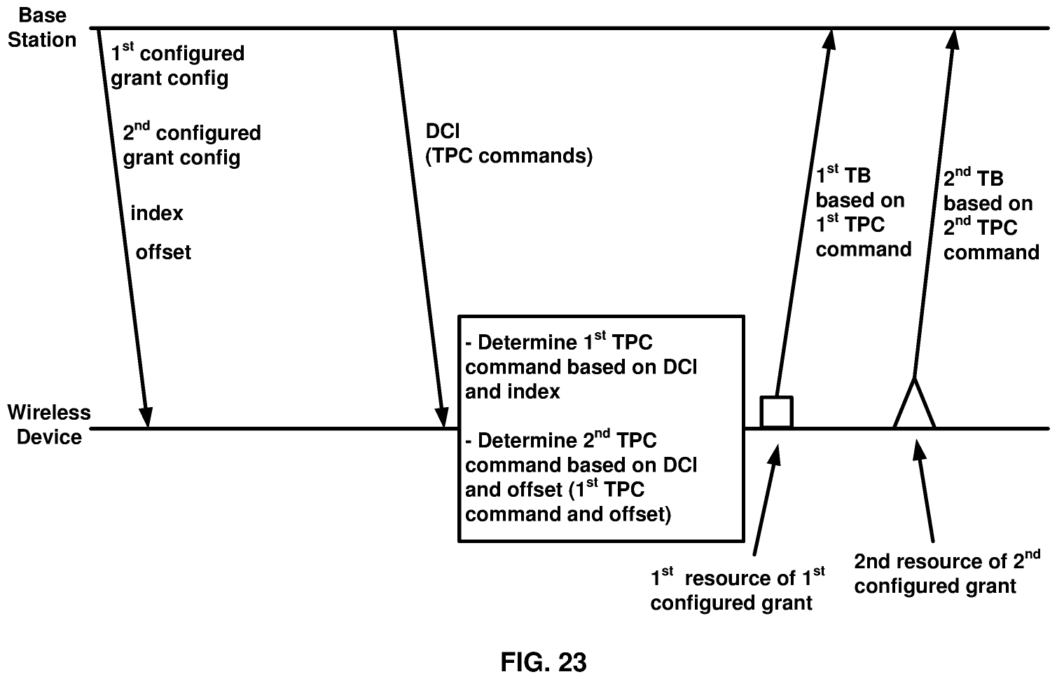

In an example embodiment as shown in FIG. 23, the one or more first parameters for TPC determination of a transmission associated with the first configured grant configuration may comprise an index indicating a location of the first TPC command in the DCI. The wireless device may determine the first TPC command, based on the DCI and the index. For example, the index may indicate which one or more first bits, in a plurality of bits indicated by the DCI, correspond to the first TPC command. The mapping between the one or more first bits and the first TPC command may be pre-configured. The wireless device may determine the first TPC command based on the one or more first bits and the pre-configured mapping. The one or more second parameters for TPC determination of a transmission associated with the second configured grant configuration may comprise an offset parameter. The offset may be to the first TPC command. The wireless device may determine the second TPC command, based on the DCI and the offset parameter. In an example, the wireless device may determine the second TPC command, based on the DCI, the index and the offset parameter. In an example, the wireless device may determine the second TPC command, based on the DCI, the first TPC command and the offset parameter. For example, the wireless device may determine the first TPC command (e.g., based on the DCI and the index) and determine the second TPC command by applying an offset to the first TPC command. In an example, the offset parameter may be configured separately for different configured grant configurations. In an example, configuration parameters of a configure grant configuration may comprise an offset parameter to be used for transmissions associated with the configured configurations. A wireless device may apply an offset parameter specific to a configured grant configuration when determining a TPC command for a transmission associated with a configured grant configuration. In an example, the index may be used for determining a TPC command for a transmission corresponding to one of one or more configured grant configurations. The RRC configuration may indicate that the wireless device may use the index for which configured grant configuration of the one or more configured grant configurations. In an example, the third configuration parameters further comprise a target cell parameter indicating which cell an index corresponds to.

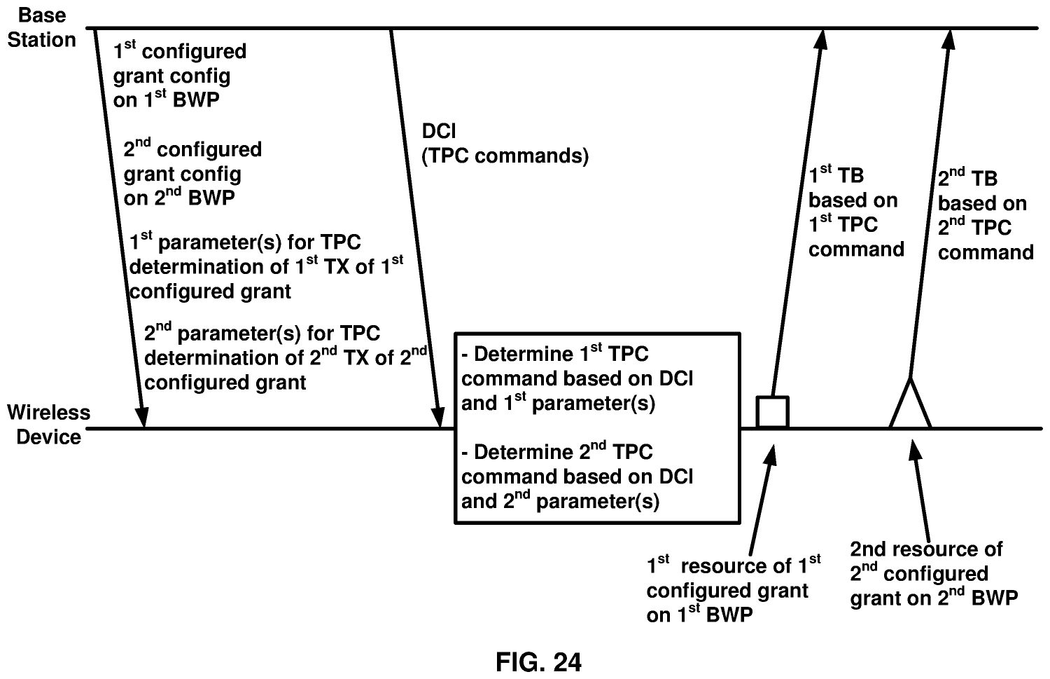

In an example embodiment as shown in FIG. 24, a wireless device may receive one or more messages comprising configuration parameters. The one or more messages may comprise one or more RRC messages. The one or more messages may comprise first configuration parameters of a first configured grant configuration on a first bandwidth part of a cell. The first configuration parameters may comprise a first plurality of parameters (e.g., first periodicity, first number of HARQ processes, first HARQ process offset, etc.). The one or more messages may comprise second configuration parameters of a second configured grant configuration on a second bandwidth part of the cell. The second configuration parameters may comprise a second plurality of parameters (e.g., second periodicity, second number of HARQ processes, second HARQ process offset, etc.). The one or more messages may further comprise third configuration parameters. The third configuration parameters may indicate one or more first parameters for transmit power control (TPC) determination of a transmission associated with the first configured grant configuration. The transmission associated with the first configured grant configuration may be based on resource indicated at least by the first configured grant configuration. The third configuration parameters may further indicate one or more second parameters for transmit power control (TPC) determination of a transmission associated with the second configured grant configuration. The transmission associated with the second configured grant configuration may be based on resource indicated at least by the second configured grant configuration.

In an example, the wireless device may receive a first DCI indicating activation of a plurality of resources comprising a first resource of the first bandwidth part. The wireless device may receive a second DCI indicating activation of a second plurality of resources comprising a second resource of the second bandwidth part. In an example, the receiving the first configuration parameters may indicate activation of the first plurality of resources comprising the first resource of the first bandwidth part. In an example, the receiving the second configuration parameters may indicate activation of the second plurality of resources comprising the second resource of the second bandwidth part.

In an example, the first configured grant configuration may correspond to a first service type in a plurality of service types (e.g., eMBB, URLLC, etc.). In an example, the first transport block may comprise one or more first logical channels corresponding to the first service type. In an example, the second configured grant configuration may correspond to a second service type in a plurality of service types (e.g., eMBB, URLLC, etc.). In an example, the second transport block may comprise one or more second logical channels corresponding to the second service type.

The wireless device may receive a DCI comprising a plurality of TPC commands. In an example, the DCI format may be format 2_2. In an example, the DCI may be transmitted via a common control channel and received in a common search space. The DCI may comprise a plurality of TPC commands for a plurality of wireless devices. The DCI may comprise one or more TPC commands for a wireless device in the plurality of wireless devices. In an example, the one or more messages may further comprise an RNTI (e.g., tpc-RNTI) for scrambling CRC of a DCI associated with the group power control.

The wireless device may determine a first TPC command, in the plurality of TPC commands, based on the DCI and the one or more first parameters. The wireless device may determine a second TPC command, in the plurality of TPC commands, based on the DCI and the one or more second parameters. The wireless device may transmit a first transport block, via a first resource of the cell, based on the first configuration parameters of the first configured grant configuration and the first TPC command. The wireless device may determine a first power of the first transport block based on the first TPC command. The wireless device may transmit a second transport block, via a second resource of the cell, based on the second configuration parameters of the second configured grant configuration and the second TPC command. The wireless device may determine a second power of the second transport block based on the second TPC command.

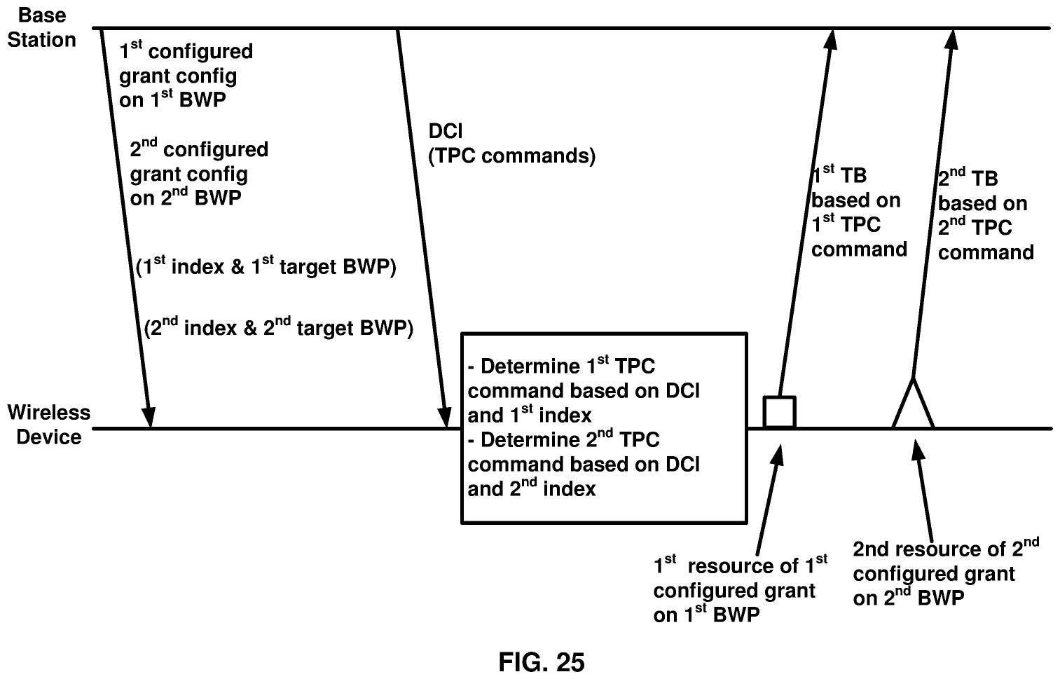

In an example embodiment as shown in FIG. 25, the one or more first parameters may comprise a first index indicating a first location of the first TPC command in the DCI. The one or more first parameters may further comprise a first target bandwidth part parameter indicating the first bandwidth part (e.g., the bandwidth part on which the first configured grant is configured). The first target bandwidth part may be associated with the first index. In an example, the first target bandwidth part and the first index may be in a same information element. The wireless device may employ the first index for TPC determination for a configured grant on the first bandwidth part due to association of the first index and the first target bandwidth and the first target bandwidth part indicating the first bandwidth part. The one or more second parameters may comprise a second index indicating a second location of the second TPC command in the DCI. The one or more second parameters may further comprise a second target bandwidth part parameter indicating the second bandwidth part (e.g., the bandwidth part on which the second configured grant is configured). The second target bandwidth part may be associated with the second index. In an example, the second target bandwidth part and the second index may be in a same information element. The wireless device may employ the second index for TPC determination for a configured grant on the second bandwidth part due to association of the second index and the second target bandwidth and the second target bandwidth part indicating the second bandwidth part. The wireless device may determine the first TPC command based on the DCI and the first index. The wireless device may determine the second TPC command based on the DCI and the second index.

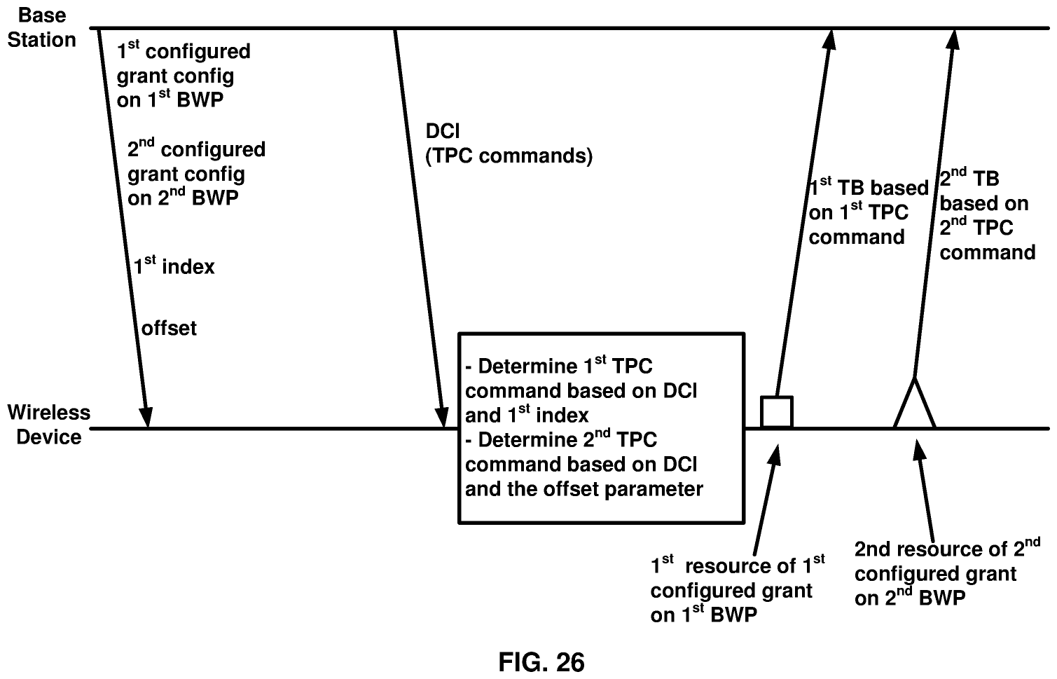

In an example embodiment as shown in FIG. 26, the one or more first parameters may comprise a first index indicating a first location of a first TPC command in the DCI. The one or more second parameters may comprise an offset parameter. The wireless device may determine the first TPC command based on the DCI and the first index. The wireless device may determine the second TPC index based on the DCI and the offset parameter. In an example, an offset may be specific to a bandwidth part. In an example the offset may be associated with the second bandwidth part. In an example, the third configuration parameters may comprise a plurality of offset parameters, comprising the offset parameter, associated with a plurality of bandwidth parts and the offset parameter may be associated with the second bandwidth part. In an example, the offset may be based on service type associated with a configured grant configuration. In an example, the third configuration parameters may comprise a plurality of offsets, comprising the offset, associated with a plurality of service types and the offset parameter may be associated with the service type of the configured grant configuration on the second bandwidth part.

In an example, the determining the second TPC command may be based on the DCI, the index and the offset parameter. In an example the determining the second TPC command may be based on the first TPC command and the offset parameter.

Base station may configure and activate a wireless device with uplink configured grant or downlink SPS. With joint activation or release/deactivation of multiple uplink configured grant configurations or downlink SPS configurations, the legacy processes lead to inefficient network performance. There is a need to enhance the legacy processes to enable joint activation or release/deactivation of multiple uplink configured grant configurations or downlink SPS configurations. Example embodiments enhance the legacy processes to enable joint activation or release/deactivation of multiple uplink configured grant configurations or downlink SPS configurations.

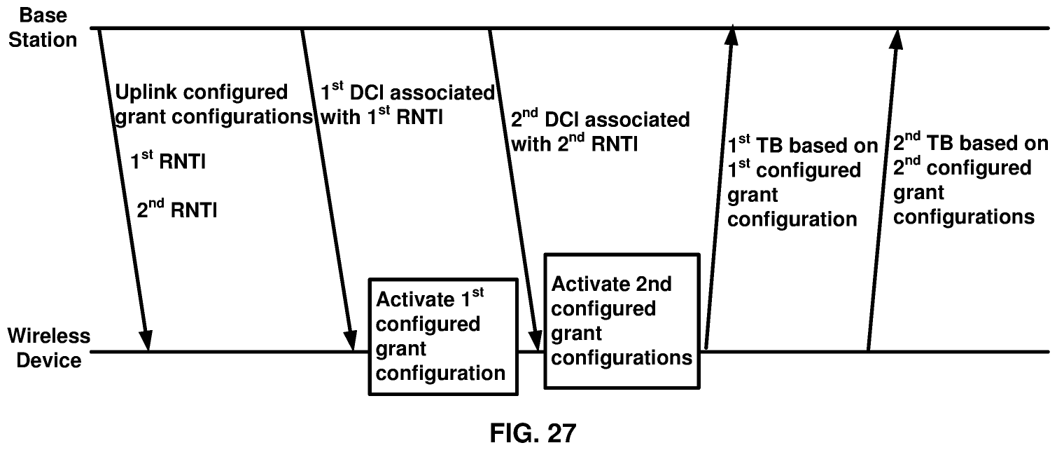

In an example embodiment as shown in FIG. 27, a wireless device may receive one or more messages comprising configuration parameters. The one or more messages may comprise one or more RRC messages. In an example, the one or more messages may comprise configuration parameters of a plurality of uplink configured grant configurations on a cell. In an example, the plurality of uplink configured grant configurations may be for a first bandwidth part of the cell. In an example, one or more first uplink configured grant configurations of the plurality of configured grant configurations may be for a first bandwidth part of the cell and one or more second uplink configured grant configurations of the plurality of configured grant configurations may be for a second bandwidth part of the cell.

The one or more messages may comprise a first RNTI for activation and/or release/deactivation of a single uplink configured grant configuration. A CRC of a DCI indicating activation and/or release/deactivation of a single uplink configured grant configuration may be scrambled with the first RNTI. The one or more messages may comprise a second RNTI for activation and/or release/deactivation of a multiple uplink configured grant configurations. A CRC of a DCI indicating activation and/or release/deactivation of multiple uplink configured grant configurations may be scrambled with the second RNTI.

In an example, the wireless device may receive a first DCI associated with the first RNTI. The first DCI may indicate activation of a first uplink configured grant configuration in the plurality of uplink configured grant configurations.

In an example, the wireless device may receive a first DCI associated with the first RNTI. The first DCI may indicate release/deactivation of a first uplink configured grant configuration in the plurality of uplink configured grant configurations.

In an example, the first DCI may indicate an identifier of the first uplink configured grant configuration. In an example, the configuration parameters of the first uplink configured grant configuration may comprise the identifier of the first uplink configured grant configuration. In an example, a value of a first field of the first DCI may indicate the identifier of the first configured grant configuration. In an example, the first field may be interpreted differently based on an RNTI associated with the first DCI. In response to the RNTI associated with the first DCI being the first RNTI, a value of the first field of the first DCI may be interpreted as an identifier of the first uplink configured grant. The wireless device may receive a second DCI, associated with a second RNTI. The second DCI may indicate activation of a second plurality of uplink configured grant configurations in the plurality of uplink configured grant configurations. In an example, the second DCI may indicate an identifier of the second plurality of uplink configured grant configurations in the plurality of uplink configured grant configurations. In an example, the configuration parameters of an uplink configured grant configuration, in the second plurality of uplink configured grant configurations, may comprise the identifier of the second plurality of uplink configured grant configurations. In an example, a value of a second field of the second DCI may indicate the identifier of the second plurality of configured grant configurations. In an example, the second field may be interpreted differently based on an RNTI associated with the second DCI. In response to the RNTI associated with the second DCI being the second RNTI, a value of the second field of the second DCI may be interpreted as an identifier of the second plurality of uplink configured grant configurations.

In an example, the wireless device may transmit a first transport block based on the first DCI and the first uplink configured grant configuration. The wireless device may transmit a second transport block based on the second DCI and the second plurality of uplink configured grant configurations.

In an example, the wireless device may receive a first DCI associated with the first RNTI. The first DCI may indicate activation of a first downlink SPS configuration in a plurality of downlink SPS configurations.

In an example, the wireless device may receive a first DCI associated with the first RNTI. The first DCI may indicate release/deactivation of a first downlink SPS configuration in the plurality of downlink SPS configurations.

In an example, the first DCI may indicate an identifier of the first downlink SPS configuration. In an example, the configuration parameters of the first downlink SPS configuration may comprise the identifier of the first downlink SPS configuration. In an example, a value of a first field of the first DCI may indicate the identifier of the first downlink SPS configuration. In an example, the first field may be interpreted differently based on an RNTI associated with the first DCI. In response to the RNTI associated with the first DCI being the first RNTI, a value of the first field of the first DCI may be interpreted as an identifier of the first downlink SPS configuration. The wireless device may receive a second DCI, associated with a second RNTI. The second DCI may indicate activation of a second downlink SPS configurations in the plurality of downlink SPS configurations. In an example, the second DCI may indicate an identifier of the second plurality of downlink SPS configurations in the plurality of downlink SPS configurations. In an example, the configuration parameters of a downlink SPS configuration, in the second plurality of downlink SPS configurations, may comprise the identifier of the second plurality of downlink SPS configurations. In an example, a value of a second field of the second DCI may indicate the identifier of the second plurality of downlink SPS configurations. In an example, the second field may be interpreted differently based on an RNTI associated with the second DCI. In response to the RNTI associated with the second DCI being the second RNTI, a value of the second field of the second DCI may be interpreted as an identifier of the second plurality of downlink SPS configurations.

In an example, the first DCI indicating the identifier of the first downlink SPS configuration may comprise the first DCI indicating an index of the first downlink SPS configuration. The second DCI indicating the identifier of the second downlink SPS configuration may comprise the second DCI indicating an index of the second downlink SPS configuration.

In an example, the wireless device may receive a first transport block based on the first DCI and the first downlink SPS configuration. The wireless device may receive a second transport block based on the second DCI and the second plurality of downlink SPS configurations.

In an example embodiment, a wireless device may indicate to a base station, e.g., in a capability message, that the wireless device is capable of supporting joint activation/release of multiple uplink configured grants and/or multiple downlink SPS on a cell and/or on a BWP of a cell. In an example, in response to the wireless device indicating support for joint activation/release of multiple uplink configured grant configurations, the wireless device may receive a DCI indicating activation of a plurality of uplink configured grant configurations. In an example, in response to the wireless device indicating support for joint activation/release of multiple uplink configured grant configurations, the wireless device may receive a DCI indicating release/deactivation of a plurality of uplink configured grant configurations. In an example, in response to the wireless device indicating support for joint activation/release of multiple downlink SPS configurations, the wireless device may receive a DCI indicating activation of a plurality of downlink SPS configurations. In an example, in response to the wireless device indicating support for joint activation/release of multiple downlink SPS configurations, the wireless device may receive a DCI indicating release/deactivation of a plurality of downlink SPS configurations.

In an example, a first field in a DCI indicating activation/release of uplink configured grant configuration may indicate a single uplink configured grant configuration or multiple uplink configured grant configurations based on one or more conditions. In an example, the first field may indicate an identifier of the single uplink configured grant configuration. In an example, the first field may indicate an identifier of a plurality/group of uplink configured grant configurations. The interpretation of a value of the first field as an identifier of a single uplink configured grant configuration or as an identifier of a plurality/group of uplink configure grant configurations may be based on the one or more conditions. In an example, the one or more conditions may be an RNTI associated with the DCI. In response to the RNTI associated with the RNTI being a first RNTI, the value of the first field may indicate an identifier of a single uplink configured grant configuration. In response to the RNTI associated with the DCI being a second RNTI, the value of the first field may indicate an identifier of a plurality/group of uplink configured grant configurations. The wireless device may receive one or more messages comprising configuration parameters comprising the first RNTI and the second RNTI. In an example, the configuration parameters may indicate whether the value of the first field indicates an identifier of a single uplink configured grant configuration or a plurality of uplink configured grant configurations.

In an example, a first field in a DCI indicating activation/release of downlink SPS configuration may indicate a single downlink SPS configuration or multiple downlink SPS configurations based on one or more conditions. In an example, the first field may indicate an identifier of the single downlink SPS configuration. In an example, the first field may indicate an identifier of a plurality/group of downlink SPS configurations. The interpretation of a value of the first field as an identifier of a single downlink SPS configuration or as an identifier of a plurality/group of downlink SPS configurations may be based on the one or more conditions. In an example, the one or more conditions may be an RNTI associated with the DCI. In response to the RNTI associated with the RNTI being a first RNTI, the value of the first field may indicate an identifier of a single downlink SPS configuration. In response to the RNTI associated with the DCI being a second RNTI, the value of the first field may indicate an identifier of a plurality/group of downlink SPS configurations. The wireless device may receive one or more messages comprising configuration parameters comprising the first RNTI and the second RNTI. In an example, the configuration parameters may indicate whether the value of the first field indicates an identifier of a single downlink SPS configuration or a plurality of downlink SPS configurations.

In an example embodiment, a wireless device may receive configuration parameters of a first uplink configured grant configuration. In an example, the wireless device may receive configuration parameters of one or more offset parameters. An offset parameter may indicate an offset to the resources associated with the first uplink configured grant configurations. In an example, first resources associated with the first uplink configured grant configuration and second resources which are offset to the first resources may be jointly activated. In an example, the configuration parameters of the first uplink configured grant configuration may comprise the offset. In an example, the offset may be indicated in an activation DCI. In an example, the activation DCI may indicate an index to one or more offsets in a plurality of RRC configured offsets. The wireless device may receive a DCI indicating activation of first plurality of resources associated with an uplink configured grant and second plurality of resources. A second resource in the second plurality of resources may be an offset to a first resource in the first plurality of resources. In an example, the offset may be a time offset. The frequency resources of the second resource may be same as the frequency resources of the first resource. In an example, the offset may indicate both time offset and frequency offset. In an example, a time offset and a frequency offset may be separately configured. The wireless device may receive different configuration parameters for the time offset and a frequency offset.

In an example embodiment, a wireless device may receive configuration parameters of a first downlink SPS configuration. In an example, the wireless device may receive configuration parameters of one or more offset parameters. An offset parameter may indicate an offset to the resources associated with the first downlink SPS configurations. In an example, first resources associated with the first downlink SPS configuration and second resources which are offset to the first resources may be jointly activated. In an example, the configuration parameters of the first downlink SPS configuration may comprise the offset. In an example, the offset may be indicated in an activation DCI. In an example, the activation DCI may indicate an index to one or more offsets in a plurality of RRC configured offsets. The wireless device may receive a DCI indicating activation of first plurality of resources associated with a downlink SPS and second plurality of resources. A second resource in the second plurality of resources may be an offset to a first resource in the first plurality of resources. In an example, the offset may be a time offset. The frequency resources of the second resource may be same as the frequency resources of the first resource. In an example, the offset may indicate both time offset and frequency offset. In an example, a time offset and a frequency offset may be separately configured. The wireless device may receive different configuration parameters for the time offset and a frequency offset.

In an example embodiment, a wireless device may receive configuration parameters of a first uplink configured grant configuration. In an example, the wireless device may receive configuration parameters of one or more bitmap parameters. A bitmap parameter may indicate one or more resources based on a first resource associated with the first uplink configured grant configuration and the bitmap parameter. In an example, a first resources associated with the first uplink configured grant configuration and one or more resources determined by a bitmap parameter may be jointly activated. In an example, a bitmap may be indicated in an activation DCI. In an example, a bitmap may be based on an activation DCI and one or more RRC parameters. In an example, the configuration parameters of the first uplink configured grant configuration may indicate the bitmap. In an example, the wireless device may receive an activation DCI indicating the bitmap parameter and/or a first uplink configured grant configuration. The wireless device may activate a first resource associated with the first uplink configured grant configuration and one or more resources based on the bitmap parameter and the first uplink configured grant configuration/ first resource.

In an example embodiment, a wireless device may receive configuration parameters of a first downlink SPS configuration. In an example, the wireless device may receive configuration parameters of one or more bitmap parameters. A bitmap parameter may indicate one or more resources based on a first resource associated with the first downlink SPS configuration and the bitmap parameter. In an example, a first resources associated with the first downlink SPS configuration and one or more resources determined by a bitmap parameter may be jointly activated. In an example, a bitmap may be indicated in an activation DCI. In an example, a bitmap may be based on an activation DCI and one or more RRC parameters. In an example, the configuration parameters of the first downlink SPS configuration may indicate the bitmap. In an example, the wireless device may receive an activation DCI indicating the bitmap parameter and/or a first downlink SPS configuration. The wireless device may activate a first resource associated with the first downlink SPS configuration and one or more resources based on the bitmap parameter and the first downlink SPS configuration/first resource.

In an example, a wireless device may transmit a confirmation MAC CE in response to receiving a DCI indicating activation/release of an uplink configured grant configuration. In an example, in response to joint activation/release of a plurality of uplink configured grant configurations, the confirmation MAC CE may indicate an identifier of the plurality of the uplink configured grants. In an example, the identifier of the plurality of uplink configured grants may be used to indicate activation/release of the plurality of uplink configured grant configurations (e.g., in an activation/release DCI). In an example, the identifier of the plurality of uplink configured grants may be a group identifier. In an example, configuration parameters of an uplink configured grant configuration in the plurality of the uplink configured grant configurations may indicate the group identifier. In an example, RRC may configure a plurality of group identifiers and an activation DCI may indicate (e.g., provide an index to) a group identifier in the plurality of group identifier configured by RRC.

In an example embodiment, in response to joint release of a plurality of downlink SPS configurations by a single DCI, the wireless device may include a plurality of ACKs in a HARQ-ACK codebook. In an example, a first number of ACKs, in response to receiving a DCI indicating release of the plurality of downlink SPS configurations, in the HARQ-ACK codebook may be based on a second number of the plurality of downlink SPS configurations. In an example, in response to receiving a single DCI indicating release of m downlink SPS configurations, m ACKs may be included in the HARQ-ACK codebook. The wireless device may transmit the HARQ-ACK codebook via an uplink channel (e.g., an uplink control channel). In an example, in response to receiving a single DCI indicating release of m downlink SPS configurations, a single ACK may be included in the HARQ-ACK codebook (e.g., irrespective of a value of m). The wireless device may transmit the HARQ-ACK codebook via an uplink channel (e.g., an uplink control channel).

In an example embodiment, a wireless device may receive one or more messages comprising configuration parameters of a plurality of downlink SPS configurations. The wireless device may receive a DCI indicating activation or release/deactivation of a first DL SPS configuration in the plurality of DL SPS configurations. The wireless device may transmit a confirmation indicating receiving the activation command for the first DL SPS confirmation. In an example, the conformation may comprise an identifier of the first DL SPS configuration. In an example, the conformation may be a MAC command (e.g., a MAC CE).

In an example embodiment, a wireless device may receive a first downlink transport block (TB) via a first semi-persistent scheduling (SPS) resource of a cell and a second downlink TB via a second SPS resource of the cell. The wireless device may determine, based on one or more criteria, first location of a first hybrid automatic repeat request (HARQ) feedback, associated with the first TB, in a HARQ-ACK codebook and a second location of a second HARQ feedback, associated with the second TB, in the HARQ-ACK codebook. The wireless device may transmit the HARQ-ACK codebook via an uplink channel. In an example, the first location may indicate a first position of the first HARQ feedback in the HARQ-ACK codebook and the second location may indicate a second position of the first HARQ feedback in the HARQ-ACK codebook. In an example, the first location and/or the second location may indicate an order of the first HARQ feedback and the second HARQ feedback in the HARQ-ACK codebook.

In an example, the receiving the first TB may be in a first timing. In an example, the receiving the first TB may be in a first transmission time interval. In an example, the receiving the first TB may be in a first slot. In an example, the receiving the first TB may be in a first subframe. In an example, the receiving the first TB may start at a first symbol. In an example, the receiving the second TB may be in a second timing. In an example, the receiving the second TB may be in a second transmission time interval. In an example, the receiving the second TB may be in a second slot. In an example, the receiving the second TB may be in a second subframe. In an example, the receiving the second TB may start at a second symbol. The determining may be based on the first timing/transmission time interval/slot/subframe/symbol and the second timing/transmission time interval/slot/subframe/symbol.

In an example, the first HARQ feedback may be recorded/included before/prior to the second HARQ feedback in the HARQ-ACK codebook in response to the first timing/transmission time interval/slot/subframe/symbol being before/earlier than the second timing/transmission time interval/slot/subframe/symbol.

In an example, the first HARQ feedback may be recorded/included before/earlier than the second HARQ feedback in the HARQ-ACK codebook in response to the second timing/transmission time interval/slot/subframe/symbol being before/earlier than the first timing/transmission time interval/slot/subframe/symbol.

In an example, the wireless device may receive first configuration parameters, of a first SPS configuration, indicating the first SPS resource. The wireless device may further receive second configuration parameters, of a second SPS configuration, indicating the second SPS resource.

In an example, the wireless device may receive a first downlink control information, in a first timing. In an example, the wireless device may receive a first downlink control information, in a first transmission time interval. In an example, the wireless device may receive a first downlink control information, in a first slot. In an example, the wireless device may receive a first downlink control information, in a first subframe. In an example, the wireless device may receive a first downlink control information starting at a first symbol. The first downlink control information may indicate activation of SPS resources based on the first SPS configuration. In an example, the wireless device may receive a second downlink control information, in a second timing. In an example, the wireless device may receive a second downlink control information, in a second transmission time interval. In an example, the wireless device may receive a second downlink control information, in a second slot. In an example, the wireless device may receive a second downlink control information, in a second subframe. In an example, the wireless device may receive a second downlink control information starting at a second symbol. The second downlink control information may indicate activation of SPS resources based on the second SPS configuration.

In an example, the determining the first location of the first HARQ feedback and the second location of the second HARQ feedback may be based on the first timing/transmission time interval/slot/subframe/symbol and the second timing/transmission time interval/slot/subframe/symbol.

In an example, the determining the first location of the first HARQ feedback and the second location of the second HARQ feedback may be based on the first configuration parameters of the first SPS configuration and the second configuration parameters of the second SPS configuration.

In an example, the first configuration parameters indicate a first parameter. The second configuration parameters indicate a second parameter. The determining of the first location of the first HARQ feedback and the second location of the second HARQ feedback may be based on the first parameter and the second parameter.

In an example, the first parameter may be a first SPS configuration identifier of the first SPS configuration and the second parameter may be the second SPS configuration identifier of the second SPS configuration.

In an example, the first SPS configuration identifier of the first SPS configuration may be a first SPS configuration index. The second SPS configuration identifier of the second SPS configuration may be a second SPS configuration index.

In an example, the first HARQ feedback may be recorded/included in the HARQ-ACK codebook before/earlier than the second HARQ feedback in response to the first SPS configuration identifier being smaller than the second SPS configuration identifier.

In an example, the second HARQ feedback may be recorded/included in the HARQ-ACK codebook before/earlier than the first HARQ feedback in response to the first SPS configuration identifier being smaller than the second SPS configuration identifier.

In an example, the first parameter may be a first priority parameter. In an example, the first priority parameter may indicate a first location. In an example, the first priority parameter may indicate a first position. In an example, the first priority parameter may indicate a first order. In an example, the second parameter may be a second priority parameter. In an example, the second priority parameter may indicate a second location. In an example, the second priority parameter may indicate a second position. In an example, the second priority parameter may indicate a first order.

In an example, the first HARQ feedback may be recorded/included in the HARQ-ACK codebook before/earlier than the second HARQ feedback in response to the first priority parameter being smaller than the second priority parameter.

In an example, the second HARQ feedback may be recorded/included in the HARQ-ACK codebook before/earlier than the first HARQ feedback in response to the first priority parameter being smaller than the second priority parameter.

In an example, the first SPS configuration parameters may indicate a first service type. The second SPS configuration parameters may indicate a second service type. The determining the first location of the first HARQ feedback and the second location of the second HARQ feedback may be based on the first service type and the second service type.

In an example, the first service type may be one of a plurality of service types comprising URLLC and eMBB. In an example, the second service type may be one of a plurality of service types comprising URLLC and eMBB.

In an example, the wireless device may receive first configuration parameters of one or more first logical channels. The wireless device may receive second configuration parameters of one or more second logical channels. The first wireless device may comprise the one or more first logical channels. The second transport block may comprise the one or more second logical channels. The determining the first location of the first HARQ feedback and the second location of the second HARQ feedback may be based on the first configuration parameters and the second configuration parameters.

In an example, the first configuration parameters may comprise one or more first parameters of the one or more first logical channels. The second configuration parameters may comprise one or more second parameters of the one or more second logical channels. The determining of the first location of the first HARQ feedback and the second location of the second HARQ feedback may be based on the one or more first parameters and the one or more second parameters.

In an example, the one or more first parameters may indicate one or more first priorities of the one or more first logical channels. The one or more second parameters may indicate one or more second priorities of the one or more second logical channels.

In an example, the uplink channel for transmission of HARQ-ACK codebook may be a physical uplink control channel. In an example, the physical uplink control channel may be a short physical uplink control channel. Ina n example, the physical uplink control channel may be a short physical uplink control channel. In an example, the physical uplink control channel has a first format from a plurality of formats.

In an example, the physical uplink control channel may be transmitted via resources of a first cell in a first slot. The first cell may be configured with a plurality of physical uplink control channels, comprising the physical uplink control channel, in the first slot.

In an example, the physical uplink control channel is transmitted via a first cell. The first cell may be a primary cell or a physical uplink control channel secondary cell.

In an example, the uplink control channel may be a physical uplink shared channel. In an example, the HARQ-ACK codebook may be multiplexed with an uplink transport block and transmitted via the physical uplink control channel. In an example, the HARQ-ACK codebook is multiplexed with the uplink transport block based on a multiplexing mechanism. In an example, the multiplexing mechanism is one of a plurality of multiplexing mechanisms. In an example, the plurality of multiplexing mechanisms comprise a rate matching mechanism and a puncturing mechanism.

In an example, the first SPS resource and the second SPS resource may be on a first downlink bandwidth part of the cell.

In an example, the first SPS resource may be on a first downlink bandwidth part of the cell and the second SPS resource may be on a second downlink bandwidth part of the cell. In an example, the first downlink bandwidth part of the cell and the second downlink bandwidth part of the cell may be simultaneously active.

In an example embodiment, wireless device may receive one or more messages comprising: first configuration parameters of a first configured grant configuration on a cell; second configuration parameters of a second configured grant configuration on the cell; and third configuration parameters indicating: one or more first parameters for transmit power control (TPC) determination of a transmission associated with the first configured grant configuration; and one or more second parameters for TPC determination of a transmission associated with the second configured grant configuration. The wireless device may receive a downlink control information (DCI) comprising a plurality of TPC commands. The wireless device may determine a first TPC command, in the plurality of TPC commands, based on the DCI and the one or more first parameters. The wireless device may determine a second TPC command, in the plurality of TPC commands, based on the DCI and the one or more second parameters. The wireless device may transmit a first transport block, via a first resource of the cell, based on the first configured grant configuration parameters and the first TPC command. The wireless device may transmit a second transport block, via a second resource of the cell, based on the second configured grant configuration parameters and the second TPC command.

In an example, the one or more first parameters may comprise a first index indicating a first location of the first TPC command in the DCI. The one or more second parameters comprise a second index indicating a second location of the second TPC command in the DCI. The determining the first TPC command may be based on the DCI and the first index. The determining the second TPC command may be based on the DCI and the second index.

In an example, the one or more first parameters may comprise an index indicating a location of the first TPC command in the DCI. The one or more second parameters may comprise an offset parameter indicating an offset to the first TPC command. The determining the first TPC command may be based on the DCI and the index. The determining the second TPC command may be based on the DCI and the offset parameter. In an example, the determining the second TPC commands is based on the DCI, the index and the offset parameter. In an example, the determining the second TPC command is based on the first TPC command and the offset parameter.

In an example, the third configuration parameters may further comprise a target cell parameter indicating the cell.

In an example, the first configured grant configuration is for a bandwidth part of the cell. The second configured grant configuration is for the bandwidth part of the cell.

In an example, the wireless device may receive a first DCI indicating activation of a first plurality of resources comprising the first resource. In an example, the wireless device may receive a second DCI indicating activation of a second plurality of resources comprising the second resource.

In an example, the receiving the first configuration parameters indicates activation of a first plurality of resources comprising the first resource. In an example, the receiving the second configuration parameters indicates activation of a second plurality of resources comprising the second resource.

In an example, the one or more messages further comprise a first radio network temporary identifier (RNTI) for group power control. In an example, the DCI, comprising the plurality of TPC commands, may be associated with the first RNTI. In an example, the DCI may have a first format. In an example, the first format may be format 2_2. In an example, the DCI maybe received via a common control channel.

In an example, the first configured grant configuration may correspond to a first service type. In an example, the first transport block may comprise one or more first logical channels corresponding to the first service type. In an example, the first service type may be one of a plurality of service types comprising ultra-reliable low-latency communications (URLLC) and enhanced mobile broadband (eMBB) service types.

In an example, the second configured grant configuration corresponds to a second service type. In an example, the second transport block comprises one or more second logical channels corresponding to the second service. In an example, the second configured grant configuration is one of a plurality of service types comprising ultra-reliable low-latency communications (URLLC) and enhanced mobile broadband (eMBB) service types.

In an example, the first transmission power of the first transport block may be based on the first TPC command. In an example, the second transmission power of the second transport block may be based on the second TPC command.

In an example, the first configuration parameters may further comprise a first periodicity parameter for resources associated with the first configured grant configuration. In an example, the second configuration parameters further comprise a second periodicity parameter for resources associated with the second configured grant configuration.

In an example, embodiment, a wireless device may receive one or more messages comprising: first configuration parameters of a first configured grant configuration on a cell; second configuration parameters of a second configured grant configuration on the cell; a first index indicating a first location of a transmit power control (TPC) command in a downlink control information (DCI); and a second index indicating a second location of a TPC command in the DCI. The wireless device may receive a DCI indicating a plurality of TPC commands. The wireless device may determine a first TPC command, in the plurality of TPC commands, based on the DCI and the first index. The wireless device may determine a second TPC command, in the plurality of TPC commands, based on the DCI and the second index. The wireless device may transmit a first transport block, via a first resource of the cell, based on the first configured grant configuration parameters and the first TPC command. The wireless device may transmit a second transport block, via a second resource of the cell, based on the second configured grant configuration parameters and the second TPC command. In an example, the first configured grant configuration is for a bandwidth part of the cell. The second configured grant configuration is for the bandwidth part of the cell.

In an example embodiment, a wireless device may receive one or more messages comprising: configuration parameters of a configured grant configuration on a cell; an index indicating a location of a transmit power control (TPC) command in a downlink control information (DCI); and an offset parameter. The wireless device may determine a first TPC command, in the plurality of TPC commands, based on the DCI and the index. The wireless device may determine a second TPC command, based on the first TPC command and the offset parameter. The wireless device may transmit a transport block, via a resource of the cell, based on the configured grant configuration parameters and the second TPC command. In an example, the wireless device may further transmit a first transport block, via a first resource of the cell, based on a first configuration parameters and the first TPC command, wherein the one or more messages further comprise the first configuration parameters of a first configured grant configuration. In an example, the first configured grant configuration is for a bandwidth part of the cell. The second configured grant configuration is for the bandwidth part of the cell.

In an example embodiment, a wireless device may receive one or more messages comprising: first configuration parameters of a first configured grant configuration on a first bandwidth part (BWP) of a cell; second configuration parameters of a second configured grant configuration on a second BWP of the cell; third configuration parameters comprising: one or more first parameters for transmit power control (TPC) determination of a transmission associated with the first configured grant configuration; and one or more second parameters for TPC determination of a transmission associated with the second configured grant configuration. The wireless device may receive a downlink control information (DCI) comprising a plurality of TPC commands. The wireless device may determine a first TPC command, in the plurality of TPC commands, based on the DCI and the one or more first parameters. The wireless device may determine a second TPC command, in the plurality of TPC commands, based on the DCI and the one or more second parameters. The wireless device may transmit a first transport block, via a first resource of the first bandwidth part, based on the first configured grant configuration parameters and the first TPC command. The wireless device may transmit a second transport block, via a second resource of the second bandwidth part, based on the second configured grant configuration parameters and the second TPC command.

In an example, the one or more first parameters may comprise a first index indicating a first location of the first TPC command in the DCI; and a first target BWP parameter, associated with the first index, indicating the first BWP. The one or more second parameters may comprise a second index indicating a second location of the second TPC command in the DCI; and a second target BWP parameter, associated with the second index, indicating the second BWP. The wireless device may determine the first TPC command based on the DCI and the first index. The wireless device may determine the second TPC command based on the DCI and the second index.

In an example, the one or more first parameters may comprise a first index indicating a first location of the first TPC command in the DCI. The one or more second parameters may comprise an offset parameter. The wireless device may determine the first TPC command based on the DCI and the first index. The wireless device may determine the second TPC command based on the DCI and the offset parameter. In an example, the offset may be associated with the second BWP. In an example, the third configuration parameters may comprise a plurality of offset parameters, comprising the offset parameter, associated with a plurality of BWPs; and the offset parameter is associated with the second BWP. In an example, the determining the second TPC command may be based on the DCI, the first index and the offset parameter. In an example, the determining the second TPC command may be based on the first TPC command and the offset parameter. In an example, the third configuration parameters may further comprise a target cell parameter indicating the cell. In an example, the third configuration parameters may further comprise a target bandwidth parameter indicating the first bandwidth part. In an example, the TPC determination of a transmission associated with the first configured grant configuration in first bandwidth part, indicated by the target bandwidth part, is based on the first index.

In an example, the wireless device may further receive a first DCI indicating activation of a first plurality of resources comprising the first resource. In an example, the wireless device may further receive a second DCI indicating activation of a second plurality of resources comprising the second resource.

In an example, the receiving the first configuration parameters indicates activation of a first plurality of resources comprising the first resource. In an example, the receiving the second configuration parameters indicates activation of a second plurality of resources comprising the second resource.

In an example, the one or more messages further comprise a first radio network temporary identifier for group power control. In an example, the DCI is associated with the first RNTI. In an example, the DCI has a first format. In an example, the first format is format 2_2. In an example, the DCI is received via a common control channel.

In an example, the first configuration parameters correspond to a first service type. In an example, the first transport block comprises one or more first logical channels corresponding to the first service type. In an example, the first service type is one of a plurality of service types comprising ultra-reliable low-latency communications (URLLC) and enhanced mobile broadband (eMBB) service types.

In an example, the second configuration parameters correspond to a second service type. In an example, the second transport block comprises one or more second logical channels corresponding to the second service type. In an example, the second service type is one of a plurality of service types comprising ultra-reliable low-latency communications (URLLC) and enhanced mobile broadband (eMBB) service types.

In an example, a first transmission power of the first transport block is based on the first TPC command. In an example, a second transmission power of the second transport block is based on the second TPC command.

In an example, the first configuration parameters further comprise a first periodicity parameter for resources associated with the first configured grant configuration; and the second configuration parameters further comprise a second periodicity parameter for resources associated with the second configured grant configuration.

In an example embodiment, a wireless device may receive one or more messages comprising: first configuration parameters of a first configured grant configuration on a first bandwidth part (BWP) of a cell; second configuration parameters of a second configured grant configuration on a second BWP of the cell; and third configuration parameters comprising: a first index; a first target BWP parameter, associated with the first index, indicating the first BWP; a second index; and a second target BWP parameter, associated with the second index, indicating the second BWP. The wireless device may receive a DCI indicating a plurality of transmit power control (TPC) commands. The wireless device may determine a first TPC command, in the plurality of TPC commands, based on the DCI and the first index. The wireless device may determine a second TPC command, in the plurality of TPC commands, based on the DCI and the second index. The wireless device may transmit a first transport block, via a first resource of the first BWP, based on the first configured grant configuration parameters and the first TPC command. The wireless device may transmit a second transport block, via a second resource of the second BWP, based on the second configured grant configuration parameters and the second TPC command.

In an example embodiment, a wireless device may receive one or more messages comprising: configuration parameters of a plurality of uplink configured grant configurations on a cell; a first radio network temporary identifier (RNTI) associated with activation of a single uplink configured grant configuration; and a second RNTI associated with activation of multiple uplink configured grant configurations. The wireless device may receive a first downlink control information (DCI), associated with the first RNTI, indicating activation of a first uplink configured grant configuration in the plurality of uplink configured grant configurations. The wireless device may receive a second DCI, associated with the second RNTI, indicating activation of a second plurality of uplink configured grant configurations in the plurality of uplink configured grant configurations. The wireless device may transmit a first transport block based on the first DCI and the first uplink configured grant configuration. The wireless device may transmit a second transport block based on the second DCI and the second plurality of uplink configured grant configurations.

In an example, the wireless device may validate the first DCI, for scheduling activation of the first uplink configured grant configuration, based on the first RNTI and one or more first fields of the first DCI. In an example, the wireless device may validate the second DCI, for scheduling activation of the second plurality of uplink configured grant configurations, based on the second RNTI and one or more second fields of the second DCI. In an example, the one or more first fields may be different from the one or more second fields. In an example, the one or more second fields comprise a third field indicating the second plurality of uplink configured grant configurations. In an example, a value of the third field may indicate an identifier of the second plurality of uplink configured grant configurations.

In an example, configuration parameters of an uplink configured grant comprise an identifier of one or more third uplink configured grant configurations in the plurality of uplink configured grant configurations.

In an example, the second DCI may comprise a third field indicating the second plurality of uplink configured grant configurations. In an example, the third field indicates an identifier of the second plurality of uplink configured grant configurations.

In an example embodiment, a wireless device may receive one or more messages comprising: configuration parameters of a plurality of downlink semi-persistent scheduling (SPS) configurations on a cell; a first radio network temporary identifier (RNTI) associated with activation of a single downlink SPS configuration; and a second RNTI associated with activation of multiple downlink SPS configurations. The wireless device may receive a first downlink control information (DCI), associated with the first RNTI, indicating activation of a first downlink SPS configuration in the plurality of downlink SPSconfigurations. The wireless device may receive a second DCI, associated with the second RNTI, indicating activation of a second plurality of downlink SPS configurations in the plurality of downlink SPS configurations. The wireless device may receive a first transport block based on the first DCI and the first downlink SPS configuration. The wireless device may receive a second transport block based on the second DCI and the second plurality of downlink SPS configurations.

In an example, the wireless device may validate the first DCI, for scheduling activation of the first downlink SPS configuration, based on the first RNTI and one or more first fields of the first DCI. In an example, the wireless device may validate the second DCI, for scheduling activation of the second plurality of downlink SPS configurations, based on the second RNTI and one or more second fields of the second DCI. In an example, the one or more first fields may be different from the one or more second fields. In an example, the one or more second fields comprise a third field indicating the second plurality of downlink SPS configurations. In an example, a value of the third field may indicate an identifier of the second plurality of downlink SPS configurations.

In an example, configuration parameters of a downlink SPS comprise an identifier of one or more third downlink SPS configurations in the plurality of downlink SPS configurations.

In an example, the second DCI may comprise a third field indicating the second plurality of downlink SPS configurations. In an example, the third field indicates an identifier of the second plurality of downlink SPS configurations.

In an example embodiment, a wireless device may receive one or more messages comprising: configuration parameters of a plurality of uplink configured grant configurations on a cell; a first radio network temporary identifier (RNTI) associated with release of a single uplink configured grant configuration; and a second RNTI associated with release of multiple uplink configured grant configurations. The wireless device may receive a first downlink control information (DCI), associated with the first RNTI, indicating release of a first uplink configured grant configuration in the plurality of uplink configured grant configurations. The wireless device may receive a second DCI, associated with the second RNTI, indicating release of a second plurality of uplink configured grant configurations in the plurality of uplink configured grant configurations.

In an example, the wireless device may validate the first DCI, for scheduling release of the first uplink configured grant configuration, based on the first RNTI and one or more first fields of the first DCI. In an example, the wireless device may validate the second DCI, for scheduling release of the second plurality of uplink configured grant configurations, based on the second RNTI and one or more second fields of the second DCI. In an example, the one or more first fields are different from the one or more second fields. In an example, the one or more second fields may comprise a third field indicating the second plurality of uplink configured grant configurations. In an example, a value of the third field may indicate an identifier of the second plurality of uplink configured grant configurations.

In an example, configuration parameters of an uplink configured grant may comprise an identifier of one or more third uplink configured grant configurations in the plurality of uplink configured grant configurations.

In an example, the second DCI may comprise a third field indicating the second plurality of uplink configured grant configurations. In an example, the third may indicate an identifier of the second plurality of uplink configured grant configurations.

In an example embodiment, a wireless device may receive one or more messages comprising: configuration parameters of a plurality of downlink semi-persistent scheduling (SPS) configurations on a cell; a first radio network temporary identifier (RNTI) associated with release of a single downlink SPS configuration; and a second RNTI associated with release of multiple downlink SPS configurations. The wireless device may receive a first downlink control information (DCI), associated with the first RNTI, indicating release of a first downlink SPS configuration in the plurality of downlink SPS configurations. The wireless device may receive a second DCI, associated with the second RNTI, indicating release of a second plurality of downlink SPS configurations in the plurality of downlink SPS configurations.

In an example, the wireless device may validate the first DCI, for scheduling release of the first downlink SPS configuration, based on the first RNTI and one or more first fields of the first DCI. In an example, the wireless device may validate the second DCI, for scheduling release of the second plurality of downlink SPS configurations, based on the second RNTI and one or more second fields of the second DCI. In an example, the one or more first fields are different from the one or more second fields. In an example, the one or more second fields may comprise a third field indicating the second plurality of downlink SPS configurations. In an example, a value of the third field indicates an identifier of the second plurality of downlink SPS configurations.

In an example, configuration parameters of a downlink SPS may comprise an identifier of one or more third downlink SPS configurations in the plurality of downlink SPS configurations.

In an example, the second DCI may comprise a third field indicating the second plurality of downlink SPS configurations. In an example, the third may indicate an identifier of the second plurality of downlink SPS configurations.

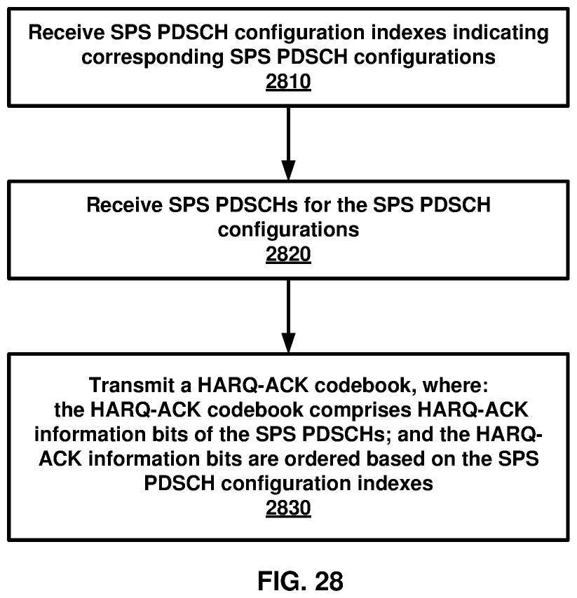

FIG. 28 is a flow diagram as per an aspect of an example embodiment of the present disclosure. At 2810, a wireless device may receive semi-persistent scheduling (SPS) physical downlink shared channel (PDSCH) configuration indexes indicating corresponding SPS PDSCH configurations. At 2820, the wireless device may receive SPS PDSCHs for the SPS PDSCH configurations. At 2830, the wireless device may transmit a hybrid automatic repeat request acknowledgement (HARQ-ACK) codebook. The HARQ-ACK codebook may comprise HARQ-ACK information bits of the SPS PDSCHs. The HARQ-ACK information bits may be ordered based on the SPS PDSCH configuration indexes.

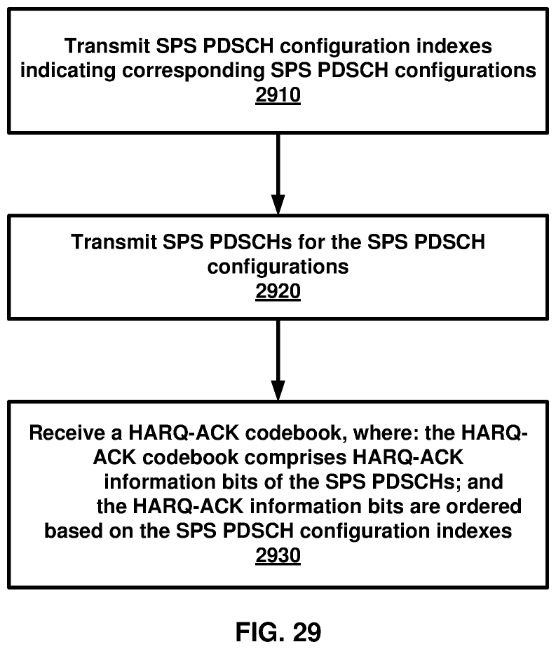

FIG. 29 is a flow diagram as per an aspect of an example embodiment of the present disclosure. At 2910, a base station may transmit semi-persistent scheduling (SPS) physical downlink shared channel (PDSCH) configuration indexes indicating corresponding SPS PDSCH configurations. At 2920, the base station may transmit SPS PDSCHs for the SPS PDSCH configurations. At 2930, the base station may receive a hybrid automatic repeat request acknowledgement (HARQ-ACK) codebook. The HARQ-ACK codebook may comprise HARQ-ACK information bits of the SPS PDSCHs. The HARQ-ACK information bits may be ordered based on the SPS PDSCH configuration indexes.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). A base station may comprise multiple sectors. When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, because those wireless devices or base stations perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed to one or more of the various embodiments.

If A and B are sets and every element of A is also an element of B, A is called a subset of B. In this specification, only non-empty sets and subsets are considered. For example, possible subsets of B ={cell1, ce112} are: {can},{cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may also refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state

In this disclosure, various embodiments are disclosed. Limitations, features, and/or elements from the disclosed example embodiments may be combined to create further embodiments within the scope of the disclosure.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more (or at least one) message(s) comprise a plurality of parameters, it implies that a parameter in the plurality of parameters is in at least one of the one or more messages, but does not have to be in each of the one or more messages. In an example embodiment, when one or more (or at least one) message(s) indicate a value, event and/or condition, it implies that the value, event and/or condition is indicated by at least one of the one or more messages, but does not have to be indicated by each of the one or more messages.

Furthermore, many features presented above are described as being optional through the use of “may” or the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features or with all three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (i.e. hardware with a biological element) or a combination thereof, all of which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or Lab VIEWMathScript. Additionally, it may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The above mentioned technologies are often used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the scope. In fact, after reading the above description, it will be apparent to one skilled in the relevant art(s) how to implement alternative embodiments. Thus, the present embodiments should not be limited by any of the above described exemplary embodiments.

In addition, it should be understood that any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112. Claims that do not expressly include the phrase “means for” or “step for” are not to be interpreted under 35 U.S.C. 112

What is claimed is:

1. A method comprising:
receiving, by a wireless device, one or more messages comprising semi-persistent scheduling (SPS) physical downlink shared channel (PDSCH) configuration indexes indicating corresponding SPS PDSCH configurations;
receiving SPS PDSCHs for the SPS PDSCH configurations; and
transmitting a hybrid automatic repeat request acknowledgement (HARQ-ACK) codebook, wherein:
the HARQ-ACK codebook comprises HARQ-ACK information bits of the SPS PDSCHs; and
the HARQ-ACK information bits are ordered based on the SPS PDSCH configuration indexes.

2. The method of claim 1, wherein the HARQ-ACK information bits being ordered comprises:
based on a first SPS PDSCH configuration index corresponding to a first SPS PDSCH configuration, of the SPS PDSCH configurations, being lower than a second SPS PDSCH configuration index corresponding to a second SPS PDSCH, of the SPS PDSCH configurations, a first HARQ-ACK bit of the first SPS PDSCH configuration being located before a second HARQ-ACK bit of the second SPS PDSCH configuration.

3. The method of claim 1, further comprising receiving a plurality of downlink control information (DCI) indicating activation of the SPS PDSCH configurations in a plurality of time slots, wherein the HARQ-ACK information bits are ordered further based on the plurality of time slots.

4. The method of claim 1, further comprising receiving the SPS PDSCHs in a plurality of reception time slots, wherein the HARQ-ACK information bits are ordered further based on the plurality of reception time slots.

5. The method of claim 1, wherein:
the SPS PDSCHs comprises:
a first SPS PDSCH for a first SPS PDSCH configuration, from the SPS PDSCH configurations, with a first PDSCH configuration index from the PDSCH configuration indexes, and
a second SPS PDSCH for a second SPS PDSCH configuration, from the SPS PDSCH configurations, with a second PDSCH configuration index from the PDSCH configuration indexes; and
the HARQ-ACK information bits comprises a first HARQ-ACK information bit for the first SPS PDSCH and a second HARQ-ACK information bit for the second SPS PDSCH.

6. The method of claim 5, wherein the HARQ-ACK information bits being ordered comprises:
determining, based on the first SPS PDSCH configuration index being lower than the second SPS PDSCH configuration index, a first location of the first HARQ-ACK information bit in the HARQ-ACK codebook being before a second location of the second HARQ-ACK information bit in the HARQ-ACK codebook.

7. The method of claim 6, further comprising receiving:
a first DCI indicating activation of the first SPS PDSCH configuration in a first time slot; and
a second DCI indicating activation of the second SPS PDSCH configuration in a second time slot, wherein the HARQ-ACK information bits being ordered further comprises the first location being before the second location based on the first time slot being earlier than the second time slot.

8. The method of claim 6, further comprising receiving:
the first SPS PDSCH in a first reception time slot; and
the second SPS PDSCH in a second reception time slot, wherein the first location is before the second location based on the first reception time slot being earlier than the second reception time slot.

9. The method of claim 1, wherein the HARQ-ACK codebook is transmitted via a physical uplink control channel (PUCCH).

10. The method of claim 9, wherein the PUCCH comprises a short PUCCH or a long PUCCH.

11. A wireless device comprising:
one or more processors; and
memory storing instructions that, when executed by the one or more processors, cause the wireless device to:
receive one or more messages comprising semi-persistent scheduling (SPS) physical downlink shared channel (PDSCH) configuration indexes indicating corresponding SPS PDSCH configurations;
receive SPS PDSCHs for the SPS PDSCH configurations; and
transmit a hybrid automatic repeat request acknowledgement (HARQ-ACK) codebook, wherein:
the HARQ-ACK codebook comprises HARQ-ACK information bits of the SPS PDSCHs; and
the HARQ-ACK information bits are ordered based on the SPS PDSCH configuration indexes.

12. The wireless device of claim 11, wherein the HARQ-ACK information bits being ordered comprises:
based on a first SPS PDSCH configuration index corresponding to a first SPS PDSCH configuration, of the SPS PDSCH configurations, being lower than a second SPS PDSCH configuration index corresponding to a second SPS PDSCH, of the SPS PDSCH configurations, a first HARQ-ACK bit of the first SPS PDSCH configuration being located before a second HARQ-ACK bit of the second SPS PDSCH configuration.

13. The wireless device of claim 11, wherein the instructions further cause the wireless device to receive a plurality of downlink control information (DCI) indicating activation of the SPS PDSCH configurations in a plurality of time slots, wherein the HARQ-ACK information bits are ordered further based on the plurality of time slots.

14. The wireless device of claim 11, wherein the instructions further cause the wireless device to receive the SPS PDSCHs in a plurality of reception time slots, wherein the HARQ-ACK information bits are ordered further based on the plurality of reception time slots.

15. The wireless device of claim 1, wherein:
the SPS PDSCHs comprises:
a first SPS PDSCH for a first SPS PDSCH configuration, from the SPS PDSCH configurations, with a first PDSCH configuration index from the PDSCH configuration indexes, and
a second SPS PDSCH for a second SPS PDSCH configuration, from the SPS PDSCH configurations, with a second PDSCH configuration index from the PDSCH configuration indexes; and
the HARQ-ACK information bits comprises a first HARQ-ACK information bit for the first SPS PDSCH and a second HARQ-ACK information bit for the second SPS PDSCH.

16. The wireless device of claim 15, wherein the HARQ-ACK information bits being ordered comprises:
determining, based on the first SPS PDSCH configuration index being lower than the second SPS PDSCH configuration index, a first location of the first HARQ-ACK information bit in the HARQ-ACK codebook being before a second location of the second HARQ-ACK information bit in the HARQ-ACK codebook.

17. The wireless device of claim 6, wherein the instructions further cause the wireless device to receive:
a first DCI indicating activation of the first SPS PDSCH configuration in a first time slot; and
a second DCI indicating activation of the second SPS PDSCH configuration in a second time slot, wherein the HARQ-ACK information bits being ordered further comprises the first location being before the second location based on the first time slot being earlier than the second time slot.

18. The wireless device of claim 16, wherein the instructions further cause the wireless device to receive:
the first SPS PDSCH in a first reception time slot; and
the second SPS PDSCH in a second reception time slot, wherein the first location is before the second location based on the first reception time slot being earlier than the second reception time slot.

19. The wireless device of claim 11, wherein the HARQ-ACK codebook is transmitted via a physical uplink control channel (PUCCH).

20. A system comprising:
a base station comprising:
one or more first processors; and
first memory storing first instructions that, when executed by the one or more first processors, cause the base station to:
transmit one or more messages comprising semi-persistent scheduling (SPS) physical downlink shared channel (PDSCH) configuration indexes indicating corresponding SPS PDSCH configurations; and
transmit SPS PDSCHs for the SPS PDSCH configurations; and
a wireless device comprising:
one or more second processors; and
second memory storing second instructions that, when executed by the one or more second processors, cause the wireless device to:
receive the SPS PDSCH configuration indexes;
receive the SPS PDSCHs; and
transmit a hybrid automatic repeat request acknowledgement (HARQ-ACK) codebook, wherein:
the HARQ-ACK codebook comprises HARQ-ACK information bits of the SPS PDSCHs; and
the HARQ-ACK information bits are ordered based on the SPS PDSCH configuration indexes.
